(19) United States
(12) Patent Application Publication
(10) Pub. No.: US 2018/0133719 A1
(43) Pub. Date: May 17, 2018

(54) MOLDING SAND RECLAMATION METHOD AND RECLAMATION EQUIPMENT

(71) Applicant: SINTOKOGIO, LTD., Nagoya-shi, Aichi (JP)

(72) Inventors: Takahumi OBA, Toyokawa-shi (JP); Junichi IWASAKI, Toyokawa-shi (JP); Kazuya ABE, Toyokawa-shi (JP); Tatsuyuki AOKI, Toyokawa-shi (JP)

(73) Assignee: SINTOKOGIO, LTD., Nagoya-shi, Aichi (JP)

(21) Appl. No.: 15/577,508

(22) PCT Filed: Apr. 18, 2016
(86) PCT No.: PCT/JP2016/062274

§ 371 Date: Nov. 28, 2017

(30) Foreign Application Priority Data
Jun. 11, 2015 (JP) 2015-118537

(51) Int. Cl. B02C 23/14; B22C 5/06; B02C 15/04; B02C 15/06; B02C 23/18; B03C 1/26; B02C 25/00; B02C 23/02; B02C 21/00

(52) U.S. Cl. CPC B02C 23/14; B22C 5/06; B02C 15/04; B02C 15/06; B22C 9/02; B03C 1/26; B02C 25/00; B02C 23/02; B02C 21/00; B02C 23/18

(57) ABSTRACT

A method includes measuring a water content and a magnetized matter content of molding sand discharged from green sand casting equipment; comparing the measured water content with a first control value, and if the water content exceeds the first control value, drying the molding sand until the water content becomes equal to or less than the first control value; comparing the measured magnetized matter content with a second control value, and if the magnetized matter content exceeds the second control value, magnetically separating the molding sand until the magnetized matter content becomes equal to or less than the second control value; thereafter, reclaiming the molding sand by dry mechanical reclamation until a loss-on-ignition becomes equal to or less than a third control value; and classifying the molding sand until a total clay content becomes equal to or less than a fourth control value.

### TECHNICAL FIELD

The present invention relates to a reclamation method and reclamation equipment for molding sand discharged from green sand casting equipment.

### BACKGROUND ART

In green sand casting equipment, in which molds are made by adding a green sand additive such as water, bentonite, lime powder, starch or the like to molding sand, mixing the sand, and then loading the mixed sand into a casting mold, waste sand having various properties is generated during various processes, such as overflow sand, which is old sand that has overflowed from sand treatment equipment, sand adhering to the product, which is discharged during shot blast processes, main mold/core-mixed sand, which is discharged during crushing processes, and sand lumps/sand, which is discharged during core sand extraction processes.

Such waste sand does not have sand properties enabling direct reuse as sand for main molds or cores, so it is necessary to remove impurities or adherents on the surfaces of the sand grains, and to appropriately adjust the grain size for reuse. This process is called reclamation.

Normally, green sand is reclaimed by thermal reclamation using a calcination furnace, mechanical reclamation using a dry mechanical reclamation apparatus, wet reclamation using a wet sand reclamation apparatus, or a combination of these methods.

For example, Patent Document 1 discloses a molding sand reclamation apparatus using thermal reclamation, Patent Document 2 discloses a molding sand reclamation method that combines thermal regeneration with dry mechanical reclamation, Patent Document 3 discloses a molding sand reclamation apparatus and reclamation method using dry mechanical reclamation, Patent Document 4 discloses a green sand waste reclamation method that combines dry mechanical reclamation with wet reclamation, and Patent Document 5 discloses a self-hardening molding sand reclamation apparatus that combines multiple types of dry mechanical reclamation.

Additionally, Patent Document 6 discloses a green sand management system and management method wherein multiple types of reclaimed sand (replenishing sand), which has undergone thermal reclamation and dry reclamation under multiple processing conditions, are added, at a predetermined ratio, to recovered sand (green sand), and reused.

### RELATED ART DOCUMENTS

### Patent Documents

[Patent Document 1] JP H5-15940 A

[Patent Document 2] JP 2014-24097 A

[Patent Document 3] JP H6-170486 A

[Patent Document 4] JP 2006-68815 A

[Patent Document 5] JP H5-318021 A

[Patent Document 6] JP 2011-194451 A

### SUMMARY OF THE INVENTION

### Problems to be Solved by the Invention

However, effective and appropriate methods and reclamation equipment that use only dry mechanical reclamation to reclaim molding sand containing moisture and magnetized matter, which has been discharged from green sand casting equipment, have not existed until now.

Additionally, effective and appropriate methods and reclamation equipment that use only dry mechanical reclamation to reclaim various types of molding sand, which has been discharged from green sand casting equipment, have not existed until now.

The present invention was made in view of the above, and has the purpose of providing a method and reclamation equipment that use only dry mechanical reclamation to reclaim various types of molding sand that has been discharged from green sand casting equipment.

### Means for Solving the Problems

In order to solve the above-mentioned problem and to achieve the purpose, the molding sand reclamation method according to the present invention comprises a step of measuring a water content and a magnetized matter content of molding sand discharged from green sand casting equipment; a step of comparing the measured water content with a first control value, and if the water content exceeds the first control value, drying the molding sand until the water content becomes equal to or less than the first control value; a step of comparing the measured magnetized matter content with a second control value, and if the magnetized matter content exceeds the second control value, magnetically separating the molding sand until the magnetized matter content becomes equal to or less than the second control value; thereafter, a step of reclaiming the molding sand by dry mechanical reclamation until a loss-on-ignition becomes equal to or less than a third control value; and a step of classifying the molding sand until a total clay content becomes equal to or less than a fourth control value.

Additionally, the molding sand reclamation method according to the present invention comprises a step of recovering molding sand that has been discharged from green sand casting equipment, separately as overflow sand, sand adhering to the product, main mold/core-mixed sand and sand lumps/sand; a step of drying the overflow sand until the water content is equal to or less than a first control value, removing foreign matter from the overflow sand, and storing the overflow sand; a step of removing foreign matter from the sand adhering to the product, magnetically separating the sand adhering to the product until the magnetized matter content is equal to or less than a second control value, and storing the sand adhering to the product; a step of crushing the main mold/core-mixed sand, removing foreign matter from the main mold/core-mixed sand, and storing the main mold/core-mixed sand; a step of crushing the sand lumps/sand, removing foreign matter from the sand lumps/sand, and storing the sand lumps/sand; a step of extracting and blending the stored overflow sand, the stored sand adhering to the product, the stored main mold/core-mixed sand and the stored sand lumps/sand so that a ratio therebetween is always kept constant; a step of reclaiming the blended sand by dry mechanical reclamation until a loss-on-ignition becomes equal to or less than a third control value; and a step of classifying the blended sand until a total clay content becomes equal to or less than a fourth control value.

Additionally, the molding sand reclamation equipment according to the present invention comprises drying equipment that dries molding sand discharged from green sand casting equipment until a water content is equal to or less than a first control value; magnetic separation equipment that magnetically separates the molding sand until a magnetized matter content is equal to or less than a second control value; dry mechanical reclamation equipment that reclaims the molding sand until a loss-on-ignition is equal to or less than a third control value; classification equipment that classifies the molding sand until a total clay content is equal to or less than a fourth control value; first switching equipment that selects whether or not to pass the molding sand through the drying equipment; and second switching equipment that selects whether or not to pass the molding sand through the magnetic separation equipment.

Additionally, the molding sand reclamation equipment according to the present invention comprises overflow sand recovery equipment that recovers overflow sand discharged during a sand processing step; drying equipment that dries the overflow sand until a water content is equal to or less than a first control value; overflow sand foreign-matter removal equipment that removes foreign matter from the overflow sand; an overflow sand storage tank that stores the overflow sand; product-adhered sand recovery equipment that recovers sand adhering to the product; product-adhered sand foreign-matter removal equipment that removes foreign matter from the sand adhering to the product; magnetic separation equipment that magnetically separates the sand adhering to the product until a magnetized matter content is equal to or less than a second control value; a product-adhered sand storage tank that stores sand adhering to the product; main mold/core-mixed sand recovery equipment that recovers main mold/core-mixed sand; crushing equipment that crushes the main mold/core-mixed sand; main mold/core-mixed sand foreign-matter removal equipment that removes foreign matter from the main mold/core-mixed sand; a main mold/core-mixed sand storage tank that stores the main mold/core-mixed sand; sand lumps/sand recovery equipment that recovers sand lumps/sand discharged during a core sand extraction step; crushing equipment that crushes the sand lumps/sand; sand lumps/sand foreign-matter removal equipment that removes foreign matter from the sand lumps/sand; a sand lumps/sand storage tank that stores the sand lumps/sand; sand cutting/blending equipment that cuts out and blends sand from the overflow sand storage tank, the product-adhered sand storage tank, the main mold/core-mixed storage tank and the sand lumps/sand storage tank so that the ratio between the sand extracted from the respective storage tanks are always constant; dry mechanical reclamation equipment that reclaims the blended sand until a loss-on-ignition becomes equal to or less than a third control value; and classification equipment that classifies the blended sand until a total clay content becomes equal to or less than a fourth control value.

### Effects of the Invention

According to the present invention, it is possible to reclaim molding sand that has been discharged from green sand casting equipment, using only dry mechanical reclamation. As a result thereof, the present invention achieves the effects wherein it is unnecessary to perform a separation process for impurities or a neutralization process for waste water that is generated when using wet reclamation, the large amounts of energy that are consumed when using thermal reclamation can be reduced, and the reclamation equipment can be made compact and simple, so that the efficiency required for sand reclamation can be raised and the cost of sand reclamation can be reduced.

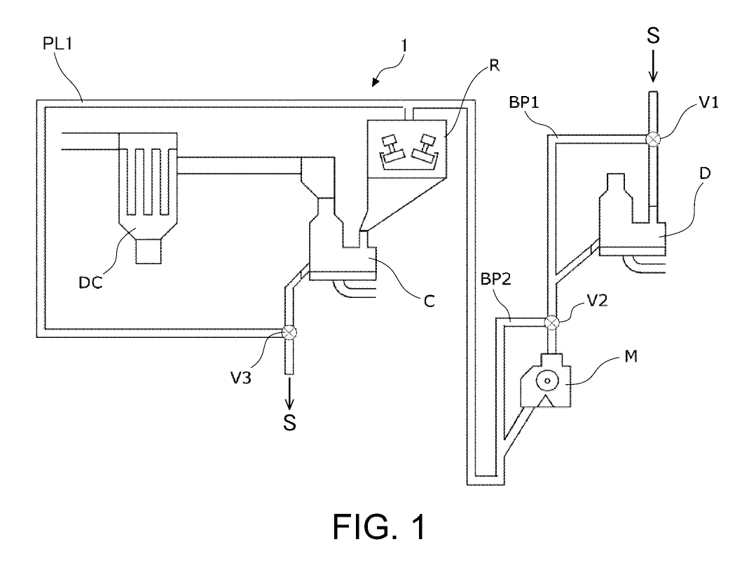

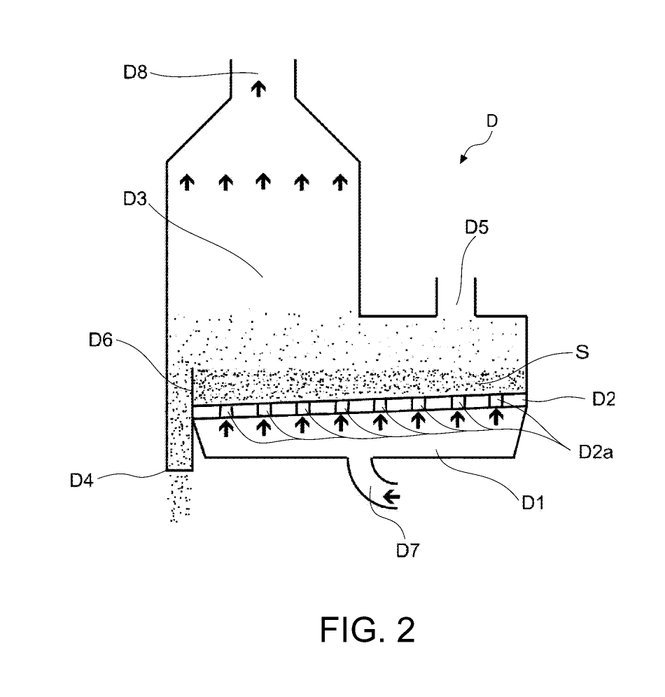

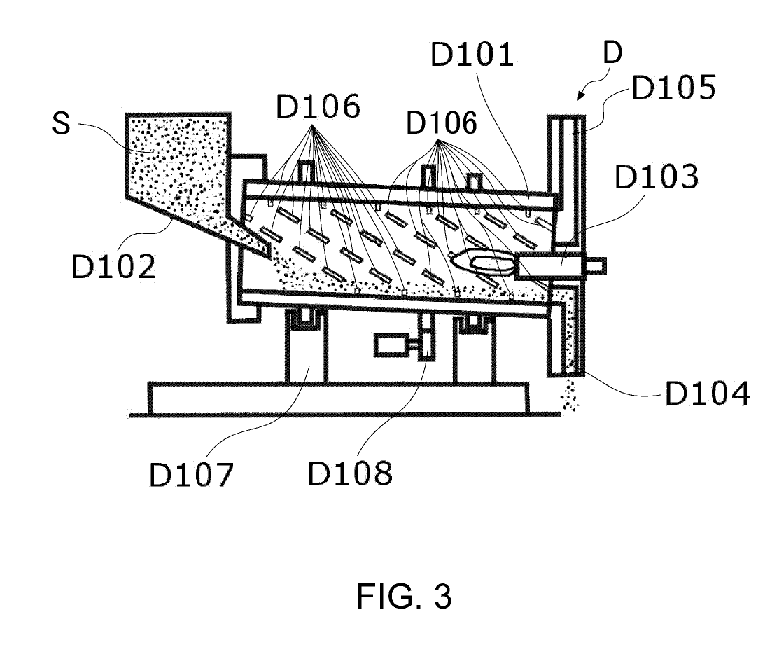

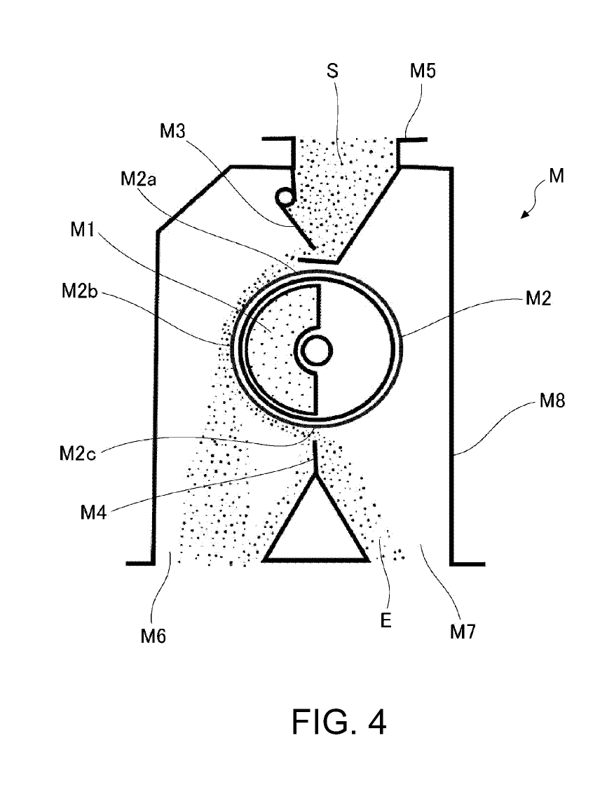

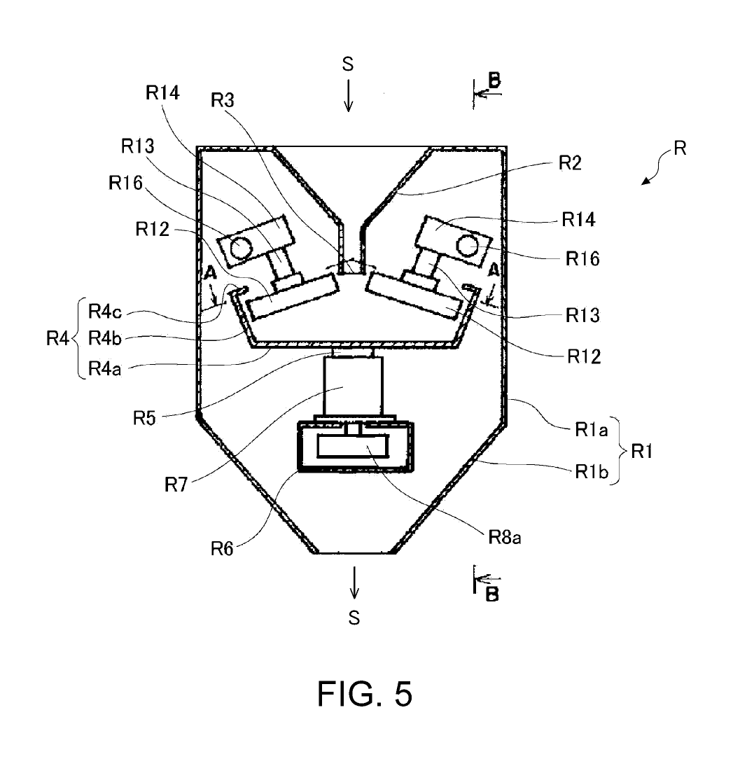

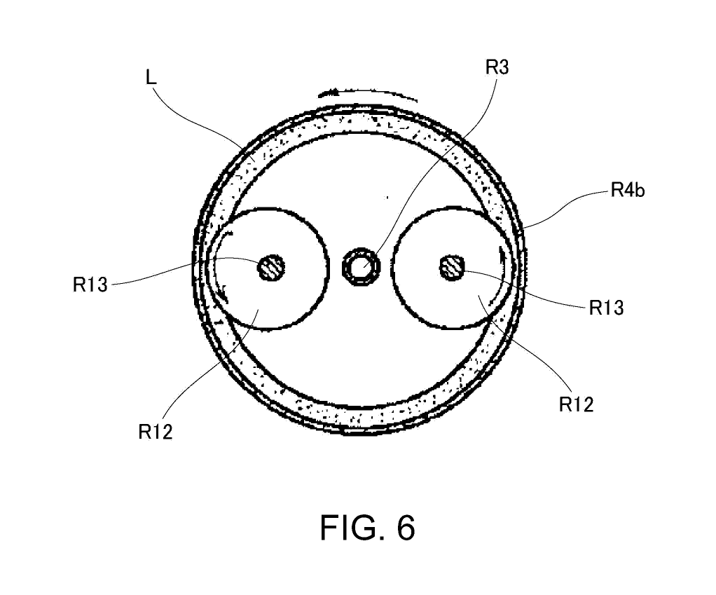

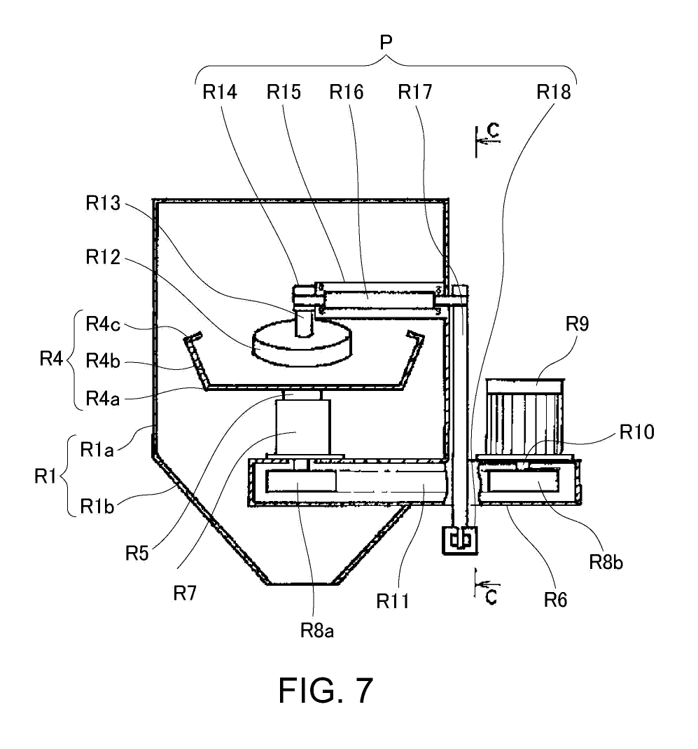

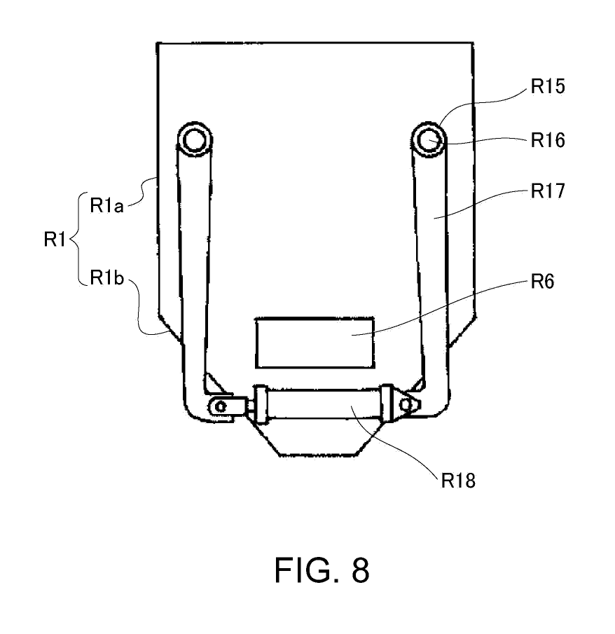

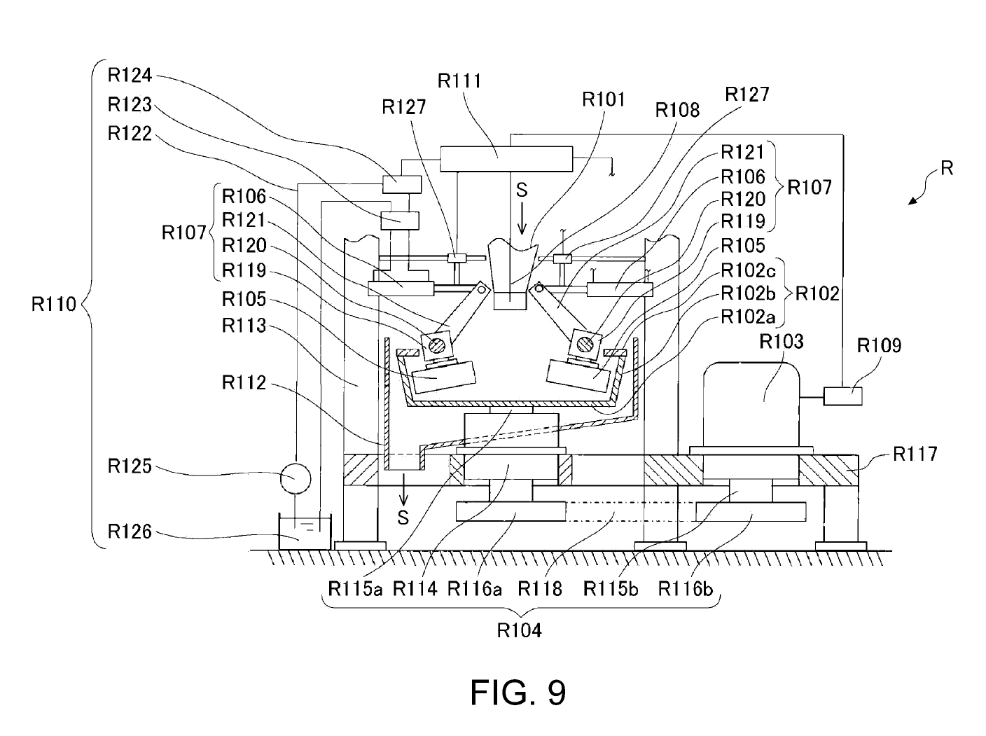

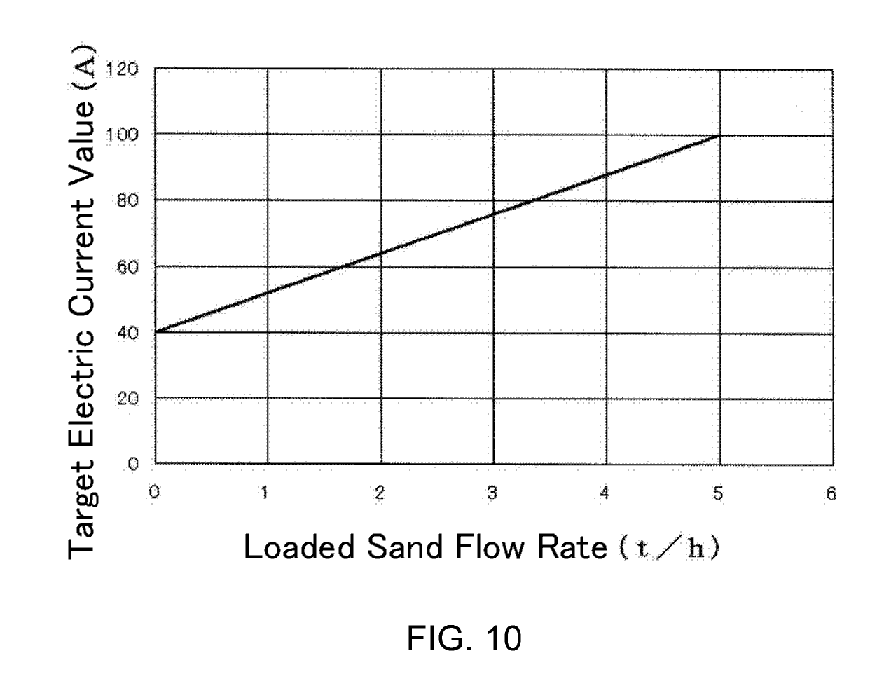

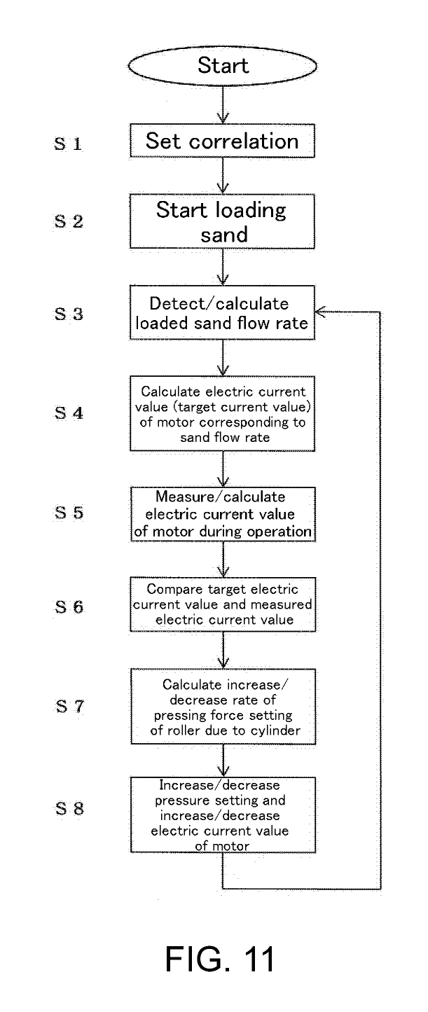

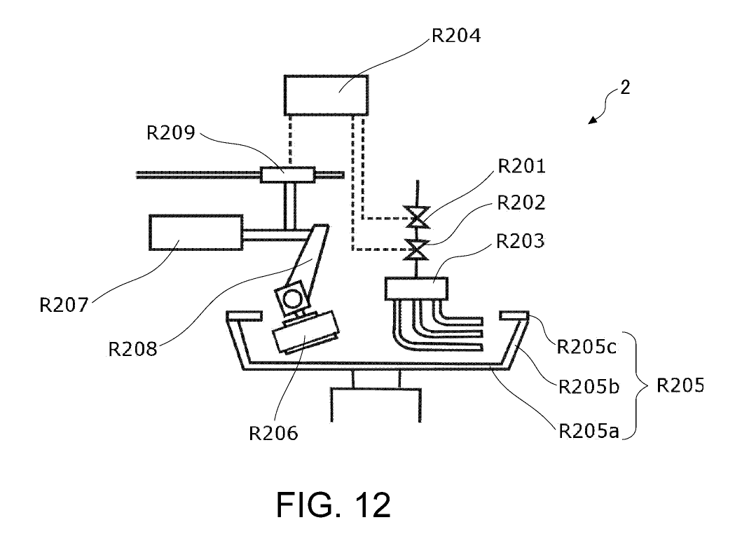

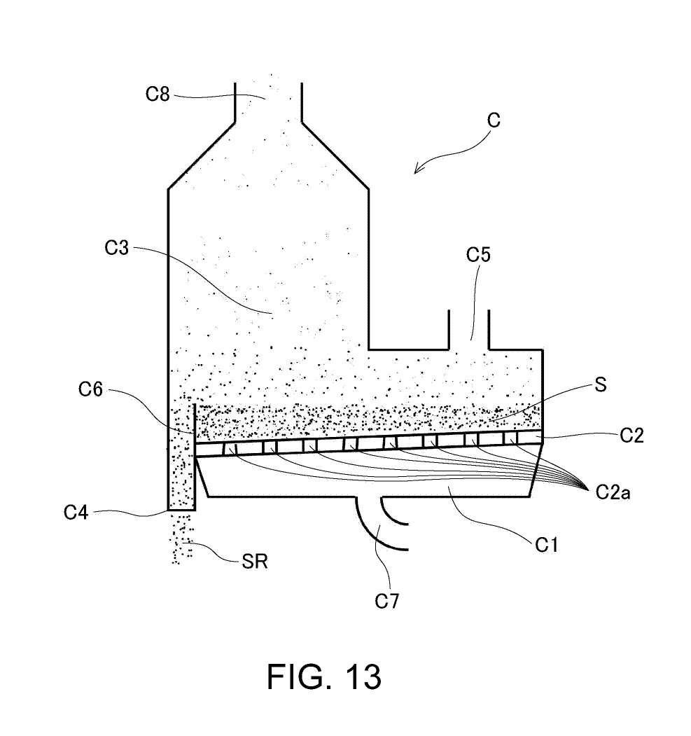

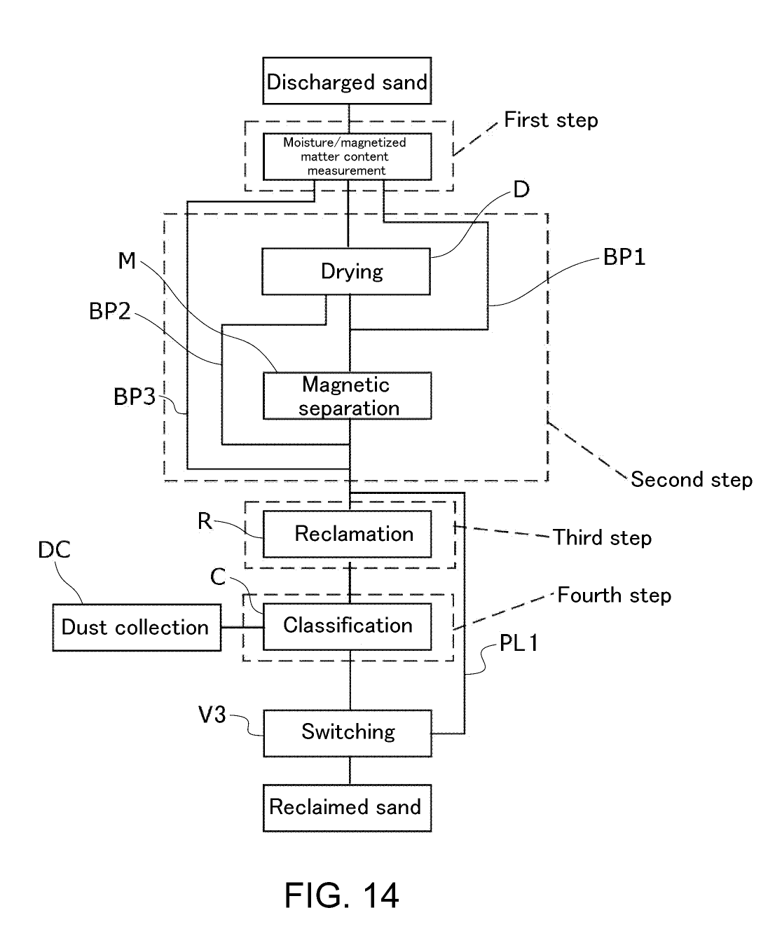

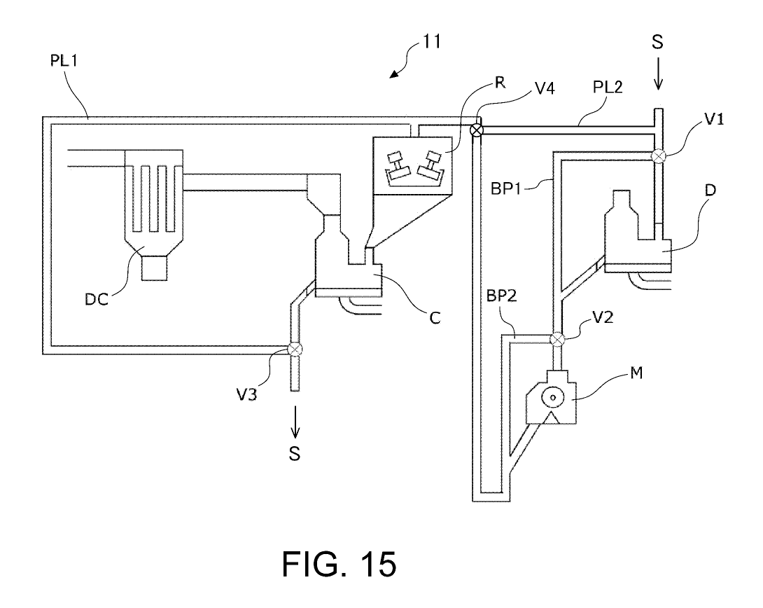

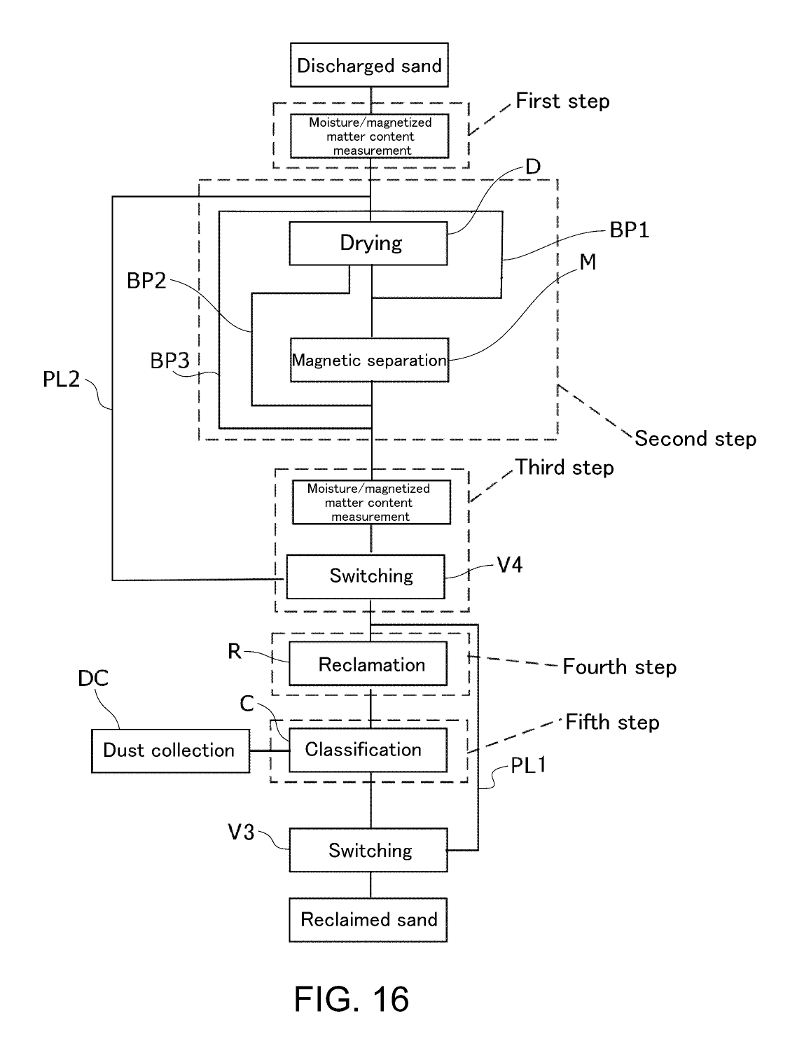

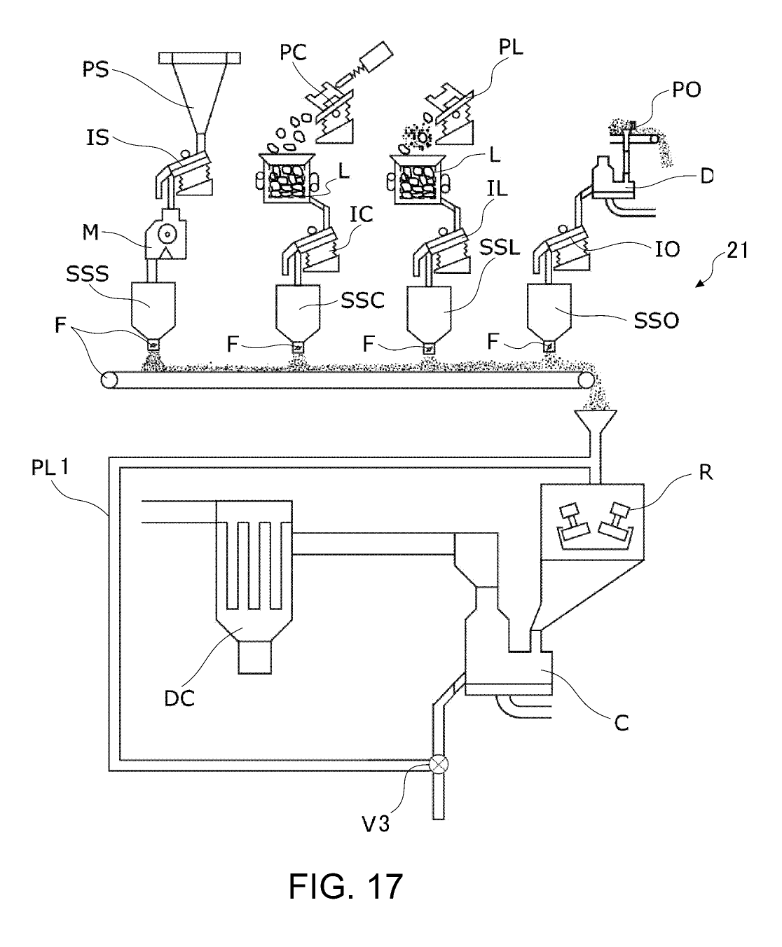

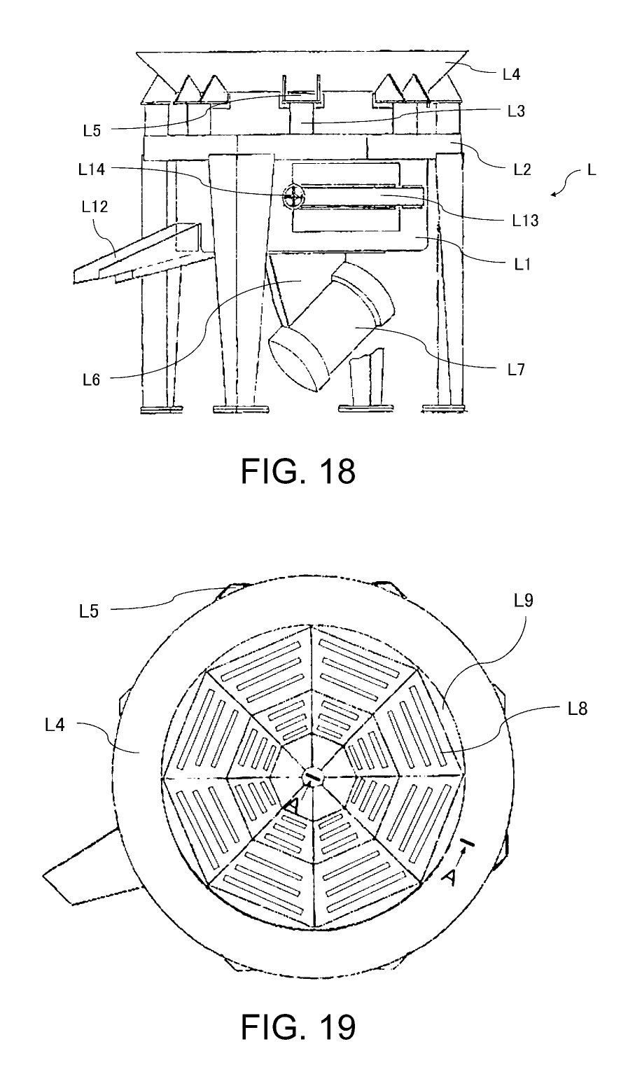

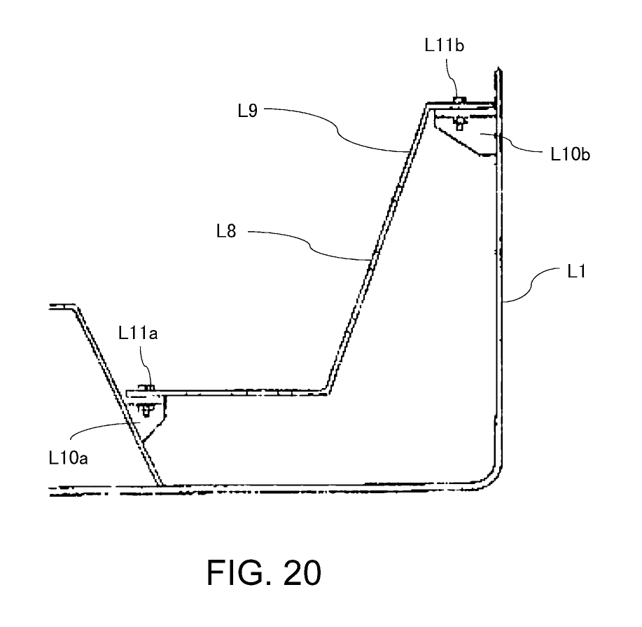

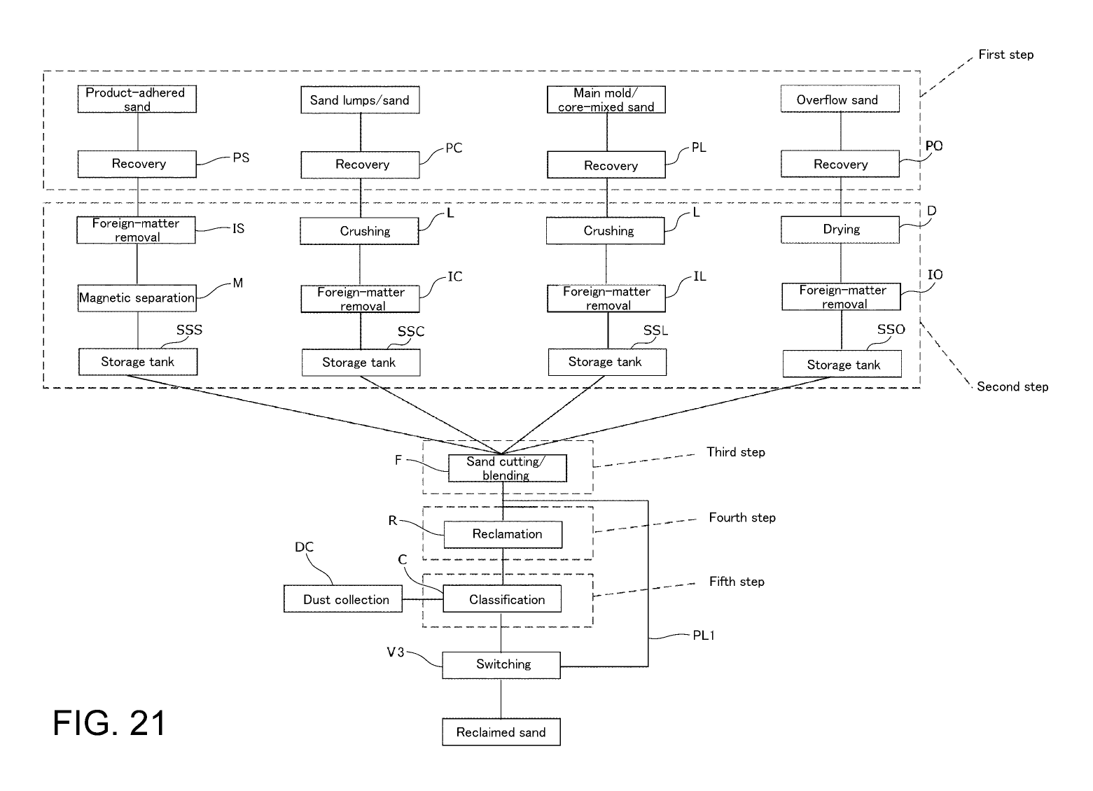

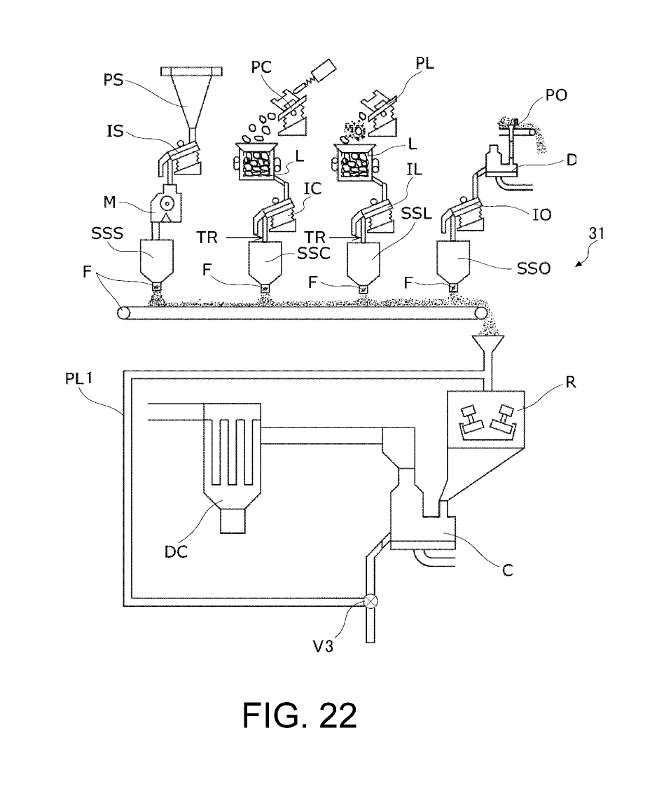

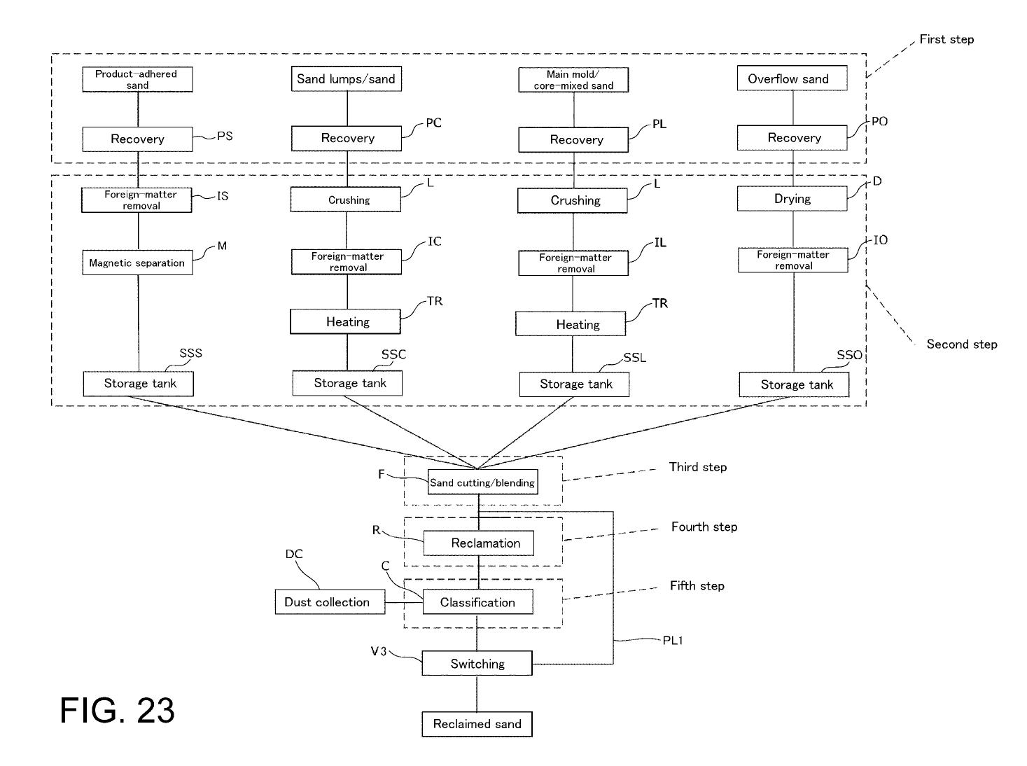

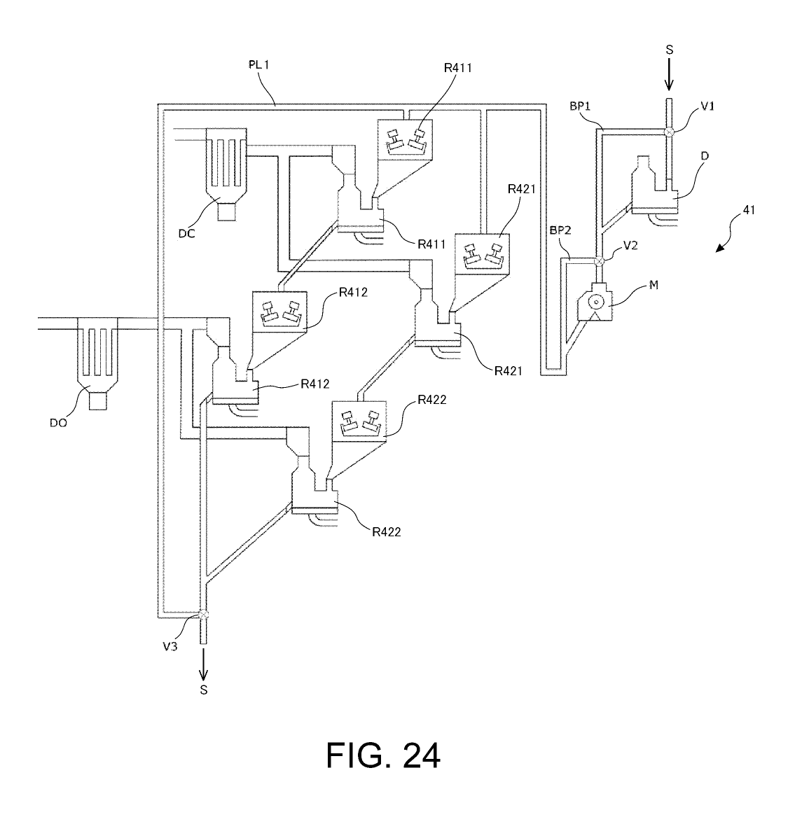

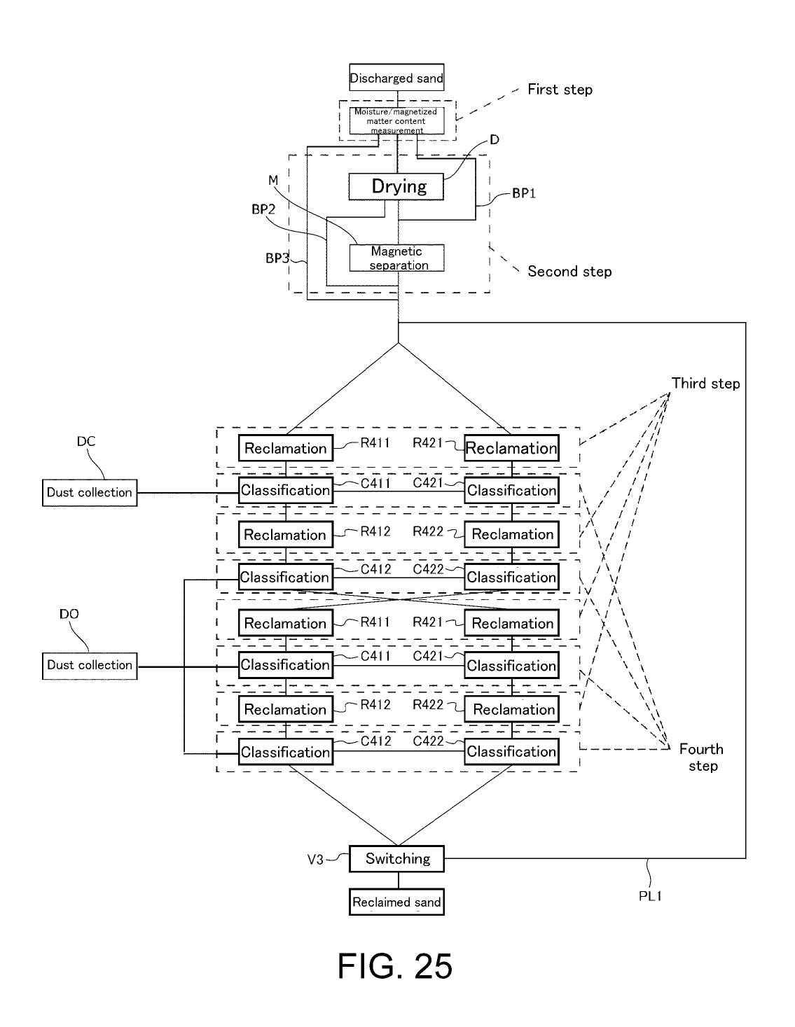

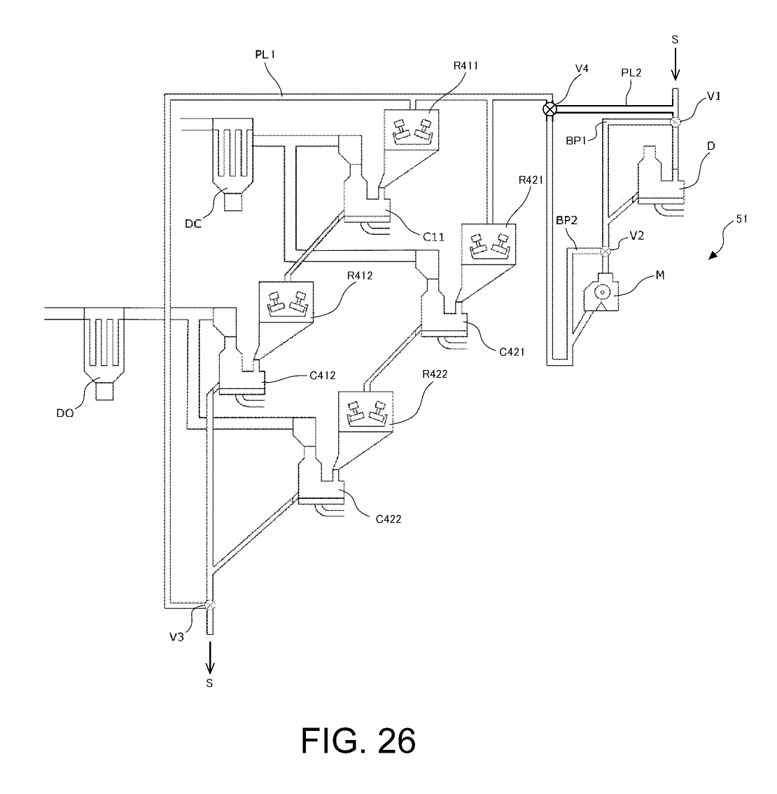

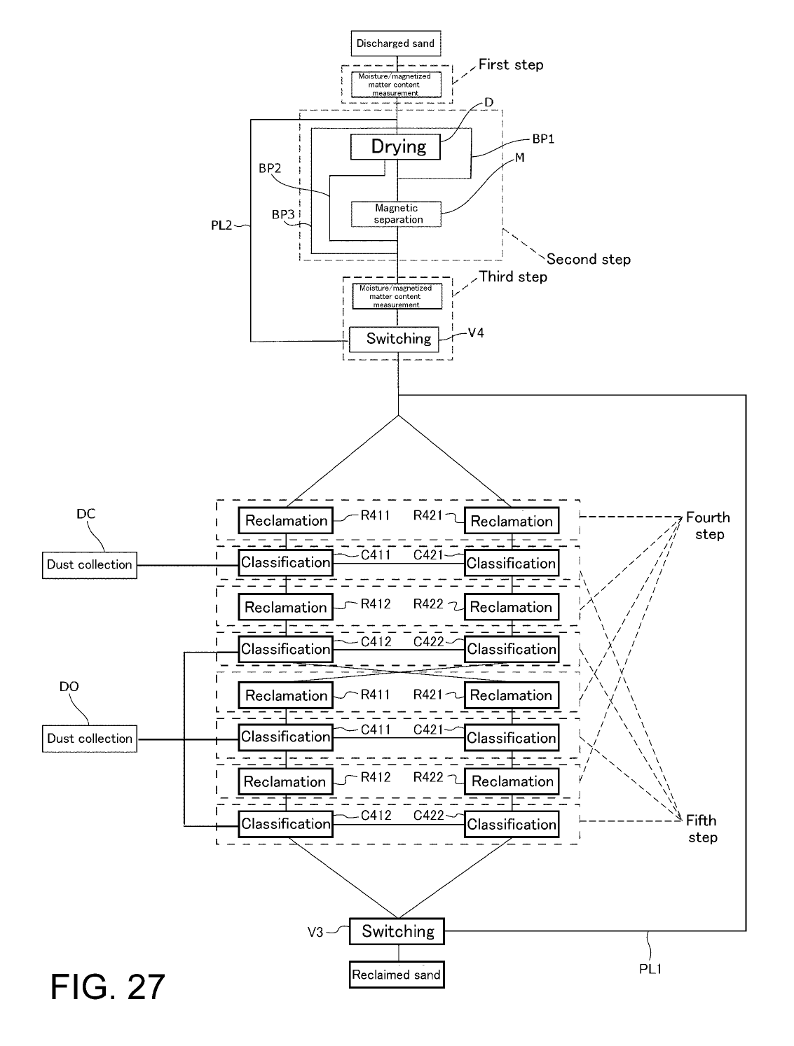

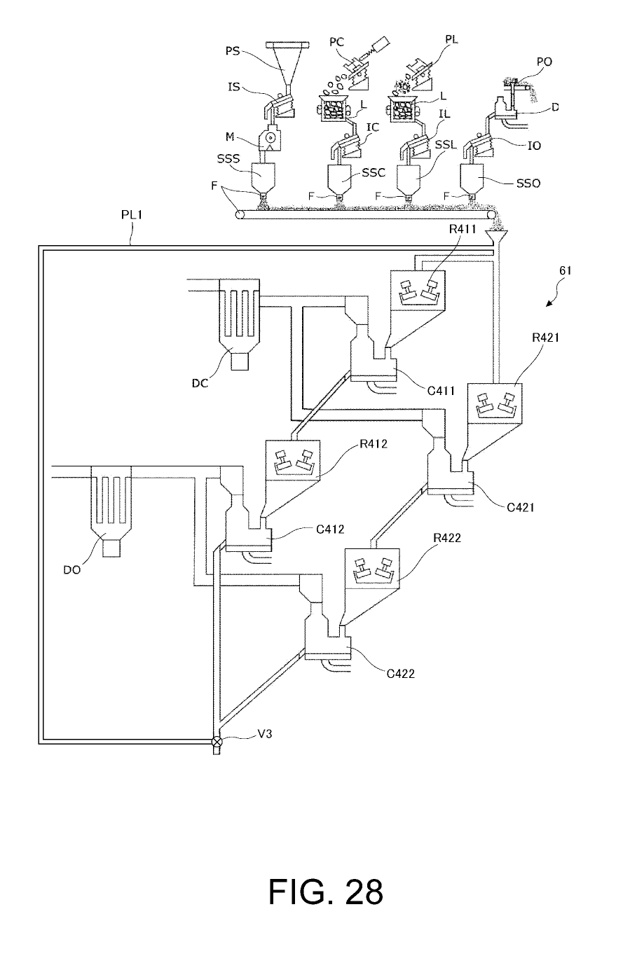

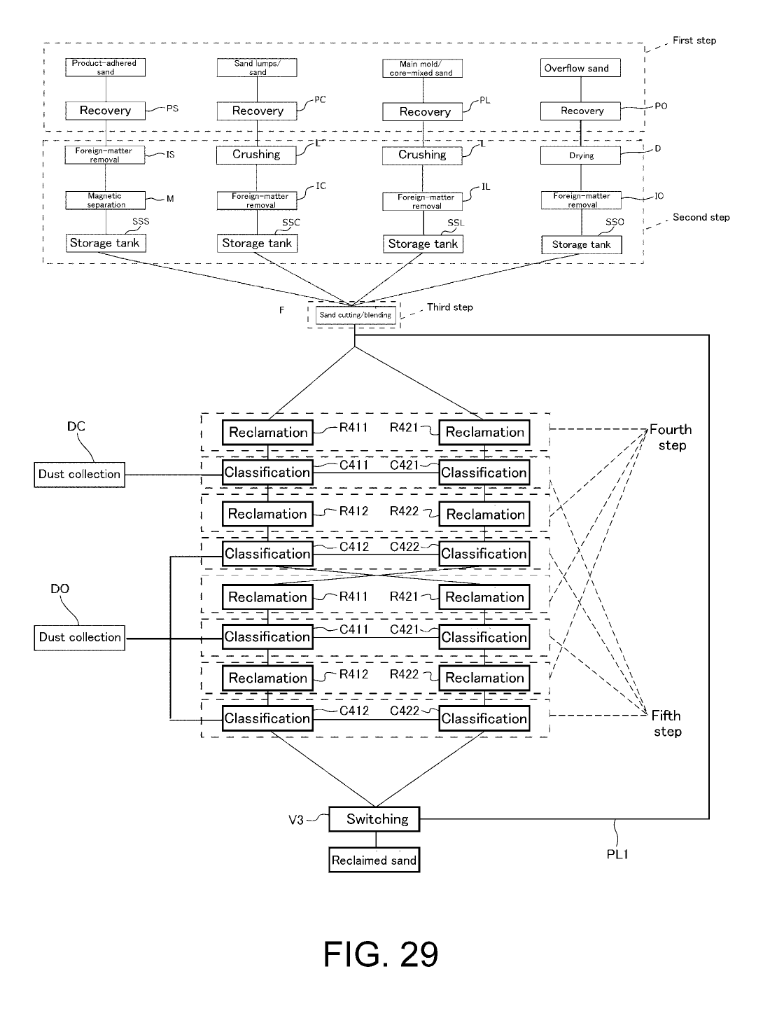

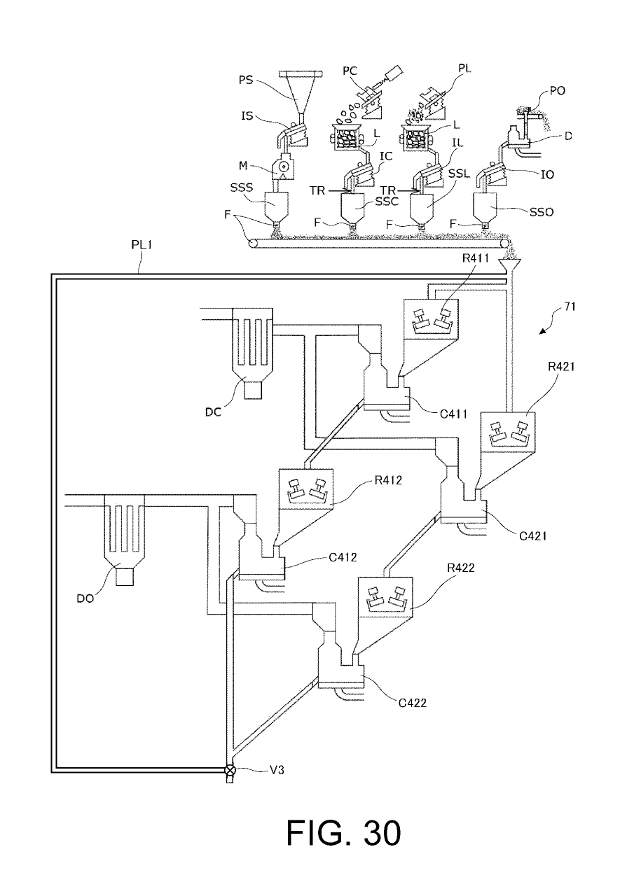

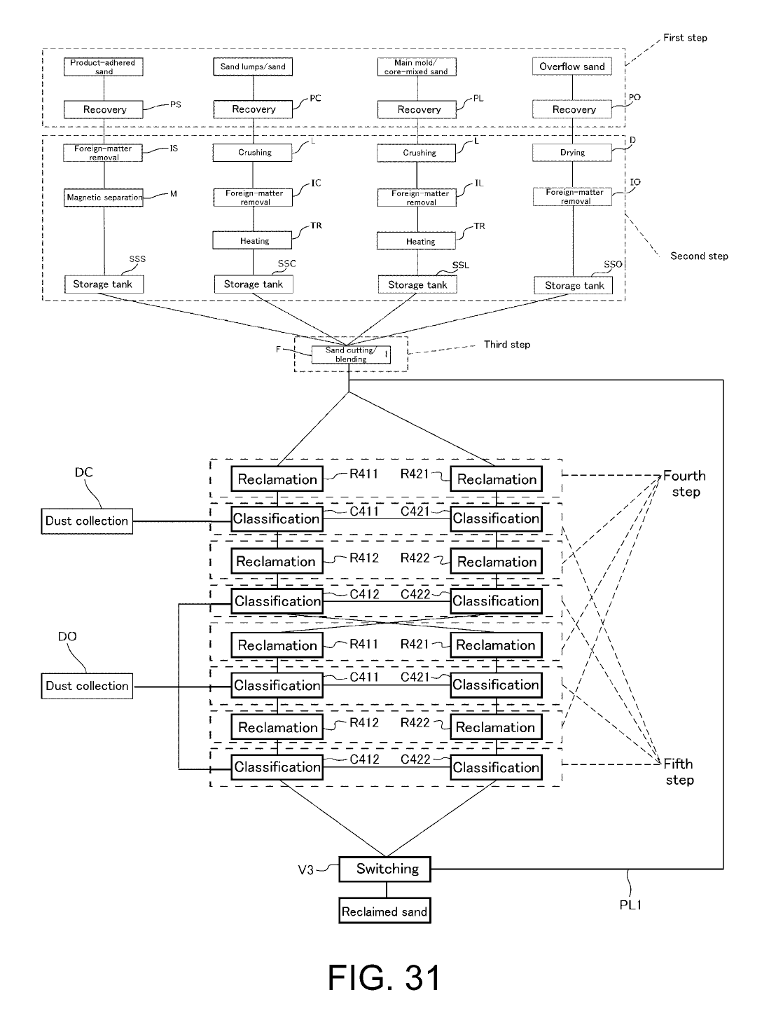

### BRIEF DESCRIPTION OF THE DRAWINGS

[FIG. 1] A schematic block diagram of molding sand reclamation equipment according to a first embodiment.

[FIG. 2] A schematic section view illustrating the structure of fluidized-bed hot-air drying equipment, which is a first example of drying equipment.

[FIG. 3] A schematic section view illustrating the structure of internal-combustion-type rotary kiln drying equipment, which is a second example of drying equipment.

[FIG. 4] A schematic section view of magnetic separation equipment.

[FIG. 5] A schematic section view of mechanical reclamation equipment, which is a first example of dry mechanical reclamation equipment.

[FIG. 6] A perspective view along the arrows A-A in FIG. 5.

[FIG. 7] A perspective view along the arrows B-B in FIG. 5.

[FIG. 8] A perspective view along the arrows C-C in FIG. 7.

[FIG. 9] A schematic section view of mechanical reclamation equipment, which is a second example of dry mechanical reclamation equipment.

[FIG. 10] A graph showing the correlation between the introduced sand flow rate and the target electric current value of a motor in the second example of dry mechanical reclamation equipment.

[FIG. 11] A flow chart according to the second example of dry mechanical reclamation equipment.

[FIG. 12] A schematic block diagram of a compressed-air ejection means.

[FIG. 13] A schematic section view of classification equipment.

[FIG. 14] A flow chart showing a molding sand reclamation method using reclamation equipment according to the first embodiment.

[FIG. 15] A schematic block diagram of molding sand reclamation equipment according to a second embodiment.

[FIG. 16] A flow chart showing a molding sand reclamation method using reclamation equipment according to the second embodiment.

[FIG. 17] A schematic block diagram of molding sand reclamation equipment according to a third embodiment.

[FIG. 18] A front view of sand crushing equipment.

[FIG. 19] A plan view of sand crushing equipment.

[FIG. 20] A section view along A-A in FIG. 19.

[FIG. 21] A flow chart showing a molding sand reclamation method using reclamation equipment according to the third embodiment.

[FIG. 22] A schematic block diagram of molding sand reclamation equipment according to a fourth embodiment.

[FIG. 23] A flow chart showing a molding sand reclamation method using reclamation equipment according to the fourth embodiment.

[FIG. 24] A schematic block diagram of molding sand reclamation equipment according to a fifth embodiment.

[FIG. 25] A flow chart showing a molding sand reclamation method using reclamation equipment according to the fifth embodiment.

[FIG. 26] A schematic block diagram of molding sand reclamation equipment according to a sixth embodiment.

[FIG. 27] A flow chart showing a molding sand reclamation method using reclamation equipment according to the sixth embodiment.

[FIG. 28] A schematic block diagram of molding sand reclamation equipment according to a seventh embodiment.

[FIG. 29] A flow chart showing a molding sand reclamation method using reclamation equipment according to the seventh embodiment.

[FIG. 30] A schematic block diagram of molding sand reclamation equipment according to an eighth embodiment.

[FIG. 31] A flow chart showing a molding sand reclamation method using reclamation equipment according to the eighth embodiment.

### MODES FOR CARRYING OUT THE INVENTION

Herebelow, embodiments for carrying out the molding sand reclamation method and reclamation equipment according to the present invention will be explained on the basis of drawings, by referring to the attached drawings.

### First Embodiment

The first embodiment will be explained with reference to the attached drawings. FIG. 1 is a schematic block diagram of molding sand reclamation equipment according to the first embodiment. The reclamation equipment 1 comprises drying equipment D, magnetic separation equipment M, switching equipment V1, switching equipment V2, a bypass system BP1, a bypass system BP2, dry mechanical reclamation equipment R, classification equipment C, switching equipment V3, a return system PL1 and dust collection equipment DC.

The drying equipment D dries molding sand S that is discharged from green sand casting equipment. The drying equipment D is connected, via the switching equipment V1, to an inlet for loading the molding sand S. The drying equipment D may be of any type as long as it has the ability to dry the molding sand S until the moisture content therein becomes equal to or less than a control value to be described below. For example, it may be of a type wherein air is heated by an electric or gas-based heat source, and the hot air is blown by a blower through the molding sand to dry away the moisture. The capacity that is necessary to dry the molding sand to a moisture content equal to or less than the control value is determined beforehand by experimentally measuring the moisture content before drying, and finding the amount of heat that is necessary to dry the moisture to equal to or less than the control value. The drying equipment D should preferably be drying equipment that has the ability to heat the molding sand S to at least 90° C.

The magnetic separation equipment M magnetically separates the molding sand discharged from green sand casting equipment, so as to remove magnetized matter from the molding sand S. Magnetized matter refers to sand grains that are in a state of fusion between a metal and a sand grain. The magnetic separation equipment M is connected to the drying equipment D via the bypass system BP1 and the switching equipment V2. The magnetic separation equipment M may be of any type as long as it has the ability to perform magnetic separation until the magnetized matter content in the molding sand S is equal to or less than a control value to be described below. For example, it may be of a type wherein a permanent magnet is disposed on the inside of half the circumference of a rotating drum, the molding sand is passed over the drum, and non-magnetic matter is separated from magnetized matter by the magnetic force of the permanent magnet. The capacity that is necessary to lower the magnetized matter content to equal to or less than the control value is determined beforehand by experimentally measuring the magnetized matter content before magnetic separation, and finding the capacity that is necessary to perform magnetic separation until the magnetized matter content is equal to or less than the control value. Additionally, the magnetic flux density of the magnetic separation equipment must be selected to be the same as the magnetic flux density of the magnet used to measure the magnetized matter content. The magnetic separation equipment M should preferably be half-magnetic outer-drum type magnetic separation equipment having a magnetic flux density of 0.15 to 0.5 T.

The switching equipment V1 is provided in front of the drying equipment D, the switching equipment V2 is provided in front of the magnetic separation equipment M, and they are respectively connected to the bypass system BP1 and the bypass system BP2. If the measured value of the moisture contained in the molding sand S discharged from the green sand casting equipment is not greater than the control value, then it is possible to choose, by means of the switching equipment V1, to make the molding sand S pass through the bypass system BP1 instead of passing through the drying equipment D.

Additionally, if the measured value of the magnetized matter contained in the molding sand S discharged from the green sand casting equipment is not greater than the control value, then it is possible to choose, by means of the switching equipment V2, to make the molding sand S pass through the bypass system BP2 instead of passing through the magnetic separation equipment M. Due to these features, it is possible to choose whether the molding sand S that is discharged from the green sand casting equipment should be transported to the dry mechanical reclamation equipment R via both the drying equipment D and the magnetic separation equipment M, transported to the dry mechanical reclamation equipment R via just one of the two types of equipment, or directly transported to the dry mechanical reclamation equipment R without passing through either type of equipment.

The dry mechanical reclamation equipment R reclaims the molding sand S by stripping away carbonized matter, sintered matter, metal compounds or the like that have adhered to the surface of the molding sand S discharged from the green sand casting equipment. The dry mechanical reclamation equipment R is connected to the end of the magnetic separation equipment M. The dry mechanical reclamation equipment R may be of any type as long as it has the ability to reduce the loss-on-ignition to equal to or less than a control value to be described below.

The classification equipment C classifies the reclaimed molding sand S by means of a specific-gravity classification system, and separates the sand grains, which are to be recovered, from the fine powders, such as carbonized matter, sintered matter and metal compounds, that is to be collected. The classification equipment C is connected to the end of the dry mechanical reclamation equipment R. The classification equipment C may be of any type as long as it is able to remove fine powders so that the total clay content in the reclaimed molding sand S is equal to or less than a control value to be described below.

Following the classification equipment C, switching equipment V3 is provided for switching between whether to discharge the classified reclaimed sand (molding sand S) from the reclamation equipment 1 or to return the reclaimed sand that has been classified to the loading port of the dry reclamation equipment R to repeat the reclamation process. The switching equipment V3 is connected to a return system PL1 for returning the reclaimed sand that has been classified to the dry mechanical reclamation equipment R. If the loss-on-ignition and the total clay content of the reclaimed sand that has been classified are not equal to or less than the control values, then the reclaimed sand that has been classified can be returned to the dry mechanical reclamation equipment R.

The dust collection equipment DC is connected to the classification equipment C, and collects dust (fine powders) generated in the classification equipment C.

Next, specific examples of the various types of equipment described above forming the present molding sand reclamation equipment 1 shall be explained.

### (First Example of Drying Equipment)

First, the drying equipment D shall be explained. FIG. 2 is a schematic section view illustrating the structure of fluidized-bed hot-air drying equipment, which is a first example of drying equipment D. The drying equipment D, which is fluidized-bed hot-air drying equipment, dries the molding sand S by heating the molding sand S to at least 90° C. The drying equipment D comprises an air compartment D1, a bottom plate D2, a settlement chamber D3, a sand discharge port D4, a sand loading port D5, a weir D6, a hot-air blowing pipe D7 and a dust collection port D8.

The air compartment D1 is provided on a lower portion of the drying equipment D, and hot air that is fed from the hot-air blowing pipe D7 is blown through the air compartment D1 and to the settlement chamber D3. The bottom plate D2 is provided on an upper portion of the air compartment D1, and is arranged so that the loaded molding sand S collects on the upper surface thereof. The bottom plate D2 is provided with air ejection ports D2a through which hot air from the air compartment D1 is blown into the settlement chamber D3. The settlement chamber D3 is provided on the upper portion of the drying equipment D, and allows the molding sand S that has been blown by the hot air to settle towards the bottom plate D2 by means of gravity. The sand discharge port D4 is provided on a tip of the bottom plate D2 and opens downwards from the equipment body. After being dried, the molding sand S is discharged through the sand discharge port D4. The sand loading port D5 is provided on the upper portion of the air compartment D1, and opens upwards from the equipment body. The molding sand S, before being dried, is loaded through the sand loading port D5. The bottom plate D2 is slightly tilted so as to be lower towards the side having the sand discharge port D4 and higher towards the side having the sand loading port D5.

The weir D6 is provided on the bottom plate D2 at a position adjacent to the sand discharge port D4. The weir D6 temporarily captures the fluidized molding sand S. The hot-air blowing pipe D7 is provided on the bottom portion of the air compartment D1, and is connected to a hot-air generation device, which is not shown. The hot-air blowing pipe D7 blows hot air generated by the hot-air generation device. The dust collection port D8 is provided on the upper end of the settlement chamber D3 and is connected to a dust collection device, which is not shown. Dust that has adhered to the molding sand S is collected in the dust collection device through the dust collection port D8.

In FIG. 2, hot air generated by the hot-air generation device is blown into the hot-air blowing pipe D7 simultaneously with the loading of molding sand S through the sand loading port D5. The hot air that is blown flows into the air compartment D1, and is further blown through the air ejection ports D2a in the bottom plate D2 and into the settlement chamber D3. Then, the molding sand S that has collected on the bottom plate D2 is blown by the hot air, thereby reducing the moisture by means of evaporation. Gradually, the molding sand S is fluidized, and begins sliding over the bottom plate D2, with a portion floating within the settlement chamber D3. At this time, the dust that has adhered to the molding sand S separates from the molding sand S. The sliding molding sand S advances along the tilt of the bottom plate D2 towards the sand discharge port D4, after which the sliding is stopped by the weir D6. Thus, the molding sand S begins to form a layer at this location. Furthermore, if molding sand S is continuously loaded through the sand loading port D5, the layer of molding sand S will flow over the weir D6 and be discharged from the sand discharge port D4.

At this time, by collecting the dust from the dust collection port D8, the dust and molding sand S floating inside the drying equipment D (settlement chamber D3) float towards the dust collection port D8, but the molding sand S falls away due to gravity before reaching the dust collection port D8. As a result, the dust and hot wind (air) are discharged through the dust collection port D8, and the molding sand S is discharged through the sand discharge port D4.

In this case, the molding sand S cannot be dried so as to reduce the moisture to equal to or less than the control value unless the molding sand S being dried is heated to a temperature that is sufficient to evaporate the moisture. In order to do so, the molding sand S inside the drying equipment D must be heated to a temperature of at least 90° C., and the amount of heat supplied from the hot-air generation device must be determined by considering, beforehand, the amount of molding sand S to be supplied, and the percentage of moisture that must be evaporated, at maximum, between the sand loading port D5 and the sand discharge port D4.

Furthermore, in order to provide efficient drying, the flow of hot air from the hot-air blowing pipe D7 to the air compartment D1, through the air ejection ports D2a and the settlement chamber D3, and to the dust collection port D8 must always be present, and it is necessary to prevent the leakage of hot air to the outside of the equipment body. For that purpose, it is necessary to make the amount of hot air that is fed from the hot-air blowing pipe D7 equal to the amount of air that is collected at the dust collection port D8, or to make the amount of air that is collected at the dust collection port D8 larger.

### (Second Example of Drying Equipment)

FIG. 3 is a schematic section view illustrating the structure of internal-combustion-type rotary kiln drying equipment, which is a second example of the drying equipment D. The drying equipment D, which is internal-combustion-type rotary kiln drying equipment, dries molding sand S by heating the molding sand to at least 90° C. The drying equipment D comprises a cylinder D101, a sand loading port D102, a burner D103, a sand discharge port D104, a sand discharge port D105, agitation plates D106, a support stand D107 and a drive source D108.

The cylinder D101 is disposed at the center of the drying equipment D, and rotatably supported. The cylinder D101 is arranged so that the loaded molding sand S collects inside the cylinder. The sand loading port D102 is provided at one end of the cylinder D101. The molding sand S, before being dried, is loaded into the sand loading port D102. The burner D103 is inserted into and positioned at approximately the center of the cylinder D101, on the end of the cylinder D101 opposite from the sand loading port D102. By lighting the burner D103, the temperature inside the cylinder D101 is raised. The sand discharge port D104 is provided below the burner D103, and opens downwards from the cylinder D101. After being dried, the molding sand S is discharged from the sand discharge port D104. The sand discharge port D105 is provided above the burner D103, and opens upwards from the cylinder D101.

Multiple agitation plates D106 are arranged in a spiral on the inner surface of the cylinder D101. By rotating the cylinder D101, the agitation plates D106 are made to agitate the molding sand S inside the cylinder D101. The support stand D107 is provided under the cylinder D101, and rotatably supports the cylinder D101. The drive source D108 is provided under the cylinder D101 and rotates the cylinder D101. The cylinder D101 is supported on the support stand D107 in a slightly tilted state such that the side having the sand loading port D102 is higher and the side having the sand discharge port D104 is lower.

In FIG. 3, the burner D103 is lit beforehand, and the temperature inside the cylinder D101 is allowed to rise. In this state, the cylinder D101 is rotated, and molding sand S is loaded through the sand loading port D102. The molding sand S is heated and dried while being agitated by the agitation plates D106 inside the heated cylinder D101. Thereafter, the molding sand S reaches the sand discharge port D104 and is discharged through the sand discharge port D104.

In this case, the molding sand S cannot be dried so as to reduce the moisture to equal to or less than the control value unless the molding sand S being dried is heated to a temperature that is sufficient to evaporate the moisture. In order to do so, the molding sand S inside the drying equipment D must be heated to a temperature of at least 90° C., and the amount of heat supplied from the burner D103 must be determined by considering, beforehand, the amount of molding sand S to be supplied, and the percentage of moisture that must be evaporated, at maximum, between the sand loading port D102 and the sand discharge port D104.

The configuration of the drying equipment D is not limited to these two possibilities, and any structure may be used as long as it is capable of heating the molding sand S to at least 90° C. For example, the drying equipment may be a mechanism that dries the molding sand by blowing hot air while vibration-conveying the molding sand, or the drying equipment may be of a type that dries the molding sand S by continuously agitating the molding sand S while blowing hot air, and there would be no problem in using drying equipment, such as an external-combustion-type rotary kiln, wherein the heat source is provided outside the cylinder.

The drying equipment D has the ability to heat the molding sand S to at least 90° C., and is therefore able to effectively dry the moisture remaining in the sand grains to equal to or less than the control value.

### (Magnetic Separation Equipment)

Next, the magnetic separation equipment M shall be explained. FIG. 4 is a schematic section view of magnetic separation equipment M. The magnetic separation equipment M magnetically separates the molding sand S by means of a magnetic flux density within the range of 0.15 to 0.5 T so as to remove magnetized matter from the molding sand S. The magnetic separation equipment M is half-magnetic outer-drum type magnetic separation equipment. The magnetic separation equipment M comprises a permanent magnet M1, a rotating drum M2, an inlet-side dumper M3, an outlet-side separation plate M4, a sand loading port M5, a sand discharge port M6, a magnetized matter discharge port M7, and a housing M8.

The permanent magnet M1 is fixed to the center of the equipment and is arranged so as to impart a magnetic force within the range of conveyance of the molding sand S. The rotating drum M2 is closely arranged on the outer circumference of the permanent magnet M1, and has a mechanism that is rotated by a drive source, not shown. The rotating drum M2 has an upper end M2a and a lower end M2c. The inlet-side dumper M3 is arranged directly above the rotating drum M2, and has a mechanism that allows the degree of opening to be freely adjusted. The outlet-side separation plate M4 is arranged directly below the rotating drum M2 so as to leave a gap with respect to the rotating drum M2, and has a mechanism that allows the degree of opening to be freely adjusted. The sand loading port M5 is arranged directly above the rotating drum M2, adjacent to the inlet-side dumper M3. The sand discharge port M6 opens downward, directly below the rotating drum M2, between the outlet-side separation plate M4 and the housing M8, on the side having the permanent magnet M1. The magnetized matter discharge port M7 opens downward, directly below the rotating drum M2, between the outlet-side separation plate M4 and the housing M8, on the side opposite from the sand discharge port M6. The housing M8 covers the entirety of the magnetic separation equipment M.

In FIG. 4, when the molding sand S is loaded into the sand loading port MS while the rotating drum M2 is being rotated in a counterclockwise direction, with the inlet-side dumper M3 adjusted to a state allowing a standard amount to be cut out (extracted), the molding sand S is transported from a position at the upper end M2a of the rotating drum M2 to a state in which a layer is formed on the rotating drum M2. When the rotation of the rotating drum M2 is advanced and the rotating drum M2 passes the midpoint M2b, the molding sand S drops from the rotating drum M2, and is discharged through the sand discharge port M6. The magnetized matter E is conveyed to the lower end M2c of the rotating drum M2, and at that point, falls away from the rotating drum M2. At this time, if the outlet-side separation plate M4 is tilted towards the molding sand discharge port M6, then the ratio of the magnetized matter E falling from the lower end M2c of the rotating drum M2 that is discharged from the magnetized matter discharge port M7 increases, and conversely, if the outlet-side separation plate M4 is tilted towards the magnetized matter discharge port M7, then the ratio of the magnetized matter E falling from the lower end M2c of the rotating drum M2 that is discharged from the sand discharge port M6 increases. Therefore, the position of the outlet-side separation plate M4 must be adjusted to an appropriate position in consideration of the yield of the magnetized matter E.

Additionally, the efficiency of magnetic separation is determined, aside from the magnetic flux density, by the thickness of the molding sand S that forms a layer on the rotating drum M2. If this thickness becomes excessive, even if magnetic separation is performed at an appropriate magnetic flux density, the magnetized matter E will fall away between the midpoint M2b of the rotating drum M2 and the lower end M2c of the rotating drum M2, thus remaining within the molding sand S. For this reason, the diameter and lateral width of the permanent magnet M1 must be chosen in consideration of the amount of molding sand S that is supplied, so that the thickness of the molding sand S forming a layer on the rotating drum M2 is 5 mm or less.

The magnetic separation equipment M has a magnetic flux density of 0.15 to 0.5 T, and is of the half-magnetic outer-drum type, and is therefore capable of efficiently removing magnetized matter that remains in the molding sand S.

### (First Example of Dry Mechanical Reclamation Equipment)

Next, the dry mechanical reclamation equipment R will be explained. FIG. 5 is a schematic section view of mechanical reclamation equipment, which is a first example of dry mechanical reclamation equipment R. FIG. 6 is a perspective view along the arrows A-A in FIG. 5, FIG. 7 is a perspective view along the arrows B-B in FIG. 5, and FIG. 8 is a perspective view along the arrows C-C in FIG. 7. The dry mechanical reclamation equipment R reclaims the molding sand S by stripping away carbonized matter, sintered matter, metal compounds or the like that have adhered to the surface of the molding sand S.

In the first example, the dry mechanical reclamation equipment R comprises a continuous-type sand supply chute R2 provided with a sand dropping port at a lower end, a rotating drum R4 that is provided so as to be able to rotate horizontally below the sand supply chute R2, and at least one roller R12 that is provided inside the rotating drum R4.

More specifically, a funnel-shaped sand supply chute R2 is suspended over the upper end portion of a processing tank R1 having a pyramidal portion R1b coupled to the lower portion of a square tube portion R1a, and the lower end of the sand supply chute R2 is provided with a sand supply port R3 through which a constant flow of sand continually drops via a gate that is not shown. The rotating drum R4 is provided underneath the sand supply chute R2, and the rotating drum R4 has a configuration wherein an inclined circumferential wall R4b, which extends diagonally upward and outward from the circumferential edges of a circular bottom plate R4a, and a weir R4c, which protrudes inward from the upper end of the inclined circumferential wall R4b, are integrally connected.

Although the linkage between the rotating drum R4 and the motor R9 is not particularly limited, it is possible, for example, to fix a rotary shaft R5 to the central portion of the bottom surface of the circular bottom plate R4a of the rotating drum R4, and to have the rotating shaft R5 rotatably supported by a bearing R7 mounted on a hollow support frame R6. A V pulley R8a is mounted on the lower end of the rotary shaft R5, and allows the transmission of motion, via a V belt R11 and a V pulley R8b, from a rotary shaft R10 of a motor R9 that is mounted on a support frame R6 on the outside of the processing tank R1. Inside the rotating drum R4, two rollers R12, R12 are provided with a slight gap with respect to the inclined circumferential wall R4b, and so as to be perpendicular to the inclined circumferential wall R4b. Support shafts R13, R13 are connected to the central portions of the upper surfaces of the rollers R12, R12 so as to be capable of rotation with respect to each other.

The upper ends of the support shafts R13, R13 are fixed to ends of support arms R14, R14 extending in a lateral direction (parallel to the rollers R12, R12), and the other ends of the support arms R14, R14 are coupled, via bearings R15, R15, to the ends of horizontal shafts R16, R16 that are supported so as to be capable of vertical rotation and that extend in directions intersecting with the support arms R14, R14. The other ends of the horizontal shafts R16, R16 protrude through the square tube portion Rla to the outside, and are fixed to the upper ends of rotating arms R17, R17. Furthermore, the bottom ends of the two rotating arms R17, R17 are coupled by a cylinder R18, forming, as a whole, a roller pressing mechanism P. In other words, a constant pressure is continually applied to the rollers R12, R12 in the direction of the inclined circumferential wall R4b, via the rotating arms R17, the horizontal shafts R16 and the arms R14. Similar functions and effects can be obtained by coupling the lower ends of the rotating arms R17, R17 with a compressed coil spring instead of a cylinder R18.

The equipment which is configured in this way is supplied with the molding sand S in the sand supply chute R2 while the motor R9 is being driven so that the rotating drum R4 is rotated in the direction of the arrow in FIG. 6. As a result, a constant amount of molding sand S is continuously supplied from the sand supply port R3 to the central portion of the circular bottom plate R4a of the rotating drum R4. The supplied molding sand S is moved in an outward direction by the centrifugal force of the rotating drum R4, and is further accumulated while being pressed by the centrifugal force against the inner surface of the inclined circumferential wall R4b, thereby increasing in thickness and forming a sand layer L. When the thickness of this sand layer L becomes thicker than the gap between the inclined circumferential wall R4b and the rollers R12, R12, the rollers R12, R12 begin rotating due to the frictional force from the molding sand S. As time further passes, the sand layer L becomes even thicker and rides over the weir R4c. Thereafter, the thickness is held constant at approximately the same thickness as the width of the weir R4c.

In this state, the sand layer L rotates together with the rotating drum R4, and upon arriving at the positions of the rollers R12, R12, is pinched between the rollers R12, R12 and the inclined circumferential wall of the rotating drum R4, and is subjected to a constant pressing force such that a shearing action arises inside the sand, as a result of which deposits on the surfaces of the molding sand S are stripped and removed, thereby reclaiming the sand. This sand reclamation is performed by a shearing action while a constant pressure is being applied by the rollers R12, so deposits are efficiently stripped and the sand is not crushed very much. The reclaimed sand rides over the weir R4c, falls to the lower part of the processing tank R1, and is subsequently delivered to the classification equipment C shown in FIG. 1. As described above, the supply of molding sand S into the rotating drum R4, the sand reclamation inside the rotating drum R4, and the discharge of the reclaimed sand are performed continuously, so that the molding sand S is being continuously reclaimed.

In the above-described configuration, an upward widening inclined surface that extends upward and outward from the circumferential wall R4b of the rotating drum R4 is used because, when the sand layer L is formed by the centrifugal force, the inner diameter of the accumulated layer becomes smaller towards the bottom, due to the effects of gravity. Therefore, such a structure is used in order to keep the thickness of the sand layer L constant in the up-down direction. As a result, the pressure from the rollers R12, R12 is kept even, and more efficient sand reclamation is achieved. Additionally, while two rollers R12 are provided in the above-described configuration, there may be just one, or there may be three or more.

Furthermore, by using a polishing material such as abrasive grains as the material of the outer circumferential portions of the rollers R12, R12, the sand that is pinched between the inclined circumferential wall R4b of the rotating drum R4 and the rollers R12, R12 is polished by the polishing material simultaneously with the sand reclamation, thereby allowing the reclamation efficiency to be further improved. Additionally, the rollers R12, R12 are in a state of applying a constant pressure in the direction of the inclined circumferential wall R4b. Thus, even if there is slight wear or the like, the molding sand S can be pressed at a constant pressure, allowing the sand reclamation to be stabilized.

Additionally, in the mechanical reclamation equipment R, the strength of reclamation is represented by the load current of the motor R9, but the load current of the motor R9 is determined by the thickness of the sand layer L and the pressing force of the roller pressing mechanism P. Therefore, the most efficient reclamation can be performed by optimally adjusting the width of the weir R4c and the pressing force of the roller pressing mechanism P.

The driving power of the cylinder R18 is not particularly limited and may be pneumatic, water-based hydraulic, oil-based hydraulic or electric, but by using a combination pneumatic and oil-based hydraulic cylinder in particular, it is possible to achieve quick reactions when adjusting the pressing force.

Due to this configuration, the mechanical reclamation equipment R is able to perform reclamation very efficiently.

### (Second Example of Dry Mechanical Reclamation Equipment)

FIG. 9 is a schematic section view of mechanical reclamation equipment, which is a second example of the dry mechanical reclamation equipment R, FIG. 10 is a graph showing the correlation between the loaded sand flow rate and the motor target electric current value in the second example of the dry mechanical reclamation equipment R, and FIG. 11 is a flow chart according to the second example of the dry mechanical reclamation equipment 2. The dry mechanical reclamation equipment R reclaims the molding sand S by stripping away carbonized matter, sintered matter, metal compounds or the like that have adhered to the surface of the molding sand S.

In the second example, the dry mechanical reclamation equipment R is molding sand reclamation equipment comprising a sand loading portion R101 having a sand dropping port for loading sand (molding sand S) at a lower end, a rotating drum R102 that is provided so as to be able to rotate horizontally below the sand loading portion R101, motor driving means R104 for rotating the rotating drum R102 by means of a motor R103, rollers R105, R105 that are disposed inside the rotating drum R102 with a gap therebetween, and roller pressing mechanisms R107, R107 in which cylinders R106, R106 are coupled to the rollers R105, R105, the mechanisms R107, R107 pressing the rollers R105, R105 towards the rotating drum R102. The equipment further comprises a sand flow rate detector R108 that is installed at the sand dropping port of the sand loading portion and that detects the flow rate of the loaded sand, a current detector R109 that detects the electric current value of the motor driving means R104, pressure control means R110 for the cylinders R106, R106, and control means R111.

The rotating drum R102 has a configuration wherein an inclined circumferential wall R102b extending diagonally upwards and outwards from the circumferential edges of a circular bottom plate R102a is connected to a weir R102c that protrudes inward from the upper end of the inclined circumferential wall R102b. The rollers R105, R105 are arranged so as to leave a slight gap with respect to the inclined circumferential wall R102b. Additionally, a chute R112 is provided so as to surround the rotating drum R102. As a result, reclaimed sand (molding sand S) that has been subjected to a shearing action while being pressed at a constant pressure by the rollers R105, R105 rides over the weir R102c, is collected in the chute R112, and is delivered to the classification equipment C.

Although the motor driving means R104 is not particularly limited, it is possible to use a mechanism wherein a rotating drum R102 is driven by a motor R103 and a belt. In this configuration, a rotary shaft R115a that is supported by a bearing portion R114 mounted to a gate-shaped frame R113 is fixed to the central portion of the lower surface of the circular bottom plate R102a of the rotating drum R102. A pulley R116a is mounted on the lower end of the rotary shaft R115a. Additionally, on the outside of the equipment body, a motor R103 is attached to the frame R117. As a result, the driving power of the motor R103 can be transmitted to the rotating drum R102 by means of a pulley R116b mounted on the rotary shaft R115b of the motor R103 and a belt R118 that is wrapped around the pulley R116a .

The roller pressing mechanism R107 is not particularly limited as long as it is able to use a mechanism that causes a roller R105 to apply pressure by means of a cylinder R106. The present configuration comprises a connector R119 that is fixed to an upper end surface of the roller R105, a shaft R120 that is inserted through and supported by the connector R119, an arm R121 coupled to the shaft R120 and a cylinder R106 coupled to the arm R121. Additionally, a rod of this cylinder R106 is rotatably coupled to the upper end portion of the arm R121. In the present configuration, two rollers R105 are provided, but the number of rollers R105 can be chosen as appropriate.

The sand flow rate detector R108 is not particularly limited as long as it is a detector that is installed at the sand dropping port of the sand loading portion R101 and is able to detect the flow rate of the loaded sand. For example, it is possible to use an apparatus that measures the weight of sand that is dropped from a certain height by a loading cell or the like. Additionally, the current detector R109 is not particularly limited as long as it is a detector that is able to detect the electric current value of the motor driving means R104. For example, it is possible to use a device that converts, to numerical data, the signals of a current transformer that is used for displaying the electric current.

Furthermore, the pressure control means R110 is not particularly limited as long as it is able to adjust the pressing force due to the cylinders R106. In the present configuration, it is a mechanism comprising an electromagnetically switched valve R123 connected to a hydraulic pipe R122, a pressure control valve R124, a hydraulic pump R125 and a hydraulic tank R126. This pressure control valve R124 controls the pressure of oil that is fed thereto so as to be proportional to the magnitude of an output signal of the control means R111, and feeds the oil to the cylinders R106. In this configuration, the cylinders R106 are hydraulic cylinders, but they may be pneumatic cylinders, combination pneumatic/hydraulic cylinders, or electric cylinders. In this case, it is possible to employ a mechanism that can appropriately adjust the pressing force due to the cylinders in accordance with the type of cylinder.

The control means R111 is configured to adjust the pressing force of the rollers R105 due to the cylinders R106 in accordance with the sand flow rate detected by the sand flow rate detector R108. In the present configuration, it comprises a target current computation portion that calculates the electric current value of the motor R103 corresponding to a sand flow rate detected by the sand flow rate detector R108 so as to maintain a preset correlation between the sand flow rate to be loaded into the rotating drum R102 and the electric current value of the motor R103 corresponding to the sand flow rate, a comparison portion that compares the target electric current value of the motor R103 corresponding to the calculated sand flow rate with the electric current value of the motor R103 actually measured during operation, and a control portion that adjusts the pressing force of the rollers R105 due to the cylinders R106 so that the electric current value of the motor R103 during operation matches the target electric current value, based on the results from the comparison portion. Specifically, the computation involves calculating the negative feedback amount. In other words, it involves calculating how much the current pressure setting should be raised or lowered, or whether it should be left the same, in order to approach the target electric current value.

The correlation can be determined as a target electric current value for the electric current value of the motor R103 that is necessary to reclaim the sand at the flow rate being loaded into the rotating drum R102, based on the sand flow rate that is determined by specifications and the electric current value that is determined by the differences in the level of polish required in the reclaimed sand, e.g. about 80 to 100 A for sand that is easy to polish and about 100 to 120 A for sand that is difficult to polish. For example, considering equipment having a sand flow rate of about 2 to 5 t/h, if the electric current value that is necessary in the motor R103 when reclaiming sand at a flow rate of 5 t/h is 100 A, then the target electric current value for the motor R103 in accordance with the sand flow rate will be 88 A when the sand flow rate that is loaded into the rotating drum R102 is 4 t/h, as shown in FIG. 10. In the present configuration, when the sand flow rate is reduced from 5 t/h to 4 t/h, the pressing force of the rollers R105 due to the cylinders R106 is adjusted so that the electric current value of the motor R103 during operation matches the target electric current value of 88 A.

The correlation in the present configuration represents the adjustment of the electric current value in accordance with the loaded sand flow rate as a straight line, but similar control is possible even if the correlation is represented by a curve.

Additionally, the comparison portion preferably comprises a computation portion that compares the target electric current value of the motor R103 corresponding to the loaded sand flow rate with the electric current value of the motor R103 actually measured during operation, then calculates an increase/decrease rate of the pressing force of the rollers R105 due to the cylinders R106. For example, the pressing force due to the cylinders R106 is adjusted by computing the increase/decrease rate (pressure increase rate or pressure decrease rate) obtained from the following equation (1) in 1 second cycles. In this case, the sensitivity is for regulating sudden changes in the increase/decrease rate, and may, for example, be 0.2.

(Equation 1)

Increase/decrease rate=(target electric current value/measured electric current value−1)×sensitivity+1 (1)

As a specific computation example for the pressing force, when the target electric current value=88 A, the measured electric current value=80 A and the sensitivity=0.2, the increase/decrease rate=(88/80−1)×0.2+1=1.02. Therefore, if the current pressure setting is 100 kPa, then the pressure setting after 1 second is set to 100×1.02=102 kPa.

Additionally, in the present configuration, a computation means for calculating the cumulative weight of the processed sand is provided as an additional function of the control means R111. This computation means performs an integration computation, over the processing time, of the sand flow rate measured by the sand flow rate detector R108, to calculate the cumulative weight of the processed sand. For example, a method for performing an integration computation of the measured sand flow rate over the processing time is to set a sampling time to 1 second, set the subtotal of the amount of sand at the processing starting time to zero, and to compute the amount of sand being processed by means of the following equation (2), at 1 second intervals.

(Equation 2)

Sand amount subtotal=sand amount subtotal+sand flow rate per unit time× 1/3600 (2)

Next, after integrating the sand amount that is being processed, the cumulative weight of the processed sand (cumulative sand amount) at the time of completion of the process can be computed by using the following equation (3).

(Equation 3)

Sand amount cumulative total=sand amount cumulative total+sand amount subtotal (3)

The reason for separating the procedure for determining the cumulative total into two stages between a subtotal and a cumulative total is in order to preserve the accuracy of the computation. For example, when processing 2 to 5 t/h, 0.6 to 1.4 kg of sand flows per second. Therefore, if operated for 2000 hours in one year, the amount of sand processed will be (0.6 to 1.4)×3600×2000=4,320,000 to 10,080,000 kg. Since the computation is made down to a floating point with seven significant figures during the computation process, a high-precision computation can be made by direct summation as long as the cumulative total is small. However, if the cumulative total is not reset for a long time, the computation result may exceed seven digits as in the aforementioned case. In this case, a problem occurs in that the smaller significant figures are lost and not added at all. Therefore, the subtotal is determined for each reclamation process, the smaller digits are shifted by about three digits, and then added to the cumulative total so as to provide a high-precision computation.

Additionally, the calculated cumulative weight of the processing sand is displayed on a display device, for example, a personal computer, a graphic touch panel or the like, and recorded in a memory card or the like. In the present configuration, this recorded information (data) on the cumulative weight of processed sand can be used to manage the amount of sand during a casting mold making process, or to manage the time of replacement of consumable parts in the equipment, such as the rollers R105 or the rotating drum R102.

The equipment that is configured in this way is operated in accordance with the flow chart in FIG. 11. In the present configuration, the equipment reclaims sand at a flow rate of 5 t/h, and a motor having a target electric current value of 100 A is used. The correlation in this case is shown in FIG. 10. Thus, the correlation between the sand flow rate loaded into the rotating drum and the target electric current value of the motor corresponding to the sand flow rate is set and stored (step S1). Next, the sand reclamation equipment is activated. Then, the loading of sand into the rotating drum is started (step S2). Next, the current flow rate of the loaded sand is calculated by a sand flow rate detector installed at the sand loading portion (step S3). Next, the target electric current value of the motor corresponding to the loaded sand flow rate is calculated from the correlation (step S4).

Next, the current (during operation) electric current value (measured electric current value) of the motor is calculated, and compared with the target electric current value of the motor corresponding to the flow rate of the loaded sand (steps S5 and S6). Next, the increase/decrease rate of the roller pressing force due to the cylinders is calculated (step S7). Next, the increase/decrease rate obtained from Equation (1) is calculated at intervals of the sampling time, e.g. 1 second, the cylinder pressing force setting is increased or decreased, and the electric current value of the motor is increased or decreased. The sensitivity at this time was set to 0.2 (step S8).

With the present configuration, the quality of the reclaimed sand can be improved by controlling the pressing force due to the cylinders in accordance with the target electric current value of the motor corresponding to the loaded sand flow rate.

Additionally, with the present configuration, the main data in the reclamation equipment are recorded during operation, the obtained records are analyzed to monitor changes in the operation state of the equipment or in the properties of the sand, and if the appropriate range is exceeded, then an alert is issued to take countermeasures, thereby preventing the occurrence of major problems and thus allowing the quality of the reclaimed sand to be controlled. Monitoring may involve providing a display on a display screen, and when the appropriate range is exceeded, displaying the reason therefor and a method that can be performed as a countermeasure. Examples of the main data include the loaded sand flow rate, the electric current value of the motor, and settings for the extension and the pressing force of the cylinders. For example, extreme decreases in the loaded sand flow rate may cause the rollers to suddenly heat up and break, so the sand flow rate is monitored.

In order to manage the variations in the electric current value due to differences in the target electric current value and the electric current value of the motor, the electric current value of the motor is recorded and monitored. If an abnormality is displayed only when the extension of the cylinders exceeds the appropriate range (e.g., 70 to 110 mm), then the process leading thereto will be unclear, so the values are recorded. Additionally, if the extension of the cylinders becomes greater even though the values of the sand properties or the pressing force of the rollers or the like have not changed, then the rollers or the rotating drum may be worn, so the extension of the cylinders is monitored. The extension of the cylinders can be measured by connecting position sensors, e.g. linear gauges R127, R127 to the rods of the cylinders R106. Additionally, since there is also a controllable range for the pressing force of the rollers, the pressing force of the rollers is also monitored.

Thus, the present configuration preferably comprises a memory portion that records the main data during operation, a determination portion that determines whether or not the recorded main data are within respectively appropriate ranges, and an alert instruction portion that issues an alert urging that countermeasures be taken when, as a result of the determination, main data are determined to be outside the appropriate range.

Due to this configuration, the mechanical reclamation equipment R is controlled so that the roller pressing force is always held in an optimal state with optimal conditions in accordance with variations in the properties of the supplied sand (molding sand S), so that the properties of the reclaimed sand can always be held constant.

### (Compressed-Air Ejection Means)

Next, the compressed-air ejection means used in the dry mechanical reclamation equipment R will be explained. FIG. 12 is a schematic block diagram of a compressed-air ejection means 2. The compressed-air ejection means 2 ejects compressed air at and removes accumulated fine powders that are deposited and accumulated on the inclined circumferential walls of the dry mechanical reclamation equipment R. The purpose is to remove the accumulated fine powders by ejecting compressed air before the accumulated fine powders layer becomes attached, since the fine powders that have been stripped from the molding sand S by reclamation will be deposited and accumulate on the inclined circumferential walls and form layers that can become attached, in which case the pressing force can be insufficient and the reclamation efficiency may be significantly reduced.

The compressed-air ejection means 2 comprises a pressure regulation valve R201 that regulates the pressure of the compressed air from a compressed-air source, not shown, a flow rate regulation valve R202 that adjusts the flow rate of the compressed air from the pressure regulation valve R201, a nozzle R203 that ejects compressed air that has flowed through the pressure regulation valve R201 and the flow rate regulation valve R202, and a control means R204 that controls the pressure regulation valve R201 and the flow rate regulation valve R202. Additionally, in the present drawing, the processing tank is composed of a rotating drum R205 formed by integrally connecting a circular bottom plate R205a provided so as to be rotatable in the horizontal plane, an inclined circumferential wall 205b that extends diagonally upwards and outwards from the circumferential edges of the circular bottom plate 205a, a weir R205c that protrudes inward from the upper end of the inclined circumferential wall R205b, and a roller R206 that is provided and supported so as to be able to roll over the inclined circumferential wall R205b, wherein the nozzle R203 is provided inside the processing tank and the tip of the nozzle R203 faces the inclined circumferential wall R205b.

In this case, the rotating drum R205 corresponds to the rotating drums R4 and R102 in the above-described dry mechanical reclamation equipment, the circular bottom plate R205a corresponds to R4a and R102a in the above-described dry mechanical reclamation equipment, the inclined circumferential wall R205b corresponds to the inclined circumferential walls R4b and R102b in the above-described dry mechanical reclamation equipment, the weir R205c corresponds to the weirs R4c and R102c in the above-described dry mechanical reclamation equipment, and the roller R206 corresponds to the rollers R12 and R105 in the above-described dry mechanical reclamation equipment.

Additionally, the roller R206 is connected to the cylinder R207 by a roller pressing mechanism R208, and furthermore, a position sensor R209 is connected to the cylinder rod, and information on the extension of the cylinder rod is sent to the control means R204. The control means R204, as an ejection condition selection means, stores specific conditions for the pressure and flow rate of compressed air, and the ejection time, determined by the growth rate of the accumulated fine powders.

In this case, the cylinder R207 corresponds to the cylinders R18 and R106 in the above-described dry mechanical reclamation equipment, and the roller pressing mechanism R208 corresponds to the roller pressing mechanisms P and R107 in the above-described dry mechanical reclamation equipment.

The equipment configured in this way stores, in the control means R204, information from the position sensor R209 at the time the pressing was started, and thereafter continuously collects information from the position sensor R209 using the control means R204, thereby obtaining information regarding the changes in the extension of the rod of the cylinder R207 for the control means R204. In this case, for example, if the extension of the cylinder rod is decreased by 10 mm compared with the value at the time the pressing was started, the thickness of the fine powders accumulation layer can be computed by the control means R204 from the distance between the roller R206 and the inclined circumferential wall 205b that is determined by the ratio between the total length of the cylinder rod and the length of the pressing control mechanism. Additionally, when a preset thickness of the fine powders accumulation layer that serves as the ejection condition is reached, compressed air is ejected at the fine powders accumulation layer to remove the fine powders accumulation layer.

If the time required to reach the fine powders accumulation layer thickness that is set as the ejection condition is short (e.g., about 5 minutes), then it can be inferred that the fine powders are highly adhesive. Thus, in the ejection condition selection means stored in the control means R204, for example, a higher compressed air pressure, a larger amount of air, and a longer ejection time are chosen. Conversely, if the time required to reach the fine powders accumulation layer thickness that is set as the ejection condition is long (e.g., about 15 minutes), then it can be inferred that the fine powders have low adhesiveness. Thus, in the ejection condition selection means stored in the control means R204, for example, a lower compressed air pressure, a smaller amount of air, and a shorter ejection time are chosen. Additionally, aside therefrom, it is possible to allow a standard time interval (e.g., once every 3 minutes) to be chosen for the ejection condition selection means, so as to preempt the growth of a fine powders accumulation layer by ejecting compressed air at regular time intervals irrespective of the thickness of the fine powders accumulation layer.

By using a compressed-air ejection means 2, it is possible to prevent situations in which the accumulated fine powders are pressed by the rollers and becomes attached, so that the pressing force can no longer be controlled to be in the optimal state.

### (Classification Equipment C)

Next, the classification equipment C will be explained. FIG. 13 is a schematic section view of classification equipment C. The classification equipment C classifies the reclaimed molding sand S by means of a specific-gravity classification system, and separates the sand into sand grains that are to be recovered and fine powders such as carbonized matter, sintered matter and metal compounds that is to be collected. The classification equipment C comprises an air compartment C1, a bottom plate C2, a settlement chamber C3, a sand discharge port C4, a sand loading port C5, a weir C6, an air blowing pipe C7 and a dust collection port C8.

The air compartment C1 is provided on a lower portion of the classification equipment C, and air that is fed from the air blowing pipe C7 is blown through the air compartment C1 and to the settlement chamber C3. The bottom plate C2 is provided on an upper portion of the air compartment C1, and is arranged so that the loaded molding sand S collects on the upper surface thereof. The bottom plate C2 is provided with air ejection ports C2a through which wind (air) from the air compartment C1 is blown into the settlement chamber C3. The settlement chamber C3 is provided on the upper portion of the classification equipment C, and the molding sand S that has been blown by the wind flows (floats) therein. The sand discharge port C4 is provided on a tip of the settlement chamber C3 and opens downwards from the equipment body. The molding sand S is discharged through the sand discharge port C4. The sand loading port C5 is provided on the upper portion of the air compartment C1, and opens upwards from the equipment body. The reclaimed molding sand S is loaded through the sand loading port C5. The bottom plate C2 is slightly tilted so as to be lower towards the side having the sand discharge port C4 and higher towards the side having the sand loading port C5.

The weir C6 is provided on the bottom plate C2 at a position adjacent to the sand discharge port C4. The weir C6 temporarily captures the fluidized (floating) molding sand S. The air blowing pipe C7 is provided on the bottom portion of the air compartment C1, and is connected to an air blower, which is not shown. The air blowing pipe C7 blows air generated by the air blower. The dust collection port C8 is provided on the upper end of the settlement chamber C3 and is connected to a dust collection device, which is not shown. Fine powders such as carbonized matter, sintered matter and metal compounds separated from the molding sand S passes through the dust collection port C8 and is collected by the dust collection apparatus.

In FIG. 13, wind (air) generated by the air blower is blown into the air blowing pipe C7 simultaneously with the loading of molding sand S through the sand loading port C5. The air that is blown flows into the air compartment C1, and is further blown through the air ejection ports C2a in the bottom plate C2 and into the settlement chamber C3. Then, the molding sand S that has collected on the bottom plate C2 is blown by the air and is fluidized, and begins sliding over the bottom plate C2, with a portion floating within the classification equipment C (settlement chamber C3). At this time, the carbonized matter, sintered matter, metal compounds and the like that have adhered to the molding sand S separate from the molding sand S. The floating molding sand S advances along the tilt of the bottom plate C2 towards the sand discharge port C4, after which the sliding is stopped by the weir C6. Thus, the molding sand S begins to form a layer at this location. Furthermore, if molding sand S is continuously loaded through the sand loading port C5, the layer of molding sand S will flow over the weir C6 and be discharged from the sand discharge port C4.

At this time, by collecting fine powders (dust) from the dust collection port C8, the carbonized matter, sintered matter, metal compounds and the like, and the molding sand S floating inside the classification equipment C (settlement chamber C3) float towards the dust collection port C8, but the reusable molding sand S falls away due to gravity before reaching the dust collection port C8, and is discharged through the sand discharge port C4. Meanwhile, the carbonized matter, sintered matter, metal compounds and the like that have been separated from the molding sand S are lighter in mass than the molding sand S and therefore do not fall, and are discharged through the dust collection port C8 together with air. In this manner, they are separated from the molding sand S.

Since the classification equipment C uses a specific-gravity classification method, it is able to efficiently classify sand grains and fine powders without the use of a complicated structure.

The fluidized-bed hot-air drying equipment which is the aforementioned first example of drying equipment D and the classification equipment C are structurally similar. For example, it is possible to use the drying equipment D as the classification equipment C by switching the hot-air generation device that is connected to the hot-air blowing pipe D7 to an air blower. Alternatively, it is possible to use the classification equipment C as the drying equipment D by switching the air blower that is connected to the air blowing pipe C7 to a hot-air generation device. Thus, the drying equipment D may also serve as the classification equipment C, or the classification equipment C may also serve as the drying equipment D.

### (Reclamation Method)

Next, the molding sand reclamation method using the reclamation equipment 1 according to the first embodiment will be explained. The molding sand S discharged from the green sand casting equipment used in the present reclamation method is sand that may include moisture and/or may have magnetized matter adhered thereto. For example, sand that may include moisture could be overflow sand, which is old sand that has overflowed from sand processing equipment. Additionally, sand that may have magnetized matter adhered thereto could be sand adhering to the product that is discharged during a shot blast process.

Overflow sand has bentonite and green sand additives adhered to the sand grain surfaces, and furthermore has a porous sintered layer, known as oolitics, formed by the sintering of bentonite on the sand grain surfaces. If the bentonite and the green sand additives are allowed to remain on the sand grain surface, the air permeability and the filling efficiency of the green sand will be reduced. Additionally, if the green sand additives vaporize, they may cause gas defects in the cast article. Furthermore, if an excessive amount of oolitics remains, then this may cause the filling efficiency of the mold to be reduced and may simultaneously reduce the fire resistance. Therefore, with overflow sand, it is necessary to remove bentonite and green sand additives from the sand grain surfaces, and to further strip and remove oolitics from the sand grain surfaces.

Sand adhering to the product has been subjected to a very severe thermal history, due to which bentonite is sintered and is converted to oolitics. Aside therefrom, a large portion of the green sand additives and core binder are evaporated away, but a portion thereof still remains on the sand grain surfaces in a carbonized state. More importantly, a lot of magnetized matter (sand grains in a state wherein metals and sand grains are fused together) is also present on the sand. If sand containing too much magnetized matter is mixed into a mold, it can cause defects such as burning of the cast article, and when used in a core, may cause poor strength development by the core binder. Therefore, in the case of sand adhering to the product, it is necessary to remove the magnetized matter by magnetic separation, and then to remove carbonized matter on the surface.

FIG. 14 is a flow chart showing a molding sand reclamation method using the reclamation equipment 1 according to the first embodiment. The molding sand S used in the present reclamation method, as mentioned above, may contain moisture and/or may have magnetized matter adhered thereto.

First, the moisture content and the magnetized matter content of the molding sand S are measured (first step). In order to measure the moisture content in the sand, a generally known measurement method may be used. For example, as a moisture content measuring method, there is that described in JIS Z 2601, Attachment 5, “Foundry Sand Moisture Content Testing Method”.

Additionally, a generally known measurement method may be used to measure the magnetized matter content of the sand. For example, as a magnetized matter content measuring method, there is Testing Procedure AFS 5101-00-S, “Magnetic Material, Removal and Determination”, defined in Mold & Core Test Handbook, 3rd Edition, published by the AFS (American Foundry Society). While this manual does not define the magnetic flux density of the magnet used for separating the magnetized matter, it is necessary to use a magnet having a magnetic flux density of 0.15 to 0.5 T in order to measure the magnetized matter defined in the present invention.

When the measured value of the moisture content in the molding sand S exceeds the control value, the molding sand S is dried in the drying equipment D (second step). In this case, the control value for the moisture content should preferably be 0.5%. This is because, as long as the moisture content is 0.5% or less, shelf-hanging will not occur in the reclamation equipment 1, and problems such as poor core strength development caused by high moisture content will not occur.

When the measured value of the magnetized matter content in the molding sand S exceeds the control value, the molding sand S is magnetically separated in the magnetic separation equipment M (second step). In this case, the magnetized matter content control value should preferably be 5.0%. If the magnetized matter content is 5.0% or less, then problems such as burning defects in the cast article due to the use of reclaimed sand and poor core strength development caused by residual metal content will not occur.

When the measured value of the moisture content in the molding sand S does not exceed the control value, there is no need to dry the molding sand S in the drying equipment D, so the switching equipment V1 is used to set the molding sand S to pass through the bypass system BP1 (second step).

When the measured value of the magnetized matter content in the molding sand S does not exceed the control value, there is no need to magnetically separate the molding sand S in the magnetic separation equipment M, so the switching equipment V2 is used to set the molding sand S to pass through the bypass system BP2 (second step).

When the measured values for the moisture content and the magnetized matter content in the molding sand S both do not exceed the control values, there is no need to dry the molding sand S in the drying equipment D or to magnetically separate the molding sand S in the magnetic separation equipment M, so the switching equipment V1 is used to set the molding sand S to pass through the bypass system BP1 and the switching equipment V2 is used to set the molding sand S to pass through the bypass system BP2 (second step). The path passing through both the bypass system BP1 and the bypass system BP2 is called bypass system BP3.

Next, the molding sand S is reclaimed using dry mechanical reclamation equipment R (third step). Due to the reclamation process, the loss-on-ignition of the molding sand S is reduced.

Next, the reclaimed molding sand S is classified by the classification equipment C using a specific-gravity classification method (fourth step). Due to this classification process, the total clay content of the molding sand S is reduced.

The molding sand S (reclaimed sand) that has undergone the third step (reclamation process) and the fourth step (classification process) has both a reduced loss-on-ignition and a reduced clay content, but ultimately, both numerical values must be brought to equal to or less than the control values. Therefore, if the loss-on-ignition and the total clay content of the molding sand S exceed the control values, then the switching equipment V3 is used to set the molding sand S to return to the dry mechanical reclamation equipment R via the return system PL1 in order to make the molding sand S undergo the third step (reclamation process) and the fourth step (classification process) again. Then, the molding sand S is passed once again through the dry mechanical reclamation equipment R and the classification equipment C. These processes are repeated until the measured values for the loss-on-ignition and the total clay content of the molding sand S are equal to or less than the control values.

Conversely, if the loss-on-ignition and the total clay content of the molding sand S are equal to or less than the control values, then the switching equipment V3 is used to set the molding sand S to be discharged from the reclamation equipment 1, and the molding sand S is discharged from the reclamation equipment 1. This ends the reclamation process.

In this case, the control value for the loss-on-ignition should preferably be 0.6%. This is because, as long as the loss-on-ignition is 0.6% or less, there will not be any problems such as the volatile components that have adhered to the sand grain surfaces vaporizing when pouring the molten metal, thereby causing cast article defects, or inhibiting the curing reaction when using a core. A generally known measurement method may be used to measure the loss-on-ignition of the sand.

For example, as a method for measuring the loss-on-ignition, there is the method described in JIS Z 2601, Attachment 6, “Foundry Sand Loss-on-Ignition Testing Method”.

Additionally, the control value for the total clay content should preferably be 0.6%. This is because, as long as the total clay content is 0.6% or less, there will not be any problems such as the volatile components that have adhered to the sand grain surfaces vaporizing when pouring the molten metal, thereby causing cast article defects, or inhibiting the curing reaction when using a core. Additionally, there will not be problems causing reductions in the quality of the molding sand S such as reduced air permeability or reduced filling efficiency of the molding sand S due to increases in fine powders in the molding sand S overall. A generally known measurement method may be used to measure the total clay content of the sand. For example, as a method for measuring the loss-on-ignition, there is the method described in JIS Z 2601, Attachment 1, “Foundry Sand Clay Content Testing Method”.

Each passage through the dry mechanical reclamation equipment R and the classification equipment C (reclamation process and classification process) shall be referred to as a “pass”. The first passage shall be referred to as the first pass, and as the number of passages increases, they will subsequently be referred to as the second pass, the third pass, etc.

The number of passes necessary for reducing the loss-on-ignition to the control value or less and reducing the total clay content to the control value or less are determined by experimentally reclaiming sand beforehand, and verifying the number of passes at which the loss-on-ignition was reduced to the control value or less and the total clay content was reduced to the control value or less.

As mentioned above, the dust collection equipment DC is connected to the classification equipment C, and is able to collect the dust (the fine powders) generated in the classification equipment C. In this case, the dust generated in the first pass is mainly bentonite and green sand additives that have adhered to the sand grain surfaces. For this reason, such dust can be reused as substitutes for bentonite and green sand additives during the mixing step. Therefore, the dust generated during this step may be recovered separately from the dust collected in subsequent passes. For example, by recovering the dust collected by the dust collection equipment DC in the first pass separately from the dust in the second and subsequent passes, such as by discharging the dust before the second pass is begun, it becomes possible to effectively recycle the reusable dust from the first pass without mixing it with other dust.

Additionally, generally, in thermal reclamation using calcination furnaces, the molding sand S must be heated to approximately 800° C. However, in the drying equipment D of the present embodiment, it is sufficient to heat the molding sand S to at least 90° C. and no more than 105° C., thereby suppressing the energy consumption and allowing the cost required for reclamation to be reduced.

Thus, with the molding sand reclamation method and reclamation equipment according to the first embodiment, it is possible to reclaim molding sand, containing moisture and magnetized matter, that has been discharged from green sand casting equipment, using only dry mechanical reclamation. As a result thereof, it is unnecessary to perform a separation process for impurities or a neutralization process for waste water that is generated when using wet reclamation, the large amounts of energy that are consumed when using thermal reclamation can be reduced, and the reclamation equipment can be made compact and simple, so the efficiency required for sand reclamation can be raised and the cost of sand reclamation can be reduced.

### Second Embodiment

In the second embodiment, the molding sand that has undergone the drying step in the drying equipment and/or the magnetic separation step in the magnetic separation equipment is again subjected to a measurement of the moisture content and the magnetized matter content in the molding sand, and the drying step in the drying equipment and/or the magnetic separation step in the magnetic separation equipment is repeated until the respective numerical values are equal to or less than the control values. The second embodiment will be explained with reference to the attached drawings. Regarding the molding sand reclamation method and reclamation equipment according to the present embodiment, the portions that differ from the first embodiment will be explained. The other portions are the same as in the first embodiment, so reference will be made to the above-given descriptions, and the descriptions will here be omitted.

FIG. 15 is a schematic block diagram of molding sand reclamation equipment according to the second embodiment. The reclamation equipment 11 comprises drying equipment D, magnetic separation equipment M, switching equipment V1, switching equipment V2, a bypass system BP1, a bypass system BP2, dry mechanical reclamation equipment R, classification equipment C, switching equipment V3, a return system PL1, dust collection equipment DC, switching equipment V4 and a return system PL2.

Between the magnetic separation equipment M and the dry mechanical reclamation equipment R, switching equipment V4 is provided for switching between whether molding sand S that has undergone the drying step in the drying equipment D and/or the magnetic separation step in the magnetic separation equipment M should be sent directly to the mechanical reclamation equipment R or whether the molding sand S should be returned to the switching equipment V1 and once again subjected to the drying process and/or the magnetic separation process. The switching equipment V4 is connected to a return system PL2 for returning the molding sand S to the drying equipment D and/or the magnetic separation equipment M. The moisture content and the magnetized matter content in the molding sand S are measured, and if the respective values are not equal to or less than the control values, then the molding sand S can be returned to the drying equipment D and/or the magnetic separation equipment M.

### (Reclamation Method)

Next, the molding sand reclamation method using the reclamation equipment 11 according to the second embodiment will be explained. FIG. 16 is a flow chart showing the molding sand reclamation method using the reclamation equipment 11 according to the second embodiment. The molding sand S used in the present reclamation method, as mentioned previously, may contain moisture and/or have magnetized matter adhered thereto.

First, the moisture content and the magnetized matter content of the molding sand S are measured (first step). If the measured value of the moisture content of the molding sand S exceeds the control value, the molding sand S is dried in the drying equipment D (second step). In this case, the control value of the moisture content should preferably be 0.5%. If the measured value of the magnetized matter content in the molding sand S exceeds the control value, the molding sand S is magnetically separated in the magnetic separation equipment M (second step). In this case, the control value of the magnetized matter content should preferably be 5.0%. If the measured value for the moisture content in the molding sand S does not exceed the control value, then the molding sand S does not need to be dried in the drying equipment D, so the switching equipment V1 is used to allow the molding sand S to pass through the bypass system BP1 (second step). If the measured value for the magnetized matter content in the molding sand S does not exceed the control value, then the molding sand S does not need to be magnetically separated in the magnetic separation equipment M, so the switching equipment V2 is used to allow the molding sand S to pass through the bypass system BP2 (second step).

If the measured values for the moisture content and the magnetized matter content in the molding sand S do not exceed the control values, the molding sand S does not need to be dried in the drying equipment D or magnetically separated in the magnetic separation equipment M, so the switching equipment V1 is used to set the molding sand S so as to pass through the bypass system BP1, and the switching equipment V2 is used to set the molding sand S so as to pass through the bypass system BP2 (second step). The path passing through both the bypass system BP1 and the bypass system BP2 in this way will be referred to as the bypass system BP3.

Next, the moisture content and the magnetized matter content in the molding sand S are measured again (third step). If the measured value of the moisture content in the molding sand S exceeds the control value and/or the measured value of the magnetized matter content in the molding sand S exceeds the control value, the switching equipment V4 is used to set the molding sand S so as to return, through the return system PL2, to the switching equipment V1, in order to pass the molding sand through the second step (drying step and/or magnetic separation step) again (third step). Then, the molding sand S is passed through the drying equipment D and/or the magnetic separation equipment M again. The step is repeated until the measured values of the moisture content and the magnetized matter content in the molding sand S become equal to or less than the control values. If the measured values for the moisture content and the magnetized matter content in the molding sand S are equal to or less than the control values, the switching equipment V4 is used to set the molding sand S so as to be sent to the mechanical reclamation equipment R, and the molding sand S is sent to the dry mechanical reclamation equipment R (third step).

Next, reclamation of the molding sand S is performed in the dry mechanical reclamation equipment R (fourth step). Due to the reclamation process, the loss-on-ignition of the molding sand S is reduced. Next, the reclaimed molding sand S is classified in the classification equipment C using a specific-gravity classification method (fifth step). Due to the classification process, the total clay content in the molding sand S is reduced.

The molding sand S (reclaimed sand) that has undergone the fourth step (reclamation process) and the fifth step (classification process) has both a reduced loss-on-ignition and a reduced total clay content, but the respective values must ultimately be reduced to the control values or less. Therefore, if the loss-on-ignition and the total clay content of the molding sand S exceed the control values, then the switching equipment V3 is used to return the molding sand S through the return system PL1 to the dry mechanical reclamation equipment R in order to pass the molding sand through the fourth step (reclamation process) and the fifth step (classification process) again.

Conversely, if the loss-on-ignition and total clay content of the molding sand S are equal to or less than the control values, then the switching equipment V3 is used to set the molding sand S so as to be discharged from the reclamation equipment 1. This ends the reclamation process. In this case, the control value for the loss-on-ignition should preferably be 0.6%. Additionally, the control value for the total clay content should preferably be 0.6%.

Thus, with the molding sand reclamation method and reclamation equipment according to the second embodiment, the drying step in the drying equipment and/or the magnetic separation step in the magnetic separation equipment M can be repeated until the moisture content and the magnetized matter content in the molding sand become equal to or less than the control values, so it is possible to reliably set the moisture content and the magnetized matter content contained in the molding sand to be equal to or less than the control values.

### Third Embodiment

In the first embodiment, a reclamation method and reclamation equipment for molding sand discharged from green sand casting equipment possibly containing moisture and/or possibly having magnetized matter adhered thereto were explained, but in the third embodiment, a method and reclamation equipment for simultaneously reclaiming various types of molding sand discharged from green sand casting equipment will be explained. The third embodiment will be explained with reference to the attached drawings. Regarding the molding sand reclamation method and reclamation equipment according to the present embodiment, the portions that differ from the first embodiment will be explained. The other portions are the same as in the first embodiment, so reference will be made to the above-given descriptions, and the descriptions will here be omitted.

FIG. 17 is a schematic block diagram of molding sand reclamation equipment according to the third embodiment. The reclamation equipment 21 comprises overflow sand recovery equipment PO, drying equipment D, overflow sand foreign-matter removal equipment IO, an overflow sand storage tank SSO, product-adhered sand recovery equipment PS, product-adhered sand foreign-matter removal equipment IS, magnetic separation equipment M, a product-adhered sand storage tank SSS, main mold/core-mixed sand recovery equipment PL, crushing equipment L, main mold/core-mixed sand foreign-matter removal equipment IL, a main mold/core-mixed sand storage tank SSL, sand lumps/sand recovery equipment PC, crushing equipment L, sand lumps/sand foreign-matter removal equipment IC, a sand lumps/sand storage tank SSC, sand cutting/blending equipment F, dry mechanical reclamation equipment R, classification equipment C, switching equipment V3, a return system PL1 and dust collection equipment DC.

The overflow sand recovery equipment PO recovers overflow sand (molding sand S) that has been discharged from the sand processing equipment (not shown) of green sand casting equipment. The structure of the overflow sand recovery equipment PO may, for example, be such that at least a certain flow rate of recovered sand flowing through the sand conveyance system of the green sand casting equipment is recovered with a scraper, and separated and recovered from the sand conveyance system. The drying equipment D dries the overflow sand recovered by the overflow sand recovery equipment PO. The overflow sand foreign-matter removal equipment IO removes foreign matter from the overflow sand after drying. As the overflow sand foreign-matter removal equipment IO, equipment of a generally known structure, such as a rotary sieve or a vibrating sieve, may be used. The overflow sand storage tank SSO stores the overflow sand after removal of the foreign matter. As the overflow sand storage tank SSO, a sand hopper having a generally known structure may be used.

The product-adhered sand recovery equipment PS recovers sand adhering to the product (molding sand S). The structure of the product-adhered sand recovery equipment PS may, for example, be a structure wherein shot and sand adhering to the product discharged by shot blasting is subjected to specific-gravity classification and the sand adhering to the product is extracted. The product-adhered sand foreign-matter removal equipment IS removes foreign matter from the sand adhering to the product. As the product-adhered sand foreign-matter removal equipment IS, equipment of a generally known structure, such as a rotary sieve or a vibrating sieve, may be used. The magnetic separation equipment M magnetically separates the sand adhering to the product after removal of foreign matter, and removes magnetized matter from the sand adhering to the product. The product-adhered sand storage tank SSS stores the sand adhering to the product after removal of the foreign matter. As the product-adhered sand storage tank SSS, a sand hopper having a generally known structure may be used.

The main mold/core-mixed sand recovery equipment PL recovers main mold/core-mixed sand (molding sand S). The structure of the main mold/core-mixed sand recovery equipment PL may, for example, be of a type wherein a cast product extracted from the mold is struck or vibrated so as to strip and recover main mold/core-mixed sand that has adhered to the cast product. The crushing equipment L crushes the main mold/core-mixed sand. The structure of the crushing equipment L may, for example, be such as to crush the main mold/core-mixed sand by applying vibrations and generating friction between the sand grains. The main mold/core-mixed sand foreign-matter removal equipment IL removes foreign matter from the main mold/core-mixed sand. As the main mold/core-mixed sand foreign-matter removal equipment IL, equipment of a generally known structure, such as a rotary sieve or a vibrating sieve, may be used. The main mold/core-mixed sand storage tank SSL stores the main mold/core-mixed sand after removal of the foreign matter. As the main mold/core-mixed sand storage tank SSL, a sand hopper having a generally known structure may be used.

The sand lumps/sand recovery equipment PC recovers sand lumps/sand (molding sand S) that has been discharged during a core sand extraction step. The structure of the sand lumps/sand recovery equipment PC may, for example, be of a type wherein a core that remains in a cast product is struck or vibrated so as to strip and recover the core remaining in the cast product. The crushing equipment L crushes the sand lumps/sand. The structure of the crushing equipment L may, for example, be such as to crush the sand lumps/sand by applying vibrations and generating friction between the sand grains. The sand lumps/sand foreign-matter removal equipment IC removes foreign matter from the sand lumps/sand. As the sand lumps/sand foreign-matter removal equipment IC, equipment of a generally known structure, such as a rotary sieve or a vibrating sieve, may be used. The sand lumps/sand storage tank SSC stores the sand lumps/sand after removal of the foreign matter. As the sand lumps/sand storage tank SSC, a sand hopper having a generally known structure may be used.

The sand cutting/blending equipment F cuts out (extracts) the sand (molding sand S) stored in the overflow sand storage tank SSO, the product-adhered sand storage tank SSS, the main mold/core-mixed sand storage tank SSL and the sand lumps/sand storage tank SSC, such that a ratio therebetween is always constant, and blends the different types of sand. The structure of the sand cutting/blending equipment F may, for example, be of a type that is provided with sliding gates for cutting out standard amounts after the storage step, and that blends the sand discharged from the sliding gates using a vibrating feeder or a screw conveyor.

The dry mechanical reclamation equipment R reclaims the molding sand S by stripping away carbonized matter, sintered matter, metal compounds or the like that have adhered to the surface of the blended molding sand S. The classification equipment C classifies the reclaimed molding sand S by means of a specific-gravity classification system, and separates the sand grains, which are to be recovered, from the fine powders such as carbonized matter, sintered matter and metal compounds that is to be collected. Following the classification equipment C, switching equipment V3 is provided for switching between whether to discharge the classified reclaimed sand (molding sand S) from the reclamation equipment 21 or to return the reclaimed sand that has been classified to the loading port of the dry reclamation equipment R to repeat the reclamation process. The switching equipment V3 is connected to a return system PL1 for returning the classified reclaimed sand to the dry mechanical reclamation equipment R. The dust collection equipment DC is connected to the classification equipment C, and collects dust (fine powders) generated in the classification equipment C.

### (Crushing Equipment L)

Next, the crushing equipment L which constitutes a part of the present molding sand reclamation equipment 21 will be explained. FIG. 18 is a front view of the crushing equipment L, FIG. 19 is a plan view of the crushing equipment L, and FIG. 20 is a cross section at A-A in FIG. 19. In the crushing equipment L, a cylindrical container L1 having an open upper surface is supported on a support column L2 with an elastic body L3, for example, a coil spring, interposed therebetween. The upper portion of the container Ll has a chute L4 that opens in the shape of a funnel, and furthermore, a plurality of pedestals L5 that support the elastic body L3 are disposed on the outer edges of the container L1 and the chute L4. A vibrator L7 is mounted on the lower surface of the container L1 by a mounting plate L6. A liner L9 that is pierced by slits L8 is screwed about the entire circumference of the inner surface of the container L1, by means of screws L11a, L11b at mounting seats L10a, L10b that are mounted to the inner surface of the container L1. A discharge port L12 is mounted to the side surface of the container L1, and furthermore, a door L13 for extracting foreign matter that has collected on the liner L9 is fixed by a handle L14.

The crushing method using the crushing equipment L will be explained below. First, main mold/core-mixed sand or sand lumps/sand is loaded into the container L1. Next, the vibrator L7 is activated so as to crush the main mold/core-mixed sand or the sand lumps/sand on the liner L9 by collisions and friction therebetween or by collisions and friction between the main mold/core-mixed sand or the sand lumps/sand and the liner L9. The sand grains that have been crushed to become finer than the widths of the slits L8 pass through the slits L8 and move into the space between the liner L9 and the container L1, and are discharged to the outside of the crushing equipment L through the discharge port L12.

If the width of the slits L8 is too wide, there is a risk that insufficiently crushed main mold/core-mixed sand or sand lumps/sand will be discharged, or furthermore, that foreign matter will be discharged. Conversely, if the slits L8 are too narrow, there is a risk that the discharge of the crushed sand grains will not progress and they may collect inside the container L1. For this reason, the width of the slits L8 should preferably be between 2 mm and 5 mm. Additionally, in order for the main mold/core-mixed sand or the sand lumps/sand on the liner L9 to be efficiently crushed and discharged, it is preferable to generate vibrations such as to cause them to move along the circumference of the container L1. For this purpose, the vibrator L7 should preferably be installed so that the center line thereof forms an angle of approximately 45° with respect to the installation floor surface. Furthermore, while a single vibrator L7 is used in FIG. 18, by instead mounting two vibrators L7 to the left and right of the mounting plate L6 so that their respective center lines form the shape of the letter X, the vibrations in the vertical direction can be canceled out by using opposite phases for the vertical vibrations generated by the two vibrators, thereby leaving only vibrations in the circumferential direction of the container L1. Thus, such a mounting method could also be employed.

### (Reclamation Method)

Next, the molding sand reclamation method using the reclamation equipment 21 according to the third embodiment will be described. FIG. 22 is a flow chart showing the molding sand reclamation method using the reclamation equipment 21 according to the third embodiment.

Of the molding sand S that is discharged from the green sand casting equipment, the overflow sand that has been discharged from sand processing equipment is recovered by the overflow sand recovery equipment PO (first step-1).

As explained in connection with the first embodiment, overflow sand has bentonite and green sand additives adhered to the sand grain surfaces, and furthermore has a porous sintered layer, known as oolitics, formed by the sintering of bentonite on the sand grain surfaces. If the bentonite and the green sand additives are allowed to remain on the sand grain surface, the air permeability and the filling efficiency of the green sand will be reduced. Additionally, if the green sand additives vaporize, they may cause gas defects in the cast article. Furthermore, if an excessive amount of oolitics remains, then this may cause the filling efficiency of the mold to be reduced and may simultaneously reduce the fire resistance. Therefore, with overflow sand, it is necessary to remove bentonite and green sand additives from the sand grain surfaces, and to further strip and remove oolitics from the sand grain surfaces.

Next, the overflow sand is dried in the drying equipment D until the moisture content becomes equal to or less than a control value (second step-1). In this case, the control value for the moisture content should preferably be 0.5%. The drying may be performed using the method described in connection with the first embodiment. Next, in the overflow sand foreign-matter removal equipment IO, foreign matter is removed from the dried overflow sand (second step-1). Finally, the overflow sand from which foreign matter has been removed is stored in the overflow sand storage tank SSO (second step-1).

Of the molding sand S that is discharged from the green sand casting equipment, the sand adhering to the product is recovered by the product-adhered sand recovery equipment PS (first step-2).

As explained in connection with the first embodiment, sand adhering to the product has been subjected to a very severe thermal history, due to which bentonite is sintered and is converted to oolitics. Aside therefrom, a large portion of the green sand additives and core binder are evaporated away, but a portion thereof still remains on the sand grain surfaces in a carbonized state. More importantly, a lot of magnetized matter (sand grains in a state wherein metals and sand grains are fused together) is also present on the sand. If sand containing too much magnetized matter is mixed into a mold, it can cause defects such as burning of the cast article, and when used in a core, may cause poor strength development by the core binder. Therefore, in the case of sand adhering to the product, it is necessary to remove the magnetized matter by magnetic separation, and then to remove carbonized matter on the surface.

Next, foreign matter is removed from the sand adhering to the product in the product-adhered sand foreign-matter removal equipment IS (second step-2). Next, the sand adhering to the product from which the foreign matter has been removed is magnetically separated in the magnetic separation equipment M until the magnetized matter content in the sand adhering to the product becomes equal to or less than the control value (second step-2). In this case, the control value for the magnetized matter content should preferably be 5.0%. The magnetic separation may be performed using the method described in connection with the first embodiment. Finally, the magnetically separated sand adhering to the product is stored in the product-adhered sand storage tank SSS (second step-2).

Of the molding sand S that is discharged from the green sand casting equipment, the main mold/core-mixed sand is recovered by the main mold/core-mixed sand recovery equipment PL (first step-3).

Main mold/core-mixed sand has been exposed to high temperatures due to the heat from the molten metal, so it has very little moisture. Additionally, the bentonite is mostly sintered and converted to oolitics. Furthermore, carbonaceous green sand additives and organic core binders have evaporated or are carbonized and adhered to the sand grain surfaces. While the problems that occur when there is an excessive amount of oolitics have been mentioned above, carbonized matter that is adhered to the sand grain surfaces also has problems such as causing gas defects when pouring the molten metal, and resulting in poor strength development when used as core sand. Therefore, main mold/core-mixed sand also must be subjected to a reclamation process in order to remove these residues.

Next, the main mold/core-mixed sand is crushed in the crushing equipment L (second step-3). Next, foreign matter is removed from the crushed main mold/core-mixed sand in the main mold/core-mixed sand foreign-matter removal equipment IL (second step-3). Finally, the main mold/core-mixed sand from which foreign matter has been removed is stored in the main mold/core-mixed sand storage tank SSL (second step-3).

Of the molding sand S that is discharged from the green sand casting equipment, the sand lumps/sand discharged during the core sand extraction step is recovered by the sand lumps/sand recovery equipment PC (first step-4).

Although the sand lumps/sand discharged during the core sand extraction step contains almost no green sand components, some of the residues from the core binder are adhered to the sand grain surfaces. These residues also have problems such as causing gas defects when pouring the molten metal, and resulting in poor strength development when used as core sand, as mentioned above. Therefore, the sand lumps/sand discharged during the core sand extraction step must also be subjected to a reclamation process in order to remove these residues.

Next, the sand lumps/sand discharged during the core sand extraction step are crushed in the crushing equipment L (second step-4). Next, foreign matter is removed from the crushed sand lumps/sand in the sand lumps/sand foreign-matter removal equipment IC (second step-4). Finally, the sand lumps/sand from which foreign matter has been removed is stored in the sand lumps/sand storage tank SSC (second step-4).

The sand (molding sand S) stored in the overflow sand storage tank SSO, the product-adhered sand storage tank SSS, the main mold/core-mixed sand storage tank SSL and the sand lumps/sand storage tank SSC is cut out (extracted) and blended by the sand cutting/blending equipment F, such that the ratio between the sand (molding sand S) cut out (extracted) from these storage tanks is always constant (third step).

Next, in the dry mechanical reclamation equipment R, the molding sand S is reclaimed by stripping away carbonized matter, sintered matter, metal compounds or the like that have adhered to the surface of the blended molding sand S (fourth step). The reclamation may be performed using the method described in connection with the first embodiment. The reclamation process reduces the loss-on-ignition of the molding sand S.

Next, the reclaimed molding sand S is classified in the classification equipment C using a specific-gravity classification method (fifth step). The classification can be performed using the method described in the first embodiment. The classification process reduces the total clay content of the molding sand S.

The molding sand S (reclaimed sand) that has undergone the fourth step (reclamation process) and the fifth step (classification process) has both a reduced loss-on-ignition and a reduced total clay content, but the respective values must ultimately be reduced to the control values or less. Therefore, if the loss-on-ignition and the total clay content of the molding sand S exceed the control values, then the switching equipment V3 is used to return the molding sand S through the return system PL1 to the dry mechanical reclamation equipment R in order to pass the molding sand through the fourth step (reclamation process) and the fifth step (classification process) again. Then, the molding sand S is passed again through the dry mechanical reclamation equipment R and the classification equipment C. The present steps are repeated until the measured values for the loss-on-ignition and the total clay content of the molding sand S become equal to or less than the control values.

Conversely, if the loss-on-ignition and total clay content of the molding sand S are equal to or less than the control values, then the switching equipment V3 is used to set the molding sand S so as to be discharged from the reclamation equipment 1, and the molding sand S is discharged from the reclamation equipment 1. This ends the reclamation process. In this case, the control value for the loss-on-ignition should preferably be 0.6%. Additionally, the control value for the total clay content should preferably be 0.6%.

The dust collection equipment DC is connected to the classification equipment C, and is able to collect the dust (the fine powders) generated in the classification equipment C. In this case, the dust generated in the first pass is mainly bentonite and green sand additives that have adhered to the sand grain surfaces. For this reason, such dust can be reused as substitutes for bentonite and green sand additives during the mixing step. Therefore, the dust generated during this step may be recovered separately from the dust collected in subsequent passes. For example, by recovering the dust collected by the dust collection equipment DC in the first pass separately from the dust in the second and subsequent passes, such as by discharging the dust before the second pass is begun, it becomes possible to effectively recycle the reusable dust from the first pass without mixing it with other dust.

The mold making method used for cores, which is used in the present embodiment, may, for example, be a furan resin acid-cured self-hardening process, a furan resin SO₂ gas-cured process, a furan resin thermosetting process, a phenolic resin thermosetting process, a phenolic resin superheated steam-cured process, a phenolic resin ester-cured self-hardening process, a phenolic resin acid-cured self-hardening process, a phenolic resin methyl formate gas-cured process, a phenolic resin CO₂ gas-cured process, a phenolic resin urethanation reaction self-hardening process, a phenolic resin urethanation reaction amine gas-cured process, an oil-modified alkyd resin urethanation reaction self-hardening process, a polyol resin urethanation reaction self-hardening process, a water glass ferrosilicon self-hardening process, a water glass dicalcium silicate self-hardening process, a water glass ester self-hardening process or a water glass CO₂ gas-cured process. Since it is clear, from experience, that in the above-mentioned water glass processes, the residual amounts of amorphous silicic acid hydrates and metal oxides can be reduced to tolerable levels by mechanical reclamation alone without heating, the processes do not require heating.

Thus, with the molding sand reclamation method and reclamation equipment according to the third embodiment, it is possible to reclaim, by only dry mechanical reclamation, various types of molding sand that have been discharged from green sand casting equipment. As a result thereof, it is unnecessary to perform a separation process for impurities or a neutralization process for waste water that is generated when using wet reclamation, the large amounts of energy that are consumed when using thermal reclamation can be reduced, and the reclamation equipment can be made compact and simple, so the efficiency required for sand reclamation can be raised and the cost of sand reclamation can be reduced.

Additionally, with the molding sand reclamation method and reclamation equipment according to the third embodiment, it is possible to separately pretreat molding sand of respectively different properties that has been discharged from various parts of green sand casting equipment, and to perform dry mechanical reclamation, and furthermore to remove fine powders, with the sand always cut out and blended at a constant ratio, so the properties of the reclaimed sand can always be held constant. Therefore, the reclaimed sand can be directly reused.

### Fourth Embodiment

In the fourth embodiment, the case wherein the core used in the green sand casting equipment is produced by a thermal-dehydration-cured water glass process will be described. The fourth embodiment will be explained with reference to the attached drawings. Regarding the molding sand reclamation method and reclamation equipment according to the present embodiment, the portions that differ from the third embodiment will be explained. The other portions are the same as in the third embodiment, so reference will be made to the above-given descriptions, and the descriptions will here be omitted.

FIG. 22 is a schematic block diagram of molding sand reclamation equipment 31 according to the fourth embodiment. The reclamation equipment 31 comprises overflow sand recovery equipment PO, drying equipment D, overflow sand foreign-matter removal equipment IO, an overflow sand storage tank SSO, product-adhered sand recovery equipment PS, product-adhered sand foreign-matter removal equipment IS, magnetic separation equipment M, a product-adhered sand storage tank SSS, main mold/core-mixed sand recovery equipment PL, crushing equipment L, main mold/core-mixed sand foreign-matter removal equipment IL, heating equipment TR, a main mold/core-mixed sand storage tank SSL, sand lumps/sand recovery equipment PC, crushing equipment L, sand lumps/sand foreign-matter removal equipment IC, heating equipment TR, a sand lumps/sand storage tank SSC, sand cutting/blending equipment F, dry mechanical reclamation equipment R, classification equipment C, switching equipment V3, a return system PL1 and dust collection equipment DC.

The heating equipment TR heats the molding sand S to at least 400° C. In the present embodiment, two units of heating equipment TR are provided. One is provided between the main mold/core-mixed foreign-matter removal equipment IL and the main mold/core-mixed sand storage tank SSL to heat the main mold/core-mixed sand after removal of foreign matter. The other one is provided between the sand lumps/sand foreign-matter removal equipment IC and the sand lumps/sand storage tank SSC to heat the sand lumps/sand after removal of the foreign matter.

When a core used in green sand casting equipment is produced by a thermal-dehydration-cured water glass process, if amorphous silicic acid hydrates and metal oxides which are the main components of water glass even slightly remain, then problems such as extreme strength development defects can occur when used as core sand. Therefore, in that case, main mold/core-mixed sand and sand lumps/sand discharged during the core sand extraction step are heated, thereby heating and converting the amorphous silicic acid anhydrates remaining therein, while simultaneously sealing the metal oxides in the interior thereof. Thereafter, dry mechanical reclamation is performed, so it is possible to render harmless the silicic acid hydrates and metal oxides that are detrimental to the strength development of the molds.

### (Reclamation Method)

Next, the molding sand reclamation method using the reclamation equipment 31 according to the fourth embodiment will be described. FIG. 23 is a flow chart showing the molding sand reclamation method using the reclamation equipment according to the fourth embodiment.

Of the molding sand S that is discharged from the green sand casting equipment, the overflow sand that has been discharged from sand processing equipment is recovered by the overflow sand recovery equipment PO (first step-1). Next, the overflow sand is dried in the drying equipment D until the moisture content becomes equal to or less than a control value (second step-1). In this case, the control value for the moisture content should preferably be 0.5%. Next, in the overflow sand foreign-matter removal equipment IO, foreign matter is removed from the dried overflow sand (second step-1). Finally, the overflow sand from which foreign matter has been removed is stored in the overflow sand storage tank SSO (second step-1).

Of the molding sand S that is discharged from the green sand casting equipment, the sand adhering to the product is recovered by the product-adhered sand recovery equipment PS (first step-2). Next, foreign matter is removed from the sand adhering to the product in the product-adhered sand foreign-matter removal equipment IS (second step-2). Next, the sand adhering to the product from which the foreign matter has been removed is magnetically separated in the magnetic separation equipment M until the magnetized matter content in the sand adhering to the product becomes equal to or less than the control value (second step-2). In this case, the control value for the magnetized matter content should preferably be 5.0%. Finally, the magnetically separated sand adhering to the product is stored in the product-adhered sand storage tank SSS (second step-2).

Of the molding sand S that is discharged from the green sand casting equipment, the main mold/core-mixed sand is recovered by the main mold/core-mixed sand recovery equipment PL (first step-3). Next, the main mold/core-mixed sand is crushed in the crushing equipment L (second step-3). Next, foreign matter is removed from the crushed main mold/core-mixed sand in the main mold/core-mixed sand foreign-matter removal equipment IL (second step-3). Next, the main mold/core-mixed sand from which foreign matter has been removed is heated to at least 400° C. (second step-3). Finally, the heated main mold/core-mixed sand is stored in the main mold/core-mixed sand storage tank SSL (second step-3).

Of the molding sand S that is discharged from the green sand casting equipment, the sand lumps/sand discharged during the core sand extraction step is recovered by the sand lumps/sand recovery equipment PC (first step-4). Next, the sand lumps/sand discharged during the core sand extraction step is crushed in the crushing equipment L (second step-4). Next, foreign matter is removed from the crushed sand lumps/sand in the sand lumps/sand foreign-matter removal equipment IC (second step-4). Next, the sand lumps/sand from which foreign matter has been removed is heated to at least 400° C. (second step-4). Finally, the heated sand lumps/sand is stored in the sand lumps/sand storage tank SSC (second step-4).

The sand stored in the overflow sand storage tank SSO, the product-adhered sand storage tank SSS, the main mold/core-mixed sand storage tank SSL and the sand lumps/sand storage tank SSC is cut out and blended by the sand cutting/blending equipment F, such that the ratio between the sand cut out from these storage tanks is always constant (third step).

Next, in the dry mechanical reclamation equipment R, the molding sand S is reclaimed by stripping away carbonized matter, sintered matter, metal compounds or the like that have adhered to the surface of the blended molding sand S (fourth step). Next, the reclaimed molding sand S is classified in the classification equipment C using a specific-gravity classification method (fifth step). If the loss-on-ignition and the total clay content of the molding sand S exceed the control values, then the switching equipment V3 is used to return the molding sand S through the return system PL1 to the dry mechanical reclamation equipment R in order to pass the molding sand through the fourth step (reclamation process) and the fifth step (classification process) again.

Conversely, if the loss-on-ignition and the total clay content of the molding sand S are equal to or less than the control values, then the switching equipment V3 is used to set the molding sand S so as to be discharged from the reclamation equipment 1. This ends the reclamation process. In this case, the control value for the loss-on-ignition should preferably be 0.6%. Additionally, the control value for the total clay content should preferably be 0.6%.

Thus, with the molding sand reclamation method and reclamation equipment according to the fourth embodiment, even if the core used in the green sand casting equipment is produced by a thermal-dehydration-cured water glass process, the main mold/core-mixed sand discharged from various parts of the green sand casting equipment and the sand lumps/sand discharged during the core sand extraction step are heated, thereby converting the amorphous silicic acid hydrates remaining therein to glass, and sealing metal oxides in the interior thereof. Thereafter, dry mechanical reclamation is performed, so it is possible to render harmless the silicic acid hydrates and metal oxides that are detrimental to the strength development of the molds.

### Fifth Embodiment

The fifth embodiment has a structure wherein a plurality of units of the reclamation equipment R and the classification equipment C from the first embodiment are arranged serially and in parallel. The fifth embodiment will be explained with reference to the attached drawings. Regarding the molding sand reclamation method and reclamation equipment according to the present embodiment, the portions that differ from the first embodiment will be explained. The other portions are the same as in the first embodiment, so reference will be made to the above-given descriptions, and the descriptions will here be omitted.

FIG. 24 is a schematic block diagram of molding sand reclamation equipment according to the fifth embodiment. The reclamation equipment 41 comprises drying equipment D, magnetic separation equipment M, switching equipment V1, switching equipment V2, a bypass system BP1, a bypass system BP2, four units of dry mechanical reclamation equipment R411, R412, R421 and R422, four units of classification equipment C411, C412, C421 and C422, switching equipment V3, a return system PL1 and two units of dust collection equipment DC and DO.

The units of dry mechanical reclamation equipment R411, R412, R421 and R422 reclaim the molding sand S by stripping away carbonized matter, sintered matter, metal compounds or the like that have adhered to the surface of the molding sand S discharged from green sand casting equipment. The dry mechanical reclamation equipment R411, R412, R421 and R422 all have the same mechanism, and any system may be used as long as it is able to make the loss-on-ignition equal to or less than the control value.

The units of classification equipment C411, C412, C421 and C422 classify the reclaimed molding sand S by means of a specific-gravity classification system, and separate the sand grains, which are to be recovered, from the fine powders such as carbonized matter, sintered matter and metal compounds that is to be collected. The classification equipment C411, C412, C421 and C422 all have the same mechanism, and any system may be used as long as it is able to remove fine powders until the total clay content in the reclaimed molding sand S is equal to or less than the control value.

The dry mechanical reclamation equipment R411 that is connected to the end of the bypass system BP2 is serially connected to the classification equipment C411, the dry mechanical reclamation equipment R412 and the classification equipment C412, and at the end thereof, is connected to the switching equipment V3. Similarly, the dry mechanical reclamation equipment R421 that is connected to the end of the bypass system BP2 is serially connected to the classification equipment C421, the dry mechanical reclamation equipment R422 and the classification equipment C422, and at the end thereof, is connected to the switching equipment V3. From a different viewpoint, the structure formed by the dry mechanical reclamation equipment R411, the classification equipment C411, the dry mechanical reclamation equipment R412 and the classification equipment C412, and the structure formed by the dry mechanical reclamation equipment R421, the classification equipment C421, the dry mechanical reclamation equipment R422 and the classification equipment C422 are arranged in parallel between the bypass system BP2 and the switching equipment V3.

Following the classification equipment C412 and C422, the switching equipment V3 is provided for switching between whether to discharge the classified reclaimed sand (molding sand S) from the reclamation equipment 41 or to return the reclaimed sand that has been classified to the loading ports of the dry reclamation equipment R411 and R421 to repeat the reclamation process. The switching equipment V3 is connected to a return system PL1 for returning the classified reclaimed sand to the path through the dry mechanical reclamation equipment R411, the classification equipment C411, the dry mechanical reclamation equipment R412 and the classification equipment C412, and the path through the dry mechanical reclamation equipment R421, the classification equipment C421, the dry mechanical reclamation equipment R422 and the classification equipment C422. The structure allows the reclaimed sand that has been classified to be returned to the path through the dry mechanical reclamation equipment R411, the classification equipment C411, the dry mechanical reclamation equipment R412 and the classification equipment C412, and the path through the dry mechanical reclamation equipment R421, the classification equipment C421, the dry mechanical reclamation equipment R422 and the classification equipment C422, if the loss-on-ignition and the total clay content of the reclaimed sand that has been classified are not equal to or less than the control values.

The dust collection equipment DC is connected to the classification equipment C411 and C421, and collects dust (fine powders) generated in the classification equipment C411 and C421. The dust collection equipment DO is connected to the classification equipment C412 and C422, and collects dust (fine powders) generated in the classification equipment C412 and C422.

### (Reclamation Method)

Next, the molding sand reclamation method using the reclamation equipment 41 according to the fifth embodiment will be explained. FIG. 25 is a flow chart showing the molding sand reclamation method using the reclamation equipment 41 according to the fifth embodiment. The molding sand S used in the present reclamation method, as described in connection with the first embodiment, may contain moisture and/or have magnetized matter adhered thereto.

First, the moisture content and the magnetized matter content of the molding sand S are measured (first step). If the measured value of the moisture content of the molding sand S exceeds the control value, the molding sand S is dried in the drying equipment D (second step). In this case, the control value of the moisture content should preferably be 0.5%. If the measured value of the magnetized matter content in the molding sand S exceeds the control value, the molding sand S is magnetically separated in the magnetic separation equipment M (second step). In this case, the control value of the magnetized matter content should preferably be 5.0%. If the measured value for the moisture content in the molding sand S does not exceed the control value, then the molding sand S does not need to be dried in the drying equipment D, so the switching equipment V1 is used to allow the molding sand S to pass through the bypass system BP1 (second step). If the measured value for the magnetized matter content in the molding sand S does not exceed the control value, then the molding sand S does not need to be magnetically separated in the magnetic separation equipment M, so the switching equipment V2 is used to allow the molding sand S to pass through the bypass system BP2 (second step).

If the measured values for the moisture content and the magnetized matter content in the molding sand S do not exceed the control values, the molding sand S does not need to be dried in the drying equipment D or magnetically separated in the magnetic separation equipment M, so the switching equipment V1 is used to set the molding sand S so as to pass through the bypass system BP1, and the switching equipment V2 is used to set the molding sand S so as to pass through the bypass system BP2 (second step). The path passing through both the bypass system BP1 and the bypass system BP2 in this way will be referred to as the bypass system BP3.

Next, the molding sand S is reclaimed respectively in the dry mechanical reclamation equipment R411 and R421 (third step). The reclamation process reduces the loss-on-ignition of the molding sand S. Next, the reclaimed molding sand S is classified in the classification equipment C411 and C421 using a specific-gravity classification method (fourth step). The classification process reduces the total clay content of the molding sand S.

Next, the dust collected from the classification equipment C411 and C421 is recovered by the dust collection equipment DC alone. As mentioned previously, the dust generated initially (in the first pass) is mainly bentonite and green sand additives that have adhered to the sand grain surface. Therefore, by recovering the dust generated during this step separately, this dust can be reused as a substitute for bentonite and green sand additives during the mixing of the molding sand.

Next, the molding sand S that has once been subjected to the reclamation process is again reclaimed in the dry mechanical reclamation equipment R412 and R422 (third step). By performing the reclamation process again, the loss-on-ignition of the molding sand S is reduced. Next, the reclaimed molding sand S is classified in the classification equipment C412 and C422 using a specific-gravity classification method (fourth step). The classification process reduces the total clay content of the molding sand S.

The molding sand S (reclaimed sand) that has undergone the third step (reclamation process) twice and the fourth step (classification process) twice has both a reduced loss-on-ignition and a reduced total clay content, but ultimately, both numerical values must be brought to equal to or less than the control values. Therefore, if the loss-on-ignition and the total clay content of the molding sand S exceed the control values, then the switching equipment V3 is used to set the molding sand S to return to the dry mechanical reclamation equipment R411 and R421 via the return system PL1 in order to make the molding sand S undergo the third step (reclamation process) and the fourth step (classification process) again.

Conversely, if as a result of undergoing the third step (reclamation process) twice and the fourth step (classification process) twice, the loss-on-ignition and the total clay content of the molding sand S are equal to or less than the control values, then the switching equipment V3 is used to set the molding sand S to be discharged from the reclamation equipment 1. This ends the reclamation process. In this case, the control value for the loss-on-ignition should preferably be 0.6%. Additionally, the control value for the total clay content should preferably be 0.6%.

The dust collection equipment DO collects dust generated in the classification equipment C412 and C422, and the dust generated in the classification equipment C411 and C421 for the second and subsequent passes.

Thus, with the molding sand reclamation method and reclamation equipment according to the fifth embodiment, there is no need to combine reclamation equipment having different mechanisms, and it is possible to easily decide the structure of the reclamation equipment in accordance with the amount being processed and the control values for the loss-on-ignition and the total clay content.

Additionally, with the molding sand reclamation method and reclamation equipment according to the fifth embodiment, it is possible to appropriately suspend unneeded steps in accordance with variations in the load required for the steps, based on the amount being processed, the required processing capacity or the like, so it is possible to adapt more flexibly to load variations than in the first embodiment.

Additionally, with the molding sand reclamation method and reclamation equipment according to the fifth embodiment, two reclamation processes and two classification processes can be performed at once, so the number of times that switching equipment must be used to return the molding sand to the reclamation process and the classification process can be reduced.

Additionally, with the molding sand reclamation method and reclamation equipment according to the fifth embodiment, it is possible to reclaim molding sand, containing moisture and magnetized matter, that has been discharged from green sand casting equipment, using only dry mechanical reclamation. As a result thereof, it is unnecessary to perform a separation process for impurities or a neutralization process for waste water that is generated when using wet reclamation, the large amounts of energy that are consumed when using thermal reclamation can be reduced, and the reclamation equipment can be made compact and simple, so the efficiency required for sand reclamation can be raised and the cost of sand reclamation can be reduced.

### Sixth Embodiment

The sixth embodiment has a structure wherein a plurality of units of the reclamation equipment R and the classification equipment C from the second embodiment are arranged serially and in parallel. The sixth embodiment will be explained with reference to the attached drawings. Regarding the molding sand reclamation method and reclamation equipment according to the present embodiment, the portions that differ from the second embodiment will be explained. The other portions are the same as in the second embodiment, so reference will be made to the above-given descriptions, and the descriptions will here be omitted.

FIG. 26 is a schematic block diagram of molding sand reclamation equipment according to the sixth embodiment. The reclamation equipment 51 comprises drying equipment D, magnetic separation equipment M, switching equipment V1, switching equipment V2, a bypass system BP1, a bypass system BP2, four units of dry mechanical reclamation equipment R411, R412, R421 and R422, four units of classification equipment C411, C412, C421 and C422, switching equipment V3, a return system PL1 and two units of dust collection equipment DC and DO, switching equipment V4 and a return system PL2.

The units of dry mechanical reclamation equipment R411, R412, R421 and R422 reclaim the molding sand S by stripping away carbonized matter, sintered matter, metal compounds or the like that have adhered to the surface of the molding sand S discharged from green sand casting equipment. The dry mechanical reclamation equipment R411, R412, R421 and R422 all have the same mechanism, and any system may be used as long as it is able to make the loss-on-ignition equal to or less than the control value.

The units of classification equipment C411, C412, C421 and C422 classify the reclaimed molding sand S by means of a specific-gravity classification system, and separate the sand grains, which are to be recovered, from the fine powders such as carbonized matter, sintered matter and metal compounds that is to be collected. The classification equipment C411, C412, C421 and C422 all have the same mechanism, and the classification equipment C may use any system as long as it is able to remove fine powders until the total clay content in the reclaimed molding sand S is equal to or less than the control value.

The dry mechanical reclamation equipment R411 that is connected to the end of the switching equipment V4 is serially connected to the classification equipment C411, the dry mechanical reclamation equipment R412 and the classification equipment C412, and at the end thereof, is connected to the switching equipment V3. Similarly, the dry mechanical reclamation equipment R421 that is connected to the end of the switching equipment V4 is serially connected to the classification equipment C421, the dry mechanical reclamation equipment R422 and the classification equipment C422, and at the end thereof, is connected to the switching equipment V3. From a different viewpoint, the structure formed by the dry mechanical reclamation equipment R411, the classification equipment C411, the dry mechanical reclamation equipment R412 and the classification equipment C412, and the structure formed by the dry mechanical reclamation equipment R421, the classification equipment C421, the dry mechanical reclamation equipment R422 and the classification equipment C422 are arranged in parallel between the switching equipment V4 and the switching equipment V3.

Following the classification equipment C412 and C422, the switching equipment V3 is provided for switching between whether to discharge the classified reclaimed sand (molding sand S) from the reclamation equipment 41 or to return the reclaimed sand that has been classified to the loading ports of the dry reclamation equipment R411 and R421 to repeat the reclamation process. The switching equipment V3 is connected to a return system PL1 for returning the classified reclaimed sand to the path through the dry mechanical reclamation equipment R411, the classification equipment C411, the dry mechanical reclamation equipment R412 and the classification equipment C412, and the path through the dry mechanical reclamation equipment R421, the classification equipment C421, the dry mechanical reclamation equipment R422 and the classification equipment C422. The structure allows the reclaimed sand that has been classified to be returned to the path through the dry mechanical reclamation equipment R411, the classification equipment C411, the dry mechanical reclamation equipment R412 and the classification equipment C412, and the path through the dry mechanical reclamation equipment R421, the classification equipment C421, the dry mechanical reclamation equipment R422 and the classification equipment C422, if the loss-on-ignition and the total clay content of the reclaimed sand that has been classified are not equal to or less than the control values.

The dust collection equipment DC is connected to the classification equipment C411 and C421, and collects dust (fine powders) generated in the classification equipment C411 and C421. The dust collection equipment DO is connected to the classification equipment C412 and C422, and collects dust (fine powders) generated in the classification equipment C412 and C422.

### (Reclamation Method)

Next, the molding sand reclamation method using the reclamation equipment 51 according to the sixth embodiment will be explained. FIG. 27 is a flow chart showing the molding sand reclamation method using the reclamation equipment 51 according to the sixth embodiment. The molding sand S used in the present reclamation method, as described in connection with the second embodiment, may contain moisture and/or have magnetized matter adhered thereto.

First, the moisture content and the magnetized matter content of the molding sand S are measured (first step). If the measured value of the moisture content of the molding sand S exceeds the control value, the molding sand S is dried in the drying equipment D (second step). In this case, the control value of the moisture content should preferably be 0.5%. If the measured value of the magnetized matter content in the molding sand S exceeds the control value, the molding sand S is magnetically separated in the magnetic separation equipment M (second step). In this case, the control value of the magnetized matter content should preferably be 5.0%. If the measured value for the moisture content in the molding sand S does not exceed the control value, then the molding sand S does not need to be dried in the drying equipment D, so the switching equipment V1 is used to allow the molding sand S to pass through the bypass system BP1 (second step). If the measured value for the magnetized matter content in the molding sand S does not exceed the control value, then the molding sand S does not need to be magnetically separated in the magnetic separation equipment M, so the switching equipment V2 is used to allow the molding sand S to pass through the bypass system BP2 (second step).

If the measured values for the moisture content and the magnetized matter content in the molding sand S do not exceed the control values, the molding sand S does not need to be dried in the drying equipment D or magnetically separated in the magnetic separation equipment M, so the switching equipment V1 is used to set the molding sand S so as to pass through the bypass system BP1, and the switching equipment V2 is used to set the molding sand S so as to pass through the bypass system BP2 (second step). The path passing through both the bypass system BP1 and the bypass system BP2 in this way will be referred to as the bypass system BP3.

Next, the moisture content and the magnetized matter content in the molding sand S are measured again (third step). If the measured value of the moisture content in the molding sand S exceeds the control value and/or the measured value of the magnetized matter content in the molding sand S exceeds the control value, the switching equipment V4 is used to set the molding sand S so as to return, through the return system PL2, to before the switching equipment V1, in order to pass the molding sand through the second step (drying step and/or magnetic separation step) again (third step). Then, the molding sand S is passed through the drying equipment D and/or the magnetic separation equipment M again. The present step is repeated until the measured values of the moisture content and the magnetized matter content in the molding sand S become equal to or less than the control values. If the measured values for the moisture content and the magnetized matter content in the molding sand S are equal to or less than the control values, the switching equipment V4 is used to set the molding sand S so as to be sent to the mechanical reclamation equipment R, and the molding sand S is sent to the dry mechanical reclamation equipment R (third step).

Next, the molding sand S is reclaimed respectively in the dry mechanical reclamation equipment R411 and R421 (fourth step). The reclamation process reduces the loss-on-ignition of the molding sand S. Next, the reclaimed molding sand S is classified in the classification equipment C411 and C421 using a specific-gravity classification method (fifth step). The classification process reduces the total clay content of the molding sand S.

Next, the dust collected from the classification equipment C411 and C421 is recovered by the dust collection equipment DC alone. As mentioned previously, the dust generated initially (in the first pass) is mainly bentonite and green sand additives that have adhered to the sand grain surface. Therefore, by recovering the dust generated during this step separately, this dust can be reused as a substitute for bentonite and green sand additives during the mixing of the molding sand.

Next, the molding sand S that has once been subjected to the reclamation process is again reclaimed in the dry mechanical reclamation equipment R412 and R422 (fourth step). By performing the reclamation process again, the loss-on-ignition of the molding sand S is reduced. Next, the reclaimed molding sand S is classified in the classification equipment C412 and C422 using a specific-gravity classification method (fifth step). The classification process reduces the total clay content of the molding sand S.

The molding sand S (reclaimed sand) that has undergone the fourth step (reclamation process) twice and the fifth step (classification process) twice has both a reduced loss-on-ignition and a reduced total clay content, but ultimately, both numerical values must be brought to equal to or less than the control values. Therefore, if the loss-on-ignition and the total clay content of the molding sand S exceed the control values, then the switching equipment V3 is used to set the molding sand S to return to the dry mechanical reclamation equipment R411 and R421 via the return system PL1 in order to make the molding sand S undergo the fourth step (reclamation process) and the fifth step (classification process) again.

Conversely, if as a result of undergoing the fourth step (reclamation process) twice and the fifth step (classification process) twice, the loss-on-ignition and the total clay content of the molding sand S are equal to or less than the control values, then the switching equipment V3 is used to set the molding sand S to be discharged from the reclamation equipment 1. This ends the reclamation process. In this case, the control value for the loss-on-ignition should preferably be 0.6%. Additionally, the control value for the total clay content should preferably be 0.6%.

The dust collection equipment DO collects dust generated in the classification equipment C412 and C422, and the dust generated in the classification equipment C411 and C421 for the second and subsequent passes.

Thus, with the molding sand reclamation method and reclamation equipment according to the sixth embodiment, there is no need to combine reclamation equipment having different mechanisms, and it is possible to easily decide the structure of the reclamation equipment in accordance with the amount being processed and the control values for the loss-on-ignition and the total clay content.

Additionally, with the molding sand reclamation method and reclamation equipment according to the sixth embodiment, it is possible to appropriately suspend unneeded steps in accordance with variations in the load required for the steps, due to the amount being processed, the required processing capacity or the like, so it is possible to adapt more flexibly to load variations than in the second embodiment.

Additionally, with the molding sand reclamation method and reclamation equipment according to the sixth embodiment, two reclamation processes and two classification processes can be performed at once, so the number of times that switching equipment must be used to return the molding sand to the reclamation process and the classification process can be reduced.

Additionally, with the molding sand reclamation method and reclamation equipment according to the sixth embodiment, a drying step in drying equipment and/or a magnetic separation step in magnetic separation equipment M can be repeated until the moisture content and the magnetized matter content in the molding sand become equal to or less than the control values, so it is possible to reliably make the moisture content and the magnetized matter content in the molding sand equal to or less than the control values.

### Seventh Embodiment

The seventh embodiment has a structure wherein a plurality of units of the reclamation equipment R and the classification equipment C from the third embodiment are arranged serially and in parallel. The sixth embodiment will be explained with reference to the attached drawings. Regarding the molding sand reclamation method and reclamation equipment according to the present embodiment, the portions that differ from the third embodiment will be explained. The other portions are the same as in the second embodiment, so reference will be made to the above-given descriptions, and the descriptions will here be omitted.

FIG. 28 is a schematic block diagram of molding sand reclamation equipment according to the seventh embodiment. The reclamation equipment 61 comprises overflow sand recovery equipment PO, drying equipment D, overflow sand foreign-matter removal equipment IO, an overflow sand storage tank SSO, product-adhered sand recovery equipment PS, product-adhered sand foreign-matter removal equipment IS, magnetic separation equipment M, a product-adhered sand storage tank SSS, main mold/core-mixed sand recovery equipment PL, crushing equipment L, main mold/core-mixed sand foreign-matter removal equipment IL, a main mold/core-mixed sand storage tank SSL, sand lumps/sand recovery equipment PC, crushing equipment L, sand lumps/sand foreign-matter removal equipment IC, a sand lumps/sand storage tank SSC, sand cutting/blending equipment F, four units of dry mechanical reclamation equipment R411, R412, R421 and R422, four units of classification equipment C411, C412, C421 and C422, classification equipment C, switching equipment V3, a return system PL1 and two units of dust collection equipment DC and DO.

The four units of dry mechanical reclamation equipment R411, R412, R421 and R422 reclaim molding sand S by stripping away carbonized matter, sintered matter, metal compounds or the like that have adhered to the surface of the blended molding sand S. The dry mechanical reclamation equipment R411, R412, R421 and R422 all have the same mechanism, and any system may be used as long as it is able to make the loss-on-ignition equal to or less than the control value.

The units of classification equipment C411, C412, C421 and C422 classify the reclaimed molding sand S by means of a specific-gravity classification system, and separate the sand grains, which are to be recovered, from the fine powders such as carbonized matter, sintered matter and metal compounds that is to be collected. The classification equipment C411, C412, C421 and C422 all have the same mechanism, and any system may be used as long as it is able to remove fine powders until the total clay content in the reclaimed molding sand S is equal to or less than the control value.

The dry mechanical reclamation equipment R411 that is connected to the latter stages of the sand cutting/blending equipment F is serially connected to the classification equipment C411, the dry mechanical reclamation equipment R412 and the classification equipment C412, and at the end thereof, is connected to the switching equipment V3. Similarly, the dry mechanical reclamation equipment R421 that is connected to the end of the bypass system BP2 is serially connected to the classification equipment C421, the dry mechanical reclamation equipment R422 and the classification equipment C422, and at the end thereof, is connected to the switching equipment V3. From a different viewpoint, the structure formed by the dry mechanical reclamation equipment R411, the classification equipment C411, the dry mechanical reclamation equipment R412 and the classification equipment C412, and the structure formed by the dry mechanical reclamation equipment R421, the classification equipment C421, the dry mechanical reclamation equipment R422 and the classification equipment C422 are arranged in parallel between the bypass system BP2 and the switching equipment V3.

Following the classification equipment C412 and C422, the switching equipment V3 is provided for switching between whether to discharge the classified reclaimed sand (molding sand S) from the reclamation equipment 41 or to return the reclaimed sand that has been classified to the loading ports of the dry reclamation equipment R411 and R421 to repeat the reclamation process. The switching equipment V3 is connected to a return system PL1 for returning the classified reclaimed sand to the path through the dry mechanical reclamation equipment R411, the classification equipment C411, the dry mechanical reclamation equipment R412 and the classification equipment C412, and the path through the dry mechanical reclamation equipment R421, the classification equipment C421, the dry mechanical reclamation equipment R422 and the classification equipment C422. The structure allows the reclaimed sand that has been classified to be returned to the path through the dry mechanical reclamation equipment R411, the classification equipment C411, the dry mechanical reclamation equipment R412 and the classification equipment C412, and the path through the dry mechanical reclamation equipment R421, the classification equipment C421, the dry mechanical reclamation equipment R422 and the classification equipment C422, if the loss-on-ignition and the total clay content of the reclaimed sand that has been classified are not equal to or less than the control values.

The dust collection equipment DC is connected to the classification equipment C411 and C421, and collects dust (fine powders) generated in the classification equipment C411 and C421. The dust collection equipment DO is connected to the classification equipment C412 and C422, and collects dust (fine powders) generated in the classification equipment C412 and C422.

### (Reclamation Method)

Next, the molding sand reclamation method using the reclamation equipment 61 according to the seventh embodiment will be explained. FIG. 29 is a flow chart showing the molding sand reclamation method using the reclamation equipment 61 according to the seventh embodiment.

Of the molding sand S that is discharged from the green sand casting equipment, the overflow sand that has been discharged from sand processing equipment is recovered by the overflow sand recovery equipment PO (first step-1). Next, the overflow sand is dried in the drying equipment D until the moisture content becomes equal to or less than a control value (second step-1). In this case, the control value for the moisture content should preferably be 0.5%. Next, in the overflow sand foreign-matter removal equipment IO, foreign matter is removed from the dried overflow sand (second step-1). Finally, the overflow sand from which foreign matter has been removed is stored in the overflow sand storage tank SSO (second step-1).

Of the molding sand S that is discharged from the green sand casting equipment, the sand adhering to the product is recovered by the product-adhered sand recovery equipment PS (first step-2). Next, foreign matter is removed from the sand adhering to the product in the product-adhered sand foreign-matter removal equipment IS (second step-2). Next, the sand adhering to the product from which the foreign matter has been removed is magnetically separated in the magnetic separation equipment M until the magnetized matter content in the sand adhering to the product becomes equal to or less than the control value (second step-2). In this case, the control value for the magnetized matter content should preferably be 5.0%. Finally, the magnetically separated sand adhering to the product is stored in the product-adhered sand storage tank SSS (second step-2).

Of the molding sand S that is discharged from the green sand casting equipment, the main mold/core-mixed sand is recovered by the main mold/core-mixed sand recovery equipment PL (first step-3). Next, the main mold/core-mixed sand is crushed in the crushing equipment L (second step-3). Next, foreign matter is removed from the crushed main mold/core-mixed sand in the main mold/core-mixed sand foreign-matter removal equipment IL (second step-3). Finally, the main mold/core-mixed sand from which foreign matter has been removed is stored in the main mold/core-mixed sand storage tank SSL (second step-3).

Of the molding sand S that is discharged from the green sand casting equipment, the sand lumps/sand discharged during the core sand extraction step is recovered by the sand lumps/sand recovery equipment PC (first step-4). Next, the sand lumps/sand discharged during the core sand extraction step are crushed in the crushing equipment L (second step-4). Next, foreign matter is removed from the crushed sand lumps/sand in the sand lumps/sand foreign-matter removal equipment IC (second step-4). Finally, the sand lumps/sand from which foreign matter has been removed is stored in the sand lumps/sand storage tank SSC (second step-4).

The sand stored in the overflow sand storage tank SSO, the product-adhered sand storage tank SSS, the main mold/core-mixed sand storage tank SSL and the sand lumps/sand storage tank SSC is cut out and blended by the sand cutting/blending equipment F, such that the ratio between the sand cut out from these storage tanks is always constant (third step).

Next, the molding sand S is reclaimed respectively in the dry mechanical reclamation equipment R411 and R421 (fourth step). The reclamation process reduces the loss-on-ignition of the molding sand S. Next, the reclaimed molding sand S is classified in the classification equipment C411 and C421 using a specific-gravity classification method (fifth step). The classification process reduces the total clay content of the molding sand S.

Next, the dust collected from the classification equipment C411 and C421 is recovered by the dust collection equipment DC alone. As mentioned previously, the dust generated initially (in the first pass) is mainly bentonite and green sand additives that have adhered to the sand grain surface. Therefore, by recovering the dust generated during this step separately, this dust can be reused as a substitute for bentonite and green sand additives during the mixing of the molding sand.

Next, the molding sand S that has once been subjected to the reclamation process is again reclaimed in the dry mechanical reclamation equipment R412 and R422 (fourth step). By performing the reclamation process again, the loss-on-ignition of the molding sand S is reduced. Next, the reclaimed molding sand S is again classified in the classification equipment C412 and C422 using a specific-gravity classification method (fifth step). The classification process reduces the total clay content of the molding sand S.

The molding sand S (reclaimed sand) that has undergone the fourth step (reclamation process) twice and the fifth step (classification process) twice has both a reduced loss-on-ignition and a reduced total clay content, but ultimately, both numerical values must be brought to equal to or less than the control values. Therefore, if the loss-on-ignition and the total clay content of the molding sand S exceed the control values, then the switching equipment V3 is used to set the molding sand S to return to the dry mechanical reclamation equipment R411 and R421 via the return system PL1 in order to make the molding sand S undergo the fourth step (reclamation process) and the fifth step (classification process) again.

Conversely, if as a result of undergoing the fourth step (reclamation process) twice and the fifth step (classification process) twice, the loss-on-ignition and the total clay content of the molding sand S are equal to or less than the control values, then the switching equipment V3 is used to set the molding sand S to be discharged from the reclamation equipment 1. This ends the reclamation process. In this case, the control value for the loss-on-ignition should preferably be 0.6%. Additionally, the control value for the total clay content should preferably be 0.6%.

The dust collection equipment DO collects dust generated in the classification equipment C412 and C422, and the dust generated in the classification equipment C411 and C421 for the second and subsequent passes.

Thus, with the molding sand reclamation method and reclamation equipment according to the seventh embodiment, there is no need to combine reclamation equipment having different mechanisms, and it is possible to easily decide the structure of the reclamation equipment in accordance with the amount being processed and the control values for the loss-on-ignition and the total clay content.

Additionally, with the molding sand reclamation method and reclamation equipment according to the seventh embodiment, it is possible to appropriately suspend unneeded steps in accordance with variations in the load required for the steps, due to the amount being processed, the required processing capacity or the like, so it is possible to adapt more flexibly to load variations than in the third embodiment.

Additionally, with the molding sand reclamation method and reclamation equipment according to the seventh embodiment, two reclamation processes and two classification processes can be performed at once, so the number of times that switching equipment must be used to return the molding sand to the reclamation process and the classification process can be reduced.

Additionally, with the molding sand reclamation method and reclamation equipment according to the seventh embodiment, it is possible to reclaim, by only dry mechanical reclamation, various types of molding sand that have been discharged from green sand casting equipment. As a result thereof, it is unnecessary to perform a separation process for impurities or a neutralization process for waste water that is generated when using wet reclamation, the large amounts of energy that are consumed when using thermal reclamation can be reduced, and the reclamation equipment can be made compact and simple, so the efficiency required for sand reclamation can be raised and the cost of sand reclamation can be reduced.

Additionally, with the molding sand reclamation method and reclamation equipment according to the seventh embodiment, it is possible to separately pretreat molding sand having respectively different properties that has been discharged from various parts of green sand casting equipment, and to perform dry mechanical reclamation, and furthermore to remove fine powders, with the sand always cut out and blended at a constant ratio, so the properties of the reclaimed sand can always be held constant. Therefore, the reclaimed sand can be directly reused in green sand casting equipment.

### Eighth Embodiment

The eighth embodiment has a structure wherein a plurality of units of the reclamation equipment R and the classification equipment C from the fourth embodiment are arranged serially and in parallel. The eighth embodiment will be explained with reference to the attached drawings. Regarding the molding sand reclamation method and reclamation equipment according to the present embodiment, the portions that differ from the fourth embodiment will be explained. The other portions are the same as in the fourth embodiment, so reference will be made to the above-given descriptions, and the descriptions will here be omitted.

FIG. 30 is a schematic block diagram of molding sand reclamation equipment 71 according to the eighth embodiment. The reclamation equipment 71 comprises overflow sand recovery equipment PO, drying equipment D, overflow sand foreign-matter removal equipment IO, an overflow sand storage tank SSO, product-adhered sand recovery equipment PS, product-adhered sand foreign-matter removal equipment IS, magnetic separation equipment M, a product-adhered sand storage tank SSS, main mold/core-mixed sand recovery equipment PL, crushing equipment L, main mold/core-mixed sand foreign-matter removal equipment IL, heating equipment TR, a main mold/core-mixed sand storage tank SSL, sand lumps/sand recovery equipment PC, crushing equipment L, sand lumps/sand foreign-matter removal equipment IC, heating equipment TR, a sand lumps/sand storage tank SSC, sand cutting/blending equipment F, four units of dry mechanical reclamation equipment R411, R412, R421 and R422, four units of classification equipment C411, C412, C421 and C422, switching equipment V3, a return system PL1 and two units of dust collection equipment DC and DO.

The four units of dry mechanical reclamation equipment R411, R412, R421 and R422 reclaim molding sand S by stripping away carbonized matter, sintered matter, metal compounds or the like that have adhered to the surface of the blended molding sand S. The dry mechanical reclamation equipment R411, R412, R421 and R422 all have the same mechanism, and any system may be used as long as it is able to make the loss-on-ignition equal to or less than the control value.

The units of classification equipment C411, C412, C421 and C422 classify the reclaimed molding sand S by means of a specific-gravity classification system, and separate the sand grains, which are to be recovered, from the fine powders such as carbonized matter, sintered matter and metal compounds that is to be collected. The classification equipment C411, C412, C421 and C422 all have the same mechanism, and any system may be used as long as it is able to remove fine powders until the total clay content in the reclaimed molding sand S is equal to or less than the control value.

The dry mechanical reclamation equipment R411 that is connected to the latter stages of the sand cutting/blending equipment F is serially connected to the classification equipment C411, the dry mechanical reclamation equipment R412 and the classification equipment C412, and at the end thereof, is connected to the switching equipment V3. Similarly, the dry mechanical reclamation equipment R421 that is connected to the end of the bypass system BP2 is serially connected to the classification equipment C421, the dry mechanical reclamation equipment R422 and the classification equipment C422, and at the end thereof, is connected to the switching equipment V3. From a different viewpoint, the structure formed by the dry mechanical reclamation equipment R411, the classification equipment C411, the dry mechanical reclamation equipment R412 and the classification equipment C412, and the structure formed by the dry mechanical reclamation equipment R421, the classification equipment C421, the dry mechanical reclamation equipment R422 and the classification equipment C422 are arranged in parallel between the bypass system BP2 and the switching equipment V3.

Following the classification equipment C412 and C422, the switching equipment V3 is provided for switching between whether to discharge the classified reclaimed sand (molding sand S) from the reclamation equipment 41 or to return the reclaimed sand that has been classified to the loading ports of the dry reclamation equipment R411 and R421 to repeat the reclamation process. The switching equipment V3 is connected to a return system PL1 for returning the classified reclaimed sand to the path through the dry mechanical reclamation equipment R411, the classification equipment C411, the dry mechanical reclamation equipment R412 and the classification equipment C412, and the path through the dry mechanical reclamation equipment R421, the classification equipment C421, the dry mechanical reclamation equipment R422 and the classification equipment C422. The structure allows the reclaimed sand that has been classified to be returned to the path through the dry mechanical reclamation equipment R411, the classification equipment C411, the dry mechanical reclamation equipment R412 and the classification equipment C412, and the path through the dry mechanical reclamation equipment R421, the classification equipment C421, the dry mechanical reclamation equipment R422 and the classification equipment C422, if the loss-on-ignition and the total clay content of the reclaimed sand that has been classified are not equal to or less than the control values.

The dust collection equipment DC is connected to the classification equipment C411 and C421, and collects dust (fine powders) generated in the classification equipment C411 and C421. The dust collection equipment DO is connected to the classification equipment C412 and C422, and collects dust (fine powders) generated in the classification equipment C412 and C422.

### (Reclamation Method)

Next, the molding sand reclamation method using the reclamation equipment 71 according to the eighth embodiment will be explained. FIG. 31 is a flow chart showing the molding sand reclamation method using the reclamation equipment 71 according to the eighth embodiment.

Of the molding sand S that is discharged from the green sand casting equipment, the overflow sand that has been discharged from sand processing equipment is recovered by the overflow sand recovery equipment PO (first step-1). Next, the overflow sand is dried in the drying equipment D until the moisture content becomes equal to or less than a control value (second step-1). In this case, the control value for the moisture content should preferably be 0.5%. Next, in the overflow sand foreign-matter removal equipment IO, foreign matter is removed from the dried overflow sand (second step-1). Finally, the overflow sand from which foreign matter has been removed is stored in the overflow sand storage tank SSO (second step-1).

Of the molding sand S that is discharged from the green sand casting equipment, the sand adhering to the product is recovered by the product-adhered sand recovery equipment PS (first step-2). Next, foreign matter is removed from the sand adhering to the product in the product-adhered sand foreign-matter removal equipment IS (second step-2). Next, the sand adhering to the product from which the foreign matter has been removed is magnetically separated in the magnetic separation equipment M until the magnetized matter content in the sand adhering to the product becomes equal to or less than the control value (second step-2). In this case, the control value for the magnetized matter content should preferably beb 5.0%. Finally, the magnetically separated sand adhering to the product is stored in the product-adhered sand storage tank SSS (second step-2).

Of the molding sand S that is discharged from the green sand casting equipment, the main mold/core-mixed sand is recovered by the main mold/core-mixed sand recovery equipment PL (first step-3). Next, the main mold/core-mixed sand is crushed in the crushing equipment L (second step-3). Next, foreign matter is removed from the crushed main mold/core-mixed sand in the main mold/core-mixed sand foreign-matter removal equipment IL (second step-3). Next, the main mold/core-mixed sand from which foreign matter has been removed is heated to at least 400° C. (second step-3). Finally, the heated main mold/core-mixed sand is stored in the main mold/core-mixed sand storage tank SSL (second step-3).

Of the molding sand S that is discharged from the green sand casting equipment, the sand lumps/sand discharged during the core sand extraction step is recovered by the sand lumps/sand recovery equipment PC (first step-4). Next, the sand lumps/sand discharged during the core sand extraction step are crushed in the crushing equipment L (second step-4). Next, foreign matter is removed from the crushed sand lumps/sand in the sand lumps/sand foreign-matter removal equipment IC (second step-4). Next, the sand lumps/sand from which foreign matter has been removed is heated to at least 400° C. (second step-4). Finally, the heated sand lumps/sand is stored in the sand lumps/sand storage tank SSC (second step-4).

The sand stored in the overflow sand storage tank SSO, the product-adhered sand storage tank SSS, the main mold/core-mixed sand storage tank SSL and the sand lumps/sand storage tank SSC is cut out and blended by the sand cutting/blending equipment F, such that the ratio of the sand cut out from these storage tanks is always constant (third step).

Next, the molding sand S is reclaimed respectively in the dry mechanical reclamation equipment R411 and R421 (fourth step). The reclamation process reduces the loss-on-ignition of the molding sand S. Next, the reclaimed molding sand S is classified in the classification equipment C411 and C421 using a specific-gravity classification method (fifth step). The classification process reduces the total clay content of the molding sand S.

Next, the dust collected from the classification equipment C411 and C421 is recovered by the dust collection equipment DC alone. As mentioned previously, the dust generated initially (in the first pass) is mainly bentonite and green sand additives that have adhered to the sand grain surface. Therefore, by recovering the dust generated during this step separately, this dust can be reused as a substitute for bentonite and green sand additives during the mixing of the molding sand.

Next, the molding sand S that has once been subjected to the reclamation process is again reclaimed in the dry mechanical reclamation equipment R412 and R422 (fourth step). By performing the reclamation process again, the loss-on-ignition of the molding sand S is reduced. Next, the reclaimed molding sand S is classified in the classification equipment C412 and C422 using a specific-gravity classification method (fifth step). The classification process reduces the total clay content of the molding sand S.

The molding sand S (reclaimed sand) that has undergone the fourth step (reclamation process) twice and the fifth step (classification process) twice has both a reduced loss-on-ignition and a reduced total clay content, but ultimately, both numerical values must be brought to equal to or less than the control values. Therefore, if the loss-on-ignition and the total clay content of the molding sand S exceed the control values, then the switching equipment V3 is used to set the molding sand S to return to the dry mechanical reclamation equipment R411 and R421 via the return system PL1 in order to make the molding sand S undergo the fourth step (reclamation process) and the fifth step (classification process) again.

Conversely, if as a result of undergoing the fourth step (reclamation process) twice and the fifth step (classification process) twice, the loss-on-ignition and the total clay content of the molding sand S are equal to or less than the control values, then the switching equipment V3 is used to set the molding sand S to be discharged from the reclamation equipment 1. This ends the reclamation process. In this case, the control value for the loss-on-ignition should preferably be 0.6%. Additionally, the control value for the total clay content should preferably be 0.6%.

The dust collection equipment DO collects dust generated in the classification equipment C412 and C422, and the dust generated in the classification equipment C411 and C421 for the second and subsequent passes.

Thus, with the molding sand reclamation method and reclamation equipment according to the eighth embodiment, there is no need to combine reclamation equipment having different mechanisms, and it is possible to easily decide the structure of the reclamation equipment in accordance with the amount being processed and the control values for the loss-on-ignition and the total clay content.

Additionally, with the molding sand reclamation method and reclamation equipment according to the eighth embodiment, it is possible to appropriately suspend unneeded steps in accordance with variations in the load required for the steps, due to the amount being processed, the required processing capacity or the like, so it is possible to adapt more flexibly to load variations than in the fourth embodiment.

Additionally, with the molding sand reclamation method and reclamation equipment according to the eighth embodiment, two reclamation processes and two classification processes can be performed at once, so the number of times that switching equipment must be used to return the molding sand to the reclamation process and the classification process can be reduced.

Additionally, with the molding sand reclamation method and reclamation equipment according to the eighth embodiment, even if the core used in the green sand casting equipment is produced by a thermal-dehydration-cured water glass process, the main mold/core-mixed sand discharged from various parts of the green sand casting equipment and the sand lumps/sand discharged during the core sand extraction step are heated, thereby converting the amorphous silicic acid hydrates remaining therein to glass, and sealing metal oxides in the interior thereof. Thereafter, dry mechanical reclamation is performed, so it is possible to render harmless the silicic acid hydrates and metal oxides that are detrimental to the strength development of the molds.

### EXAMPLE 1

Using the reclamation equipment 1 of the first embodiment, green sand was reclaimed in five passes for the purpose of reclaiming the sand for use in a shell core, and the properties of the reclaimed sand and the physical properties of the core were evaluated. When evaluating the physical properties of the core, resin-coated sand (hereinafter referred to as RCS) was prepared using a blend of 2.0% (with respect to the sand) of a phenolic resin, 15% (with respect to the resin) of hexamethylene tetramine and 0.1% (with respect to the sand) of calcium stearate, and this RCS was evaluated. Additionally, the evaluation method was performed using a test piece having the dimensions of width 10 mm×height 10 mm×length 60 mm and molded by firing for 60 seconds at 250° C., in compliance with JACT Testing Method SM-1, “Bending Strength Testing Method”, defined by the Japan Association of Casting Technology.

### EXAMPLE 2

Using the reclamation equipment 1 of the first embodiment, green sand was reclaimed in ten passes for the purpose of reclaiming the sand for use in a shell core, and the properties of the reclaimed sand and the physical properties of the core were evaluated. The RCS preparation method and physical property evaluation method were the same as in Example 1.

### COMPARATIVE EXAMPLE 1

As Comparative Example 1, green sand was reclaimed in six passes using a post-calcination centrifugal friction-type molding sand reclamation apparatus for the purpose of reclaiming the sand for use in a shell core, and the properties of the reclaimed sand and the physical properties of the core were evaluated. The RCS preparation method and physical property evaluation method were the same as in Example 1.

### COMPARATIVE EXAMPLE 2

As Comparative Example 2, reclamation was performed for 30 minutes using a batch abrasive polishing-type molding sand reclamation apparatus for the purpose of reclaiming green sand for use in a shell core, and the properties of the reclaimed sand and the physical properties of the core were evaluated. The RCS preparation method and physical property evaluation method were the same as in Example 1.

### COMPARATIVE EXAMPLE 3

As Comparative Example 3, reclamation was performed for 45 minutes using a batch abrasive polishing-type molding sand reclamation apparatus for the purpose of reclaiming green sand for use in a shell core, and the properties of the reclaimed sand and the physical properties of the core were evaluated. The RCS preparation method and physical property evaluation method were the same as in Example 1.

### COMPARATIVE EXAMPLE 4

As Comparative Example 4, reclamation was performed for 60 minutes using a batch abrasive polishing-type molding sand reclamation apparatus for the purpose of reclaiming green sand for use in a shell core, and the properties of the reclaimed sand and the physical properties of the core were evaluated. The RCS preparation method and physical property evaluation method were the same as in Example 1.

### COMPARATIVE EXAMPLE 5

As Comparative Example 5, the properties of sand and the physical properties of a core where evaluated using green sand in a state before reclamation. The RCS preparation method and physical property evaluation method were the same as in Example 1.

### COMPARATIVE EXAMPLE 6

As Comparative Example 6, sand of the same type (a mullite-based synthetic sand formed by a spray dryer method) as that used in Examples 1 and 2 and in Comparative Examples 1-5, in the unused state, i.e., so-called new sand, was evaluated for the properties of the sand and the physical properties of the core. The RCS preparation method and physical property evaluation method were the same as in Example 1.

TABLE 1

| | Test category | | | | | | | | | | | | | | |
|---|---|---|---|---|---|---|---|---|---|---|---|---|---|---|---|
| | Bending | Flexure | Fusion | | | | | | | | | | | AFS grain | Loss-on- |
| | strength | amount | point | Grain size distribution (mesh mm/%) | | | | | | | | | | fineness | ignition |
| Sample name | (N/cm²) | (mm) | (° C.) | 840 | 590 | 420 | 297 | 212 | 150 | 106 | 75 | 53 | Pan | number | (%) |
| Example 1 | 735.20 | 0.66 | 107 | 0.0 | 0.5 | 1.0 | 8.6 | 44.9 | 37.4 | 6.9 | 0.5 | 0.2 | 0.0 | 60.5 | 0.17 |
| Example 2 | 879.26 | 0.64 | 107 | 0.0 | 0.6 | 1.0 | 8.9 | 50.1 | 33.8 | 5.6 | 0.0 | 0.0 | 0.0 | 58.3 | 0.14 |
| Comparative | 328.01 | 1.19 | 109 | 0.0 | 0.6 | 1.2 | 6.9 | 41.7 | 34.8 | 8.5 | 4.9 | 1.4 | 0.0 | 66.6 | 0.39 |
| Example 1 | | | | | | | | | | | | | | | |
| Comparative | 444.72 | 0.93 | 109 | 0.0 | 0.4 | 0.7 | 6.7 | 38.3 | 35.8 | 8.4 | 7.2 | 2.5 | 0.0 | 70.7 | 0.32 |
| Example 2 | | | | | | | | | | | | | | | |
| Comparative | 549.19 | 0.88 | 108 | 0.0 | 0.4 | 0.9 | 6.1 | 42.9 | 36.8 | 8.3 | 3.3 | 1.3 | 0.0 | 65.6 | 0.23 |
| Example 3 | | | | | | | | | | | | | | | |
| Comparative | 320.66 | 1.38 | 111 | 0.2 | 0.9 | 1.3 | 11.3 | 46.4 | 33.6 | 6.0 | 0.3 | 0.0 | 0.0 | 58.3 | 0.05 |
| Example 4 | | | | | | | | | | | | | | | |
| Comparative | 81.34 | not | 113 | 0.9 | 1.1 | 1.6 | 9.9 | 39.3 | 31.9 | 7.2 | 6.7 | 1.4 | 0.0 | 66.1 | 0.75 |
| Example 5 | | measurable | | | | | | | | | | | | | |
| Comparative | 720.20 | 0.82 | 106 | 0.0 | 0.4 | 0.4 | 3.6 | 41.5 | 39.5 | 13.0 | 1.6 | 0.0 | 0.0 | 65.3 | 0.01 |
| Example 6 | | | | | | | | | | | | | | | |

Table 1 shows a list of the results for the sand properties and the physical properties of the cores for Examples 1 and 2 and Comparative Examples 1-6. The results in Examples 1 and 2 were better than the results for all of Comparative Examples 1-6. In particular, mullite-based synthetic sand formed by a spray dryer method is a type of sand that is difficult to reclaim mechanically, and the evaluation results in Comparative Examples 1-4, which use conventional systems, were inferior to those in Comparative Example 6, which indicates the evaluation results for new sand. In contrast, the results for Examples 1 and 2 exceeded even Comparative Example 6, which indicates the evaluation results for new sand. This means that, when molding sand is reclaimed using the reclamation equipment 1 of the first embodiment, it is possible to make reclaimed sand that is of better quality than new sand. In fact, because cores that are produced using only reclaimed sand cannot be used if the evaluation results of the reclaimed sand are inferior to those of new sand, only a portion of the new sand can be replaced with reclaimed sand. For this reason, not all of the reclaimed sand can be consumed for use in cores. On the other hand, if the evaluation results for the reclaimed sand are superior to those for new sand, then cores produced using only reclaimed sand can be used, and all of the reclaimed sand can be consumed for use in cores.

### EXAMPLE 3

Using equipment having the structure in Example 1 of the first embodiment, green sand having silica sand as the main component was reclaimed in three passes for the purpose of reclaiming the sand for use in a phenolic urethane self-hardening core, and the properties of the reclaimed sand and the physical properties of the core were evaluated. The core sand was prepared by blending 0.85% (with respect to the sand) of a phenolic resin, 0.85% (with respect to the sand) of polyisocyanate and 0.1% (with respect to the sand) of a hardening catalyst, and the evaluation method was performed in compliance with JACT Testing Method HM-1, “Compressive Strength Testing Method”, defined by the Japan Association of Casting Technology.

### COMPARATIVE EXAMPLE 7

As Comparative Example 7, green sand having silica sand as the main component was reclaimed in ten passes using a continuous centrifugal friction-type sand reclamation apparatus with the same processing amount and required power as Example 7, for use in a phenolic urethane self-hardening core. The core sand preparation method and the physical property evaluation method were similar to Example 3.

TABLE 2

| | Test category | | | | | | | | | | | | | | |
|---|---|---|---|---|---|---|---|---|---|---|---|---|---|---|---|
| | Compressive | | | | | | | | | | | | | | Total |
| | strength after | | | | | | | | | | | AFS grain | | Loss-on- | clay |
| | 60 min. | Grain size distribution (mesh mm/%) | | | | | | | | | | fineness | Moisture | ignition | content |
| Sample name | (N/cm²) | 840 | 590 | 420 | 297 | 212 | 150 | 106 | 75 | 53 | Pan | number | (%) | (%) | (%) |
| Example 3 | 464.0 | 0.0 | 0.0 | 1.2 | 24.6 | 35.5 | 32.1 | 4.0 | 2.6 | 0.0 | 0.0 | 58.1 | 0.18 | 0.51 | 0.6 |
| Comparative | 425.0 | 0.0 | 0.0 | 3.9 | 28.0 | 36.1 | 23.2 | 7.5 | 1.1 | 0.2 | 0.0 | 56.1 | 0.25 | 0.67 | 0.8 |
| Example 7 | | | | | | | | | | | | | | | |

Table 2 shows the results for the properties of the reclaimed sand and the physical properties of the cores for Example 3 and Comparative Example 7. Comparing Example 3 with Comparative Example 7, the sand properties are of about the same level, but Example 3 has more strength than Comparative Example 7. Additionally, Comparative Example 7 requires ten passes with the same processing amount and required power in order to attain the same level of sand properties that is achieved with three passes in Example 3. Based on these results, Example 3 can be considered to be superior to Comparative Example 7 in terms of the amount of energy consumed.

### EXAMPLE 4

Using the reclamation equipment 1 of the first embodiment, green sand having silica sand as the main component was reclaimed in three passes, after performing magnetic separation beforehand in a magnetic separator having a magnetic flux density of 0.3 T, for the purpose of reclaiming the sand for use in a phenolic urethane cold-box core, and the properties of the reclaimed sand and the physical properties of the core were evaluated. The core sand was prepared by blending 1.0% (with respect to the sand) of a phenolic resin and 1.0% (with respect to the sand) of polyisocyanate, and the evaluation method was performed using a test piece having the dimensions of width 10 mm×height 10 mm×length 60 mm and molded with blow conditions of 0.4 MPa×3 seconds and gassing purge conditions of 0.2 MPa×10 seconds each, in compliance with JACT Testing Method SM-1, “Bending Strength Testing Method”, defined by the Japan Association of Casting Technology.

### COMPARATIVE EXAMPLE 8

As Comparative Example 8, using the reclamation equipment 1 of the first embodiment, green sand having silica sand as the main component was reclaimed in three passes for the purpose of reclaiming the sand for use in a phenolic urethane cold-box core, and the properties of the reclaimed sand and the physical properties of the core were evaluated. The core sand preparation method and the physical property evaluation method were the same as in Example 4.

TABLE 3

| | Test category | | | | | | | | | | | | | | | |
|---|---|---|---|---|---|---|---|---|---|---|---|---|---|---|---|---|
| | | | | | | | | | | | | | | | | Magne- |
| | | | | | | | | | | | | | | | Total | tized |
| | Bending | | | | | | | | | | | AFS grain | | Loss-on- | clay | matter |
| | strength | Grain size distribution (mesh mm/%) | | | | | | | | | | fineness | Moisture | ignition | content | content |
| Sample name | (N/cm²) | 840 | 590 | 420 | 297 | 212 | 150 | 106 | 75 | 53 | Pan | number | (%) | (%) | (%) | (%) |
| Example 4 | 269.0 | 0.0 | 0.1 | 3.3 | 14.8 | 33.9 | 32.6 | 12.5 | 2.4 | 0.3 | 0.0 | 63.3 | 0.04 | 0.42 | 0.4 | 3.3 |
| Comparative | 179.0 | 0.0 | 0.0 | 3.4 | 16.0 | 40.5 | 29.7 | 8.8 | 1.6 | 0.0 | 0.0 | 60.0 | 0.03 | 0.67 | 0.4 | 7.7 |
| Example 8 | | | | | | | | | | | | | | | | |

Table 3 shows the results for the properties of the reclaimed sand and the physical properties of the cores in Example 4 and Comparative Example 8. Comparing Example 4 with Comparative Example 8, Example 4, which has been magnetically separated beforehand, and which has a lower magnetized matter content, has superior strength. It is clear that, even when using the same reclamation system, the strength tends to be lower if the sand has a high magnetized matter content.

### EXAMPLE 5

The active clay content, total clay content and loss-on-ignition were measured for dust from a first pass generated during the reclamation of green sand containing silica sand as the main component using reclamation equipment 1 of the first embodiment. The active clay content measurement method was performed in compliance with Testing Procedure AFS 2210-00-S, “Methylene Blue Clay Test, Ultrasonic Method, Molding Sand”, as defined in Mold & Core Test Handbook, 3rd Edition, published by the AFS, using a bentonite factor of 4.5. Additionally, the total clay content measurement method was performed in compliance with the aforementioned JIS Z 2601, Attachment 1, “Foundry Sand Clay Content Testing Method”. The loss-on-ignition testing method was performed in compliance with the aforementioned JIS Z 2601, Attachment 6, “Foundry Sand Loss-on-Ignition Testing Method”.

### COMPARATIVE EXAMPLE 9

As Comparative Example 9, the active clay content, total clay content and loss-on-ignition were measured for dust from a second pass generated during the reclamation of green sand containing silica sand as the main component using reclamation equipment 1 of the first embodiment. The measurement methods for the active clay content, the total clay content and the loss-on-ignition were the same as those in Example 5.

TABLE 4

| | Test category | | |
|---|---|---|---|
| | Active clay | Total clay | Loss-on- |
| | content | content | ignition |
| Sample name | (%) | (%) | (%) |
| Example 5 | 44.9 | 72.6 | 9.23 |
| Comparative | 22.3 | 43.4 | 2.56 |
| Example 9 | | | |

The results for the active clay content, the total clay content and the loss-on-ignition of the dust in Example 5 and Comparative Example 9 are shown in Table 4. In a comparison between Example 5 and Comparative Example 9, the dust from the first pass has a higher value than Comparative Example 9 for the active clay content, the total clay content and the loss-on-ignition. This shows that Example 5 contains more active bentonite and volatile additives such as coal powder, and that Comparative Example 9 contains more non-volatile components and components other than active bentonite, in other words, that it contains more fine powders from sand grains that have been polished by the reclamation.

### EXAMPLE 6

The reclamation equipment 1 of the first embodiment was used to reclaim, in six passes, green sand having silica sand as the main component, for the purpose of reclaiming the sand as a replacement for silica sand to be added to a main mold, and the properties of the reclaimed sand were evaluated. Thereafter, the reclaimed sand was added to a main mold at a rate of 1 t/day, and the properties of the main mold sand were evaluated after the passage of one month.

### COMPARATIVE EXAMPLE 10

As Comparative Example 10, the properties of the silica sand for addition to a main mold before being replaced by the reclaimed sand of Example 6 were evaluated. Thereafter, the properties of main mold sand were evaluated when adding new sand to the main mold at a rate of 1 t/day.

TABLE 5

Test category

| | Oolitics | Quartz |
|---|---|---|
| Sample name | (%) | (%) |
| Example 6 | 8.2 | 90.0 |
| Reclaimed sand | | |
| Example 6 | 20.9 | 69.3 |
| Main mold sand | | |
| Comparative Example 10 | 0.5 | 99.5 |
| New sand | | |
| Comparative Example 10 | 23.9 | 60.1 |
| Main mold sand | | |

If there are not enough oolitics, the water retention function of molding sand is lost, so the moisture added to molding sand evaporates, inducing casting defects caused by the molding sand. On the other hand, if there are too many oolitics, it may cause decreases in the fill density of the molding sand or burn defects in the cast articles. For this reason, although the requirements will also differ depending on the material of the cast article or the desired specifications of the product that is to be made, in the main mold sand that is generally used in green sand casting equipment for producing cast iron articles, the percentage of oolitics is often controlled to be approximately 20%.

Comparing the results of Example 6 and Comparative Example 10 in Table 5, the proportion of oolitics is slightly higher in Comparative Example 10, but is nevertheless approximately the same value in both cases. The proportion of quartz greatly improved in Example 6 compared to Comparative Example 10. From these results, it is clear that, using reclaimed sand that has been reclaimed until the properties indicated in Example 6 are obtained, the proportion of oolitics in the main mold sand can be maintained at a rate that is sufficient to maintain the water retention properties at about the same standard as that to which new sand has been added, while further increasing the amount of quartz, thereby preventing defects such as burning caused by the presence of too many oolitics.

In the fifth to eighth embodiments, reclamation equipment R and classification equipment C all having the same mechanism are arranged in series and in parallel. The number of units that are needed should be determined by verifying the required processing amount and processing capacity by performing tests beforehand, and the maximum required number of units should be prepared.

Additionally, in the fifth to eighth embodiments, reclamation equipment and classification equipment all having the same mechanism are arranged so that there are two units in series and two units in parallel, but it is possible to arrange any number of units in series and in parallel depending on the required processing amount, the required quality of the reclaimed sand and the required processing capacity, and it is also possible to have a serial-only arrangement or a parallel-only arrangement.

Furthermore, in the fifth to eighth embodiments, reclamation equipment R and classification equipment C all having the same mechanism are used, but it is also possible to use reclamation equipment R and classification equipment C having different mechanisms.

Additionally, in the fifth to eighth embodiments, the classification equipment C in the first pass is a dust collection apparatus DC and the classification equipment C in the second and subsequent passes is a dust collection apparatus DO, thereby allowing the dust from the first pass and the dust from the second and subsequent passes to be separately recovered. As a result, the reusable dust from the first pass can be effectively reused without being mixed with other types of dust.

### DESCRIPTION OF REFERENCE SYMBOLS

1,11, 21,31, 41,51, 61,71 reclamation equipment
2 compressed-air ejection means
S molding sand
D drying equipment
M magnetic separation equipment
V1, V2, V3, V4 switching equipment
BP1, BP2 bypass system
R dry mechanical reclamation equipment
C classification equipment
PL1, PL2 return system
DC, DO dust collection equipment
PO overflow sand recovery equipment
IO overflow sand foreign-matter removal equipment
SSO overflow sand storage tank
PS product-adhered sand recovery equipment
IS product-adhered sand foreign-matter removal equipment
SSS product-adhered sand storage tank
PL main mold/core-mixed sand recovery equipment
L crushing equipment
IL main mold/core-mixed sand foreign-matter removal equipment
SSL main mold/core-mixed sand storage tank
PC sand lumps/sand recovery equipment
IC sand lumps/sand foreign-matter removal equipment
SSC sand lumps/sand storage tank
F sand cutting/blending equipment
TR heating equipment

1-31. (canceled)

32. A molding sand reclamation method comprising:
measuring a water content and a magnetized matter content of molding sand discharged from green sand casting equipment;
comparing the measured water content with a first control value, and if the water content exceeds the first control value, drying the molding sand until the water content becomes equal to or less than the first control value;
comparing the measured magnetized matter content with a second control value, and if the magnetized matter content exceeds the second control value, magnetically separating the molding sand until the magnetized matter content becomes equal to or less than the second control value;
thereafter, reclaiming the molding sand by dry mechanical reclamation until a loss-on-ignition becomes equal to or less than a third control value; and
classifying the molding sand until a total clay content becomes equal to or less than a fourth control value.

33. The molding sand reclamation method according to claim 32, further comprising dividing the molding sand into multiple batches before the reclaiming, and separately performing the reclaiming and the classifying on each of the multiple divided batches of molding sand.

34. A molding sand reclamation method comprising:
recovering molding sand that has been discharged from green sand casting equipment, separately as overflow sand, sand adhering to the product, main mold/core-mixed sand and sand lumps/sand;
drying the overflow sand until the water content is equal to or less than a first control value, removing foreign matter from the overflow sand, and storing the overflow sand;
removing foreign matter from the sand adhering to the product, magnetically separating the sand adhering to the product until the magnetized matter content is equal to or less than a second control value, and storing the sand adhering to the product;
crushing the main mold/core-mixed sand, removing foreign matter from the main mold/core-mixed sand, and storing the main mold/core-mixed sand;
crushing the sand lumps, removing foreign matter from the sand, and storing the sand;
extracting and blending the stored overflow sand, the stored sand adhering to the product, the stored main mold/core-mixed sand and the stored sand so that a ratio therebetween is always kept constant;
reclaiming the blended sand by dry mechanical reclamation until a loss-on-ignition becomes equal to or less than a third control value; and
classifying the blended sand until a total clay content becomes equal to or less than a fourth control value.

35. The molding sand reclamation method according to claim 34, further comprising dividing the molding sand into multiple batches before the reclaiming, and separately performing the reclaiming and the classifying on each of the multiple divided batches of molding sand.

36. The molding sand reclamation method according to claim 34, further comprising, when a core used in the green sand casting equipment is made by a thermal-dehydration-cured water glass process, heating the main mold/core-mixed sand to at least 400° C. after removing foreign matter from the main mold/core-mixed sand and heating the sand to at least 400° C. after removing foreign matter from the sand.

37. The molding sand reclamation method according to claim 32, further comprising collecting fine powders generated during a first classifying step.

38. Molding sand reclamation equipment comprising:
drying equipment that dries molding sand discharged from green sand casting equipment until a water content is equal to or less than a first control value;
magnetic separation equipment that magnetically separates the molding sand until a magnetized matter content is equal to or less than a second control value;
dry mechanical reclamation equipment that reclaims the molding sand until a loss-on-ignition is equal to or less than a third control value;
classification equipment that classifies the molding sand until a total clay content is equal to or less than a fourth control value;
first switching equipment that selects whether or not to pass the molding sand through the drying equipment; and
second switching equipment that selects whether or not to pass the molding sand through the magnetic separation equipment.

39. The molding sand reclamation equipment according to claim 38, further comprising, in front of the dry mechanical reclamation equipment, third switching equipment that selects whether to pass the molding sand to the dry mechanical reclamation equipment or to return the molding sand to the entrance to the reclamation equipment.

40. The molding sand reclamation equipment according to claim 38, further comprising equipment that distributes the molding sand to multiple paths, and comprising the dry mechanical reclamation equipment and the classification equipment at the end of each of the multiple paths.

41. The molding sand reclamation equipment according to claim 40, comprising multiple units of the dry mechanical reclamation equipment and the classification equipment.

42. Molding sand reclamation equipment comprising:
overflow sand recovery equipment that recovers overflow sand discharged during a sand processing step;
drying equipment that dries the overflow sand until a water content is equal to or less than a first control value;
overflow sand foreign-matter removal equipment that removes foreign matter from the overflow sand;
an overflow sand storage tank that stores the overflow sand;
product-adhered sand recovery equipment that recovers sand adhering to the product;
product-adhered sand foreign-matter removal equipment that removes foreign matter from the sand adhering to the product;
magnetic separation equipment that magnetically separates the sand adhering to the product until a magnetized matter content is equal to or less than a second control value;
a product-adhered sand storage tank that stores sand adhering to the product;
main mold/core-mixed sand recovery equipment that recovers main mold/core-mixed sand;
crushing equipment that crushes the main mold/core-mixed sand;
main mold/core-mixed sand foreign-matter removal equipment that removes foreign matter from the main mold/core-mixed sand;
a main mold/core-mixed sand storage tank that stores the main mold/core-mixed sand;
sand lumps/sand recovery equipment that recovers sand lumps/sand discharged during a core sand extraction step;
crushing equipment that crushes the sand;
sand foreign-matter removal equipment that removes foreign matter from the sand;
a sand storage tank that stores the sand;
sand cutting/blending equipment that cuts out and blends sand from the overflow sand storage tank, the product-adhered sand storage tank, the main mold/core-mixed storage tank and the sand storage tank so that the ratio between the sand extracted from the respective storage tanks is always constant;
dry mechanical reclamation equipment that reclaims the blended sand until a loss-on-ignition becomes equal to or less than a third control value; and
classification equipment that classifies the blended sand until a total clay content becomes equal to or less than a fourth control value.

43. The molding sand reclamation equipment according to claim 42, further comprising equipment that distributes the molding sand to multiple paths, and comprising the dry mechanical reclamation equipment and the classification equipment at the end of each of the multiple paths.

44. The molding sand reclamation equipment according to claim 42, further comprising heating equipment that heats the main mold/core-mixed sand to at least 400° C. at the end of the main mold/core-mixed sand foreign-matter removal equipment, and heating equipment that heats the sand to at least 400° C. at the end of the sand foreign-matter removal equipment.

45. The molding sand reclamation equipment according to claim 38, further comprising dust collection equipment that collects fine powders generated in the classification equipment.

46. The molding sand reclamation equipment according to claim 38, wherein the magnetic separation equipment is half-magnetic outer-drum type magnetic separation equipment having the capacity to generate a magnetic flux density of 0.15 T to 0.5 T.

47. The molding sand regeneration equipment according to claim 38, wherein the dry mechanical reclamation equipment comprises:
a sand supply chute provided with a sand dropping port at a lower end;
a rotating drum that is arranged so as to be able to rotate horizontally underneath the sand supply chute, and that has, connected thereto, an inclined circumferential wall extending obliquely upwards and outwards from circumferential edges of a circular bottom plate, and a weir protruding inward from the upper end of the inclined circumferential wall;
at least one roller that is arranged, inside the rotating drum, perpendicularly with respect to the inclined circumferential wall, with a slight gap provided therebetween; and
a roller pressing mechanism that is coupled to the roller and that presses the roller, with a constant pressure, towards the inclined circumferential wall.

48. The molding sand reclamation equipment according to claim 47, wherein a cylinder that is used in the roller pressing mechanism is a combined pneumatic-hydraulic cylinder.

49. The molding sand regeneration equipment according to claim 38, wherein the dry mechanical reclamation equipment comprises:
a sand loading portion that is provided with a sand dropping port on a lower end;
a rotating drum that is arranged so as to be able to rotate horizontally underneath the sand supply chute, and that has, connected thereto, an inclined circumferential wall extending obliquely upwards and outwards from circumferential edges of a circular bottom plate, and a weir protruding inward from the upper end of the inclined circumferential wall;
at least one roller that is arranged, inside the rotating drum, perpendicularly with respect to the inclined circumferential wall, with a slight gap provided therebetween;
a roller pressing mechanism that is coupled to the roller and that presses the roller, with a constant pressure, towards the inclined circumferential wall;
motor driving means for rotating the rotating drum by using a motor;
a sand flow rate detector that is installed at the sand dropping port of the sand loading portion and that detects the flow rate of the loaded sand;
an electric current detector that detects an electric current value of the motor driving means;
pressure control means for a cylinder which is the roller pressing mechanism; and
control means for adjusting a pressing force of the roller due to the cylinder in accordance with the sand flow rate detected by the sand flow rate detector; and
the control means comprises:
a target electric current computation portion that preset a correlation between the sand flow rate and an electric current value for the motor determined by differences in a level of polishing required for the reclaimed sand, and that calculates a target electric current value for the motor corresponding to the sand flow rate detected by the sand flow rate detector so as to maintain the correlation;
a comparison portion that compares the target electric current value of the motor, corresponding to the flow rate of the loaded sand, with an electric current value of the motor as actually measured during operation; and
a control portion that adjusts the pressing force of the roller due to the cylinder, based on results from the comparison portion, so that the electric current value of the motor during operation is the target electric current value of the motor.

50. The molding sand reclamation equipment according to claim 47, wherein the dry mechanical reclamation equipment further comprises compressed-air ejection means for ejecting compressed air at accumulated fine powders that are deposited and accumulated on the inclined circumferential wall; and
the compressed-air ejection means comprises:
a pressure regulation valve that regulates a pressure of compressed air from a compressed-air source;
a flow rate regulation valve that regulates a flow rate of compressed air from the pressure regulation valve;
a nozzle that ejects compressed air that has flowed through the pressure regulation valve and the flow rate regulation valve;
ejection condition selection means for selecting ejection conditions for the compressed air; and
control means for controlling the pressure regulation valve and the flow rate regulation valve based on instructions from the ejection condition selection means.
